(19) United States
(12) Patent Application Publication
(10) Pub. No.: US 2025/0085408 A1
(43) Pub. Date: Mar. 13, 2025

(54) PERFORMANCE DEGRADATION DETECTION IN HYBRID DETECTION AND RANGING SYSTEM

(71) Applicant: Seyond, Inc., Sunnyvale, CA (US)

(72) Inventors: Yang Han, Cupertino, CA (US); Qinyuan Yin, San Mateo, CA (US); Xiandong Leng, San Jose, CA (US); Jia Ge, Milpitas, CA (US)

(73) Assignee: Seyond, Inc., Sunnyvale, CA (US)

(21) Appl. No.: 18/818,553

(22) Filed: Aug. 28, 2024

Related U.S. Application Data
(60) Provisional application No. 63/537,309, filed on Sep. 8, 2023.
(60) Provisional application No. 63/537,320, filed on Sep. 8, 2023.
(60) Provisional application No. 63/539,930, filed on Sep. 22, 2023.
(60) Provisional application No. 63/539,935, filed on Sep. 22, 2023.
(60) Provisional application No. 63/539,985, filed on Sep. 22, 2023.
(60) Provisional application No. 63/540,022, filed on Sep. 22, 2023.

(51) Int. Cl. G01S 7/497; G01S 17/86; G01S 17/89

(52) U.S. Cl. CPC G01S 7/497; G01S 17/86; G01S 17/89; G01S 2007/4977

(57) ABSTRACT

A Hybrid Detection and Ranging (HyDAR) system configured for detecting signals with multiple wavelengths is provided. The system comprises: a laser light source providing laser light signals; an aperture window; one or more steering mechanisms configured to perform: directing the laser light signals toward the aperture window, receiving first return light signals formed based on at least a portion of the laser light signals provided by the laser light source, and receiving second return light signals formed from light provided by one or more light sources external to the HyDAR system. The system further includes a multimodal sensor including a Light Detection and Ranging (LiDAR) sensor and an image sensor. The point cloud data and the image data are at least partially time-and-space synchronized at the hardware-level of the HyDAR system. The system further includes a controller configured to detect one or more degradation factors affecting the HyDAR system's performance.

### CROSS-REFERENCE TO RELATED APPLICATIONS

This application claims priority to U.S. Provisional Patent Application Ser. No. 63/537,309, filed Sep. 8, 2023, entitled “HYDAR SENSOR BLOCKAGE DETECTION;” U.S. Provisional Patent Application Ser. No. 63/537,320, filed Sep. 8, 2023, entitled “HYDAR ADAPTIVE LASER CONTROL FOR EXTERNAL LIDAR INTERFERENCE DETECTION;” U.S. Provisional Patent Application Ser. No. 63/539,930, filed Sep. 22, 2023, entitled “HYDAR INTRINSIC CALIBRATION DEGRADATION DETECTION;” U.S. Provisional Patent Application Ser. No. 63/539,935, filed Sep. 22, 2023, entitled “HYDAR DYNAMIC CALIBRATION;” U.S. Provisional Patent Application Ser. No. 63/539,985, filed Sep. 22, 2023, entitled “HYDAR SENSOR BLOCKAGE DETECTION;” and U.S. Provisional Patent Application Ser. No. 63/540,022, filed Sep. 22, 2023, entitled “HYDAR ADAPTIVE LASER CONTROL FOR EXTERNAL LIDAR INTERFERENCE DETECTION.” The contents of these applications are hereby incorporated by reference in their entireties for all purposes.

### FIELD OF THE TECHNOLOGY

This disclosure relates generally to light detection and, more particularly, to detecting performance degradation related to a hybrid detection and ranging (HyDAR) system configured to detect signals with multiple wavelengths.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminates an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

A hybrid detection and ranging (HyDAR) system may include a LiDAR system and one or more other types of sensors, such as one or more cameras, one or more Radar sensors, one or more ultrasonic sensors, and/or other sensors. The LiDAR system and the one or more other types of sensors may be integrated in the HyDAR system to form a compact multimodal sensor.

### SUMMARY

A multimodal sensor of a HyDAR system may be configured to be compact so that it can be easily mounted to a moveable platform like a vehicle. When a vehicle operates over time, there may be one or more degradation factors that affect the HyDAR system's performance. The degradation factors may include, for example, at least a partial aperture window blockage, interference signals from one or more interference light sources, HyDAR system extrinsic calibration degradation, and HyDAR system intrinsic calibration degradation. The degradation factors may affect the LiDAR sensor in the HyDAR system. Thus, in this disclosure, the techniques and methods are described for degradation factors with respect to the HyDAR system including the LiDAR sensor. With respect to window blockage, the technologies described herein can determine the type of blockage on a high level in real-time with limited computational requirements. One embodiment of the method uses machine learning algorithms to detect blockage and trigger cleaning and clearing actions either by the HyDAR system or external accessories.

Interference signals are another degradation factor for the HyDAR system. To avoid such interference signals, the corresponding part of the point cloud can be discarded, a laser source in the HyDAR system can be powered off, the laser power may be increased to increase the light intensity such that it is greater than the interference light signals; and/or the steering mechanism of the LiDAR sensor can be adjusted in the direction of the interference light sources for tuning the FOV of the LiDAR sensor. This disclosure also provides methods involving the image sensor and the LiDAR sensor in a HyDAR system to improve detection performance. The methods described herein can be applied for detecting interference light signals (e.g., direct sunlight, laser interference, oncoming vehicle high beams, etc.) and adaptively control the HyDAR system to minimize performance deterioration.

Another HyDAR performance degradation factor relates to extrinsic calibration of the HyDAR system including the LiDAR sensor. This disclosure provides technologies and methods for dynamically detecting and monitoring extrinsic calibration degradation. The HyDAR system provided for such purposes require no synchronization or data fusing above the hardware level. Using the disclosed HyDAR system, the point cloud data provided by the LiDAR sensor and the image data provided by the image sensor are at least partially time-and-space synchronized at the hardware level of the HyDAR system, therefore requiring no significant software-based computation or no software computation, transformation, or data fusion at all. Furthermore, if the degradation is within a pre-defined threshold, the HyDAR system can adjust itself while the moveable platform continues to operate.

Another performance degradation factor for a HyDAR system relates to the intrinsic calibration degradation over time. The present disclosure provides techniques and methods that use the LiDAR sensor and the image sensor in the HyDAR system to detect and monitor such an intrinsic calibration degradation associated with misaligned internal components. In some examples, the HyDAR system can trigger warnings and self-correction of the intrinsic calibration. This can also help determining the root cause of the performance degradation through trained data sets from the HyDAR system data. Benefit from the performance degradation detection, at least the following major intrinsic calibration parameter degradation can be monitored, corrected, and/or reported by the methods described herein: distance correction; oscillation mirror offsets; polygon mirror offsets; and geometric parameters.

Embodiments of present invention are described below. In various embodiments of the present invention, a Hybrid Detection and Ranging (HyDAR) system configured for detecting signals with multiple wavelengths is provided. The HyDAR system comprises a laser light source providing laser light signals; an aperture window; and one or more steering mechanisms configured to perform: directing the laser light signals toward the aperture window, receiving first return light signals formed based on at least a portion of the laser light signals provided by the laser light source, and receiving second return light signals formed from light provided by one or more light sources external to the HyDAR system. The HyDAR system further comprises a multimodal sensor including a Light Detection and Ranging (LiDAR) sensor and an image sensor. The LiDAR sensor is configured to detect the first return light signals to obtain one or more frames of point cloud data. The image sensor is configured to detect the second return light signals to obtain one or more frames of image data. The point cloud data and the image data are at least partially time-and-space synchronized at the hardware-level of the HyDAR system. The HyDAR system further includes a controller configured to perform: detecting one or more degradation factors affecting the HyDAR system's performance, and in response to detecting the one or more degradation factors, causing adjustment of a device configuration or an operational condition of the HyDAR system to remove or reduce effects of the degradation factors.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating a multimodal detection system according to some embodiments.

FIG. 5A is a block diagram illustrating an example fiber-based laser source.

FIG. 5B is a block diagram illustrating an example semiconductor-based laser source.

FIG. 6 illustrates an example light collection and distribution device, according to some embodiments.

FIG. 7 illustrates an example signal separation device, according to some embodiments.

FIG. 8 illustrates configurations of integrated sensors of a multimodal sensor, according to various embodiments.

FIG. 9 illustrates example packaging configurations for integrated sensors of a multimodal sensor, according to various embodiments.

FIGS. 10A-10C illustrate an example LiDAR system using pulse signals to measure distances to objects disposed in a field-of-view (FOV).

FIG. 11 is a block diagram illustrating an example apparatus used to implement systems, apparatus, and methods in various embodiments.

FIG. 12A is block diagram illustrating an example HyDAR system according to various embodiments.

FIG. 12B is a block diagram illustrating an example HyDAR system configured for detecting aperture window blockage, according to various embodiments.

FIG. 13 is a flowchart illustrating a method for detecting aperture window blockage of a HyDAR system, according to various embodiments.

FIG. 14A is a diagram illustrating a comparison of return signal strengths between a blocked aperture window and an unblocked aperture window, according to various embodiments.

FIG. 14B is a diagram illustrating at least a partial aperture window blockage for a HyDAR system and various types of blockages, according to various embodiments.

FIGS. 15A-15D are flowcharts illustrating various methods for detecting aperture window blockage of a HyDAR system, according to various embodiments.

FIG. 16 is a diagram illustrating a HyDAR system receiving interference signals provided by one or more interference light sources, according to various embodiments.

FIGS. 17A-17B are flowcharts illustrating various methods for detecting interference signals caused by one or more interference light sources, according to various embodiments.

FIG. 17C is a diagram illustrating an example process for adjusting a steering mechanism of the HyDAR system to avoid a location of the one or more interference light sources, according to various embodiments.

FIG. 17D is a diagram illustrating discarding a particular area of scanlines to corresponding to a location of the one or more interference light sources, according to various embodiments.

FIG. 17E are diagrams illustrating various processes for adjusting the HyDAR system to avoid interference light signals or to increase the light intensity of the HyDAR system to reduce the impact of the interference light signals, according to various embodiments.

FIG. 18 is a block diagram illustrating a moveable platform having a HyDAR system having extrinsic degradations with respect to the moveable platform, according to various embodiments.

FIGS. 19A-19B are flowcharts illustrating methods for detecting extrinsic calibration degradation of a HyDAR system mounted to a moveable platform, according to various embodiments.

FIGS. 19C-19G are diagrams illustrating an example method of detecting extrinsic calibration degradation of a HyDAR system using parallel line features extending along a road surface, according to various embodiments.

FIG. 19H is a diagram illustrating an example method of detecting extrinsic calibration degradation of a HyDAR system using curved features extending along a road surface, according to various embodiments.

FIG. 20A is a flowchart illustrating a method for detecting the extrinsic calibration degradation based on both point cloud data and image data, according to various embodiments.

FIG. 20B are diagrams illustrating various predefined stationary targets in image data, based on which the detection of the extrinsic calibration degradation is performed, according to various embodiments.

FIGS. 20C-20D are flowcharts illustrating an example method of detecting extrinsic calibration degradation of a HyDAR system using sets of features based on image data and LiDAR data, according to various embodiments.

FIG. 21 is a block diagram illustrating a HyDAR system that may have intrinsic calibration degradation, according to various embodiments.

FIGS. 22A-22B are flowcharts illustrating an example method for detecting intrinsic calibration degradation of a HyDAR system, according to various embodiments.

FIG. 23 are diagrams illustrating enhanced LiDAR resolution using image data, according to various embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first light signal could be termed a second light signal and, similarly, a second light signal could be termed a first light signal, without departing from the scope of the various described examples. The first light signal and the second light signal can both be light signal and, in some cases, can be separate and different light signals.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

As described above, a HyDAR system may include an integrated LiDAR sensor and one or more other sensors to form a multimodal sensor. The multimodal sensor may be configured to be compact so that it can be easily mounted to a moveable platform like a vehicle. A HyDAR system may have one or more degradation factors that affect its performance over time. The degradation factors may include, for example, at least a partial aperture window blockage, interference signals from one or more interference light sources, HyDAR system extrinsic calibration degradation, and HyDAR system intrinsic calibration degradation. It is understood that these examples are not limiting and are just examples of degradation factors commonly encountered by the HyDAR system.

Beginning with the window blockage as a performance degradation factor, for most of LiDAR systems on the market today, the aperture window is susceptible to undesired blockage. This is especially true for a LiDAR sensor mounted on a vehicle. For instance, the aperture window may be exposed to rain drops, fog condensation, debris falling onto the aperture window, etc. The present disclosure describes technologies that uses the multimodal sensor of a HyDAR system to detect at least a partial aperture window blockage of the LiDAR sensor, the image sensor, or the HyDAR system. The technologies described herein can also determine the type of blockage on a high level in real-time with limited computational requirements. One embodiment of the method uses machine learning algorithms to detect blockage and trigger cleaning and clearing actions either by the HyDAR system or its external accessories.

Turning to the next performance degradation factor, a LiDAR sensor in the HyDAR system can be sensitive to external interference light signals including, for example, direct sunlight, light from other LiDAR systems, vehicle headlights, streetlights, etc. Interference light signals from the external interference light source may cause performance degradation of the HyDAR system. For example, interference light signals can lead to abnormal behavior and cause harm to both the sensor itself and the agents around the sensor. This disclosure provides examples configurations of a multimodal sensor in a HyDAR system for reducing or preventing misdetection or performance degradation. For example, different kinds of interference light sources, even malicious laser scrambler in the near field, can be determined by using an image sensor of the multimodal sensor in the HyDAR system. In one example, to avoid such interference signals, the corresponding part of the point cloud can be discarded, a laser source in the HyDAR system can be powered off, the laser power may be increased to increase the transmission light intensity such that the signal-to-noise (SNR) ratio is improved; and/or the steering mechanism of the LiDAR sensor can be adjusted in the direction of the interference light sources for tuning the FOV of the LiDAR sensor. The present disclosure also provides methods involving the image sensor and the LiDAR sensor in a HyDAR system to improve detection performance. The method can be applied for detecting interference light signals (e.g., direct sunlight, laser interference, oncoming vehicle high beams, etc.) and adaptively control the HyDAR system to minimize performance deterioration.

Another HyDAR performance degradation factor relates to extrinsic calibration of the HyDAR system including the LiDAR sensor and an image sensor. In autonomous industry, extrinsic calibration of a forward-looking camera and LiDAR sensor can be a difficult issue to solve since it requires accurate synchronization between the two sensors and specific calibration setup. The extrinsic calibration parameters may also degrade as the moveable platform (e.g., a vehicle) operates in harsh environmental conditions throughout its life. The extrinsic calibration measures the relation between the HyDAR system and the moveable platform to which the HyDAR system is mounted. When the HyDAR system is first manufactured and mounted to the moveable platform, the HyDAR system is calibrated to have the correct position and orientation such that it can operate to accurately detect objects in its FOV. Overtime, the extrinsic calibration of the HyDAR system may change due to various factors like environmental conditions, wear and tear, user induced errors, etc. Accordingly, the extrinsic calibration of the HyDAR system may degrade overtime, and in turn the performance of the HyDAR system may be negatively affected.

The present disclosure provides technologies and methods for dynamically detecting and monitoring extrinsic calibration degradation. The HyDAR system provided for such purposes require no synchronization or data fusing above the hardware level. Using the disclosed HyDAR system, the point cloud data provided by the LiDAR sensor and the image data provided by the image sensor are at least partially time-and-space synchronized at the hardware level of the HyDAR system, therefore requiring no significant software computation, transformation, or data fusion, or no software-level synchronization at all. Furthermore, if the degradation is within a pre-defined threshold, the HyDAR system can adjust itself while the moveable platform continues to operate.

Another performance degradation factor for a HyDAR system relates to the intrinsic calibration degradation over time. The intrinsic calibration of a HyDAR system relates to the calibration of the alignment of the internal components of the HyDAR system including the LiDAR sensor and the image sensor. The HyDAR system operates under outdoor all-weather environments where they may encounter vibration, wear and external damage. These harsh environmental conditions may sometimes cause the HyDAR system's intrinsic calibration to tilt off and in turn cause the performance degradation of the HyDAR system. The present disclosure uses the LiDAR sensor and image sensor in the HyDAR system to detect and monitor such an intrinsic calibration degradation associated with misaligned internal components. In some examples, the HyDAR system can trigger warnings and self-correction of the intrinsic calibration. This can also help determining the root cause of the performance degradation through trained data sets from the HyDAR system data. Benefitted from the performance degradation detection, at least the following major intrinsic calibration parameter degradation can be monitored, corrected, and reported by the methods described herein: distance correction; oscillation mirror offsets; polygon mirror offsets; and geometric parameters of the HyDAR system components.

Embodiments of present invention are described below. In various embodiments of the present invention, a Hybrid Detection and Ranging (HyDAR) system configured for detecting signals with multiple wavelengths is provided. The HyDAR system comprises a laser light source providing laser light signals; an aperture window; and one or more steering mechanisms configured to perform: directing the laser light signals toward the aperture window, receiving first return light signals formed based on at least a portion of the laser light signals provided by the laser light source, and receiving second return light signals formed from light provided by one or more light sources external to the HyDAR system. The HyDAR system further comprises a multimodal sensor including a LiDAR sensor and an image sensor. The LiDAR sensor is configured to detect the first return light signals to obtain one or more frames of point cloud data. The image sensor is configured to detect the second return light signals to obtain one or more frames of image data. The point cloud data and the image data are at least partially time-and-space synchronized at the hardware-level of the HyDAR system. The HyDAR system further includes a controller configured to perform: detecting one or more degradation factors affecting the HyDAR system's performance, in response to detecting the one or more degradation factors, and causing adjustment of a device configuration or an operational condition of the HyDAR system to remove or reduce effects of the degradation factors. Example HyDAR systems and various technologies for detecting performance degradations are described below in greater detail, beginning with description of a LiDAR system, which is often included in a HyDAR system.

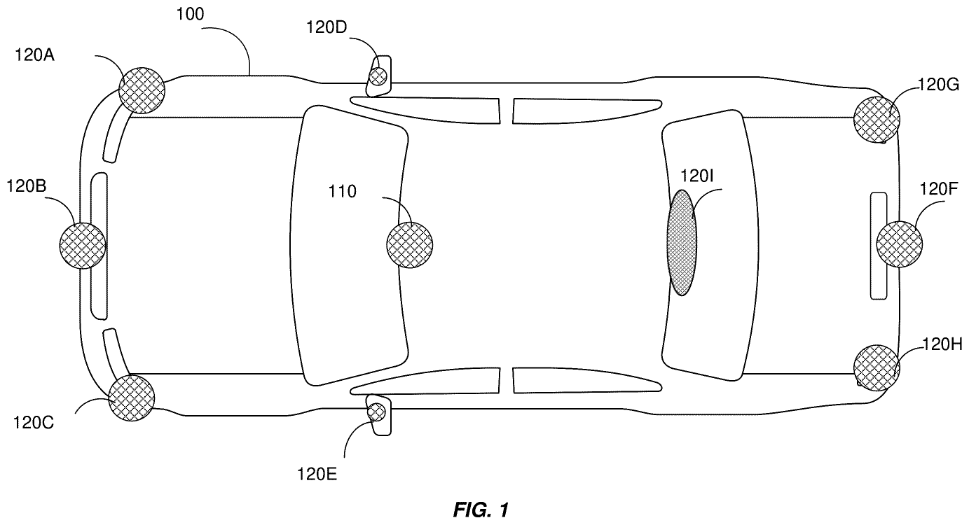

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

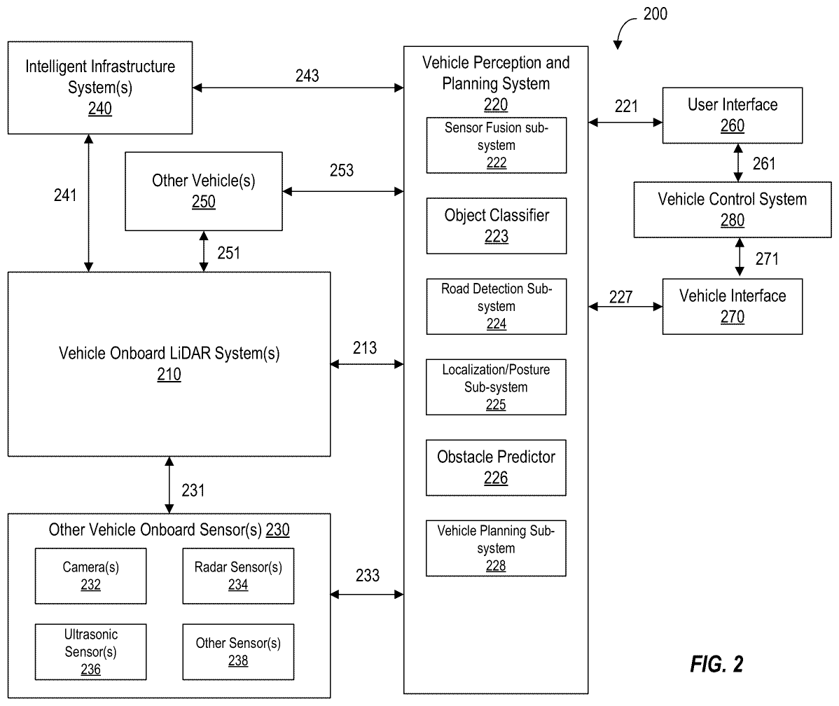

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mounted on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa.

Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the Sun or a light source (e.g., another vehicle's headlight during nighttime) directly. A LIDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

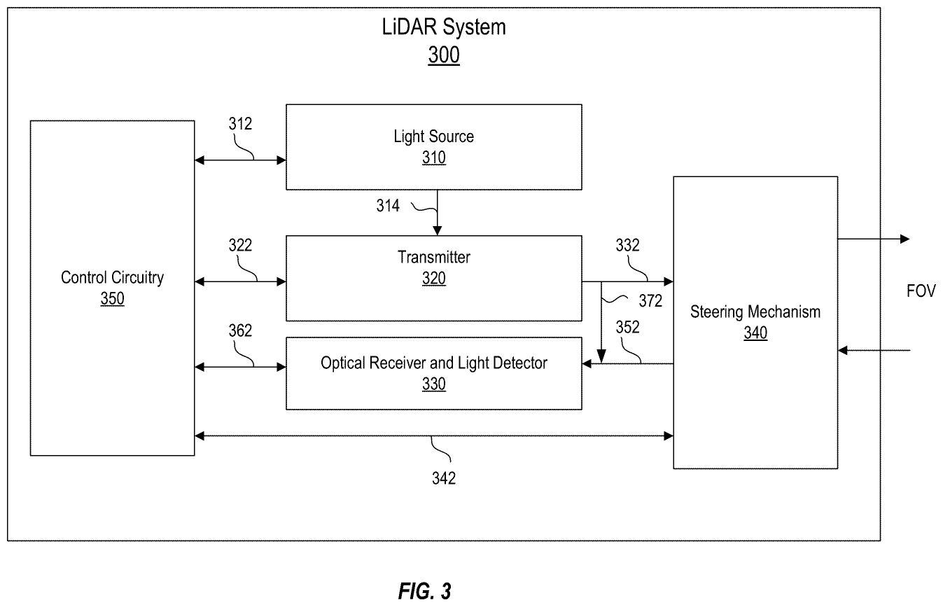

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and control circuitry 350. These components are coupled together using communications paths 312, 314, 322, 332, 342, 352, 362, and 372. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector 330 of the LiDAR system 300. The second portion is also referred to as the light that is kept local (LO) to the LiDAR system 300. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, prascodymium, thulium, and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power. An example of light source 310 is described in more detail below.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens or a lens group configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is also referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300. Control circuitry 350 may include digital and/or analog circuitry (e.g., ADC, amplifier, filter, etc.) for processing data representing return light signals received by a LiDAR system or a HyDAR system.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, 362, and 372. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

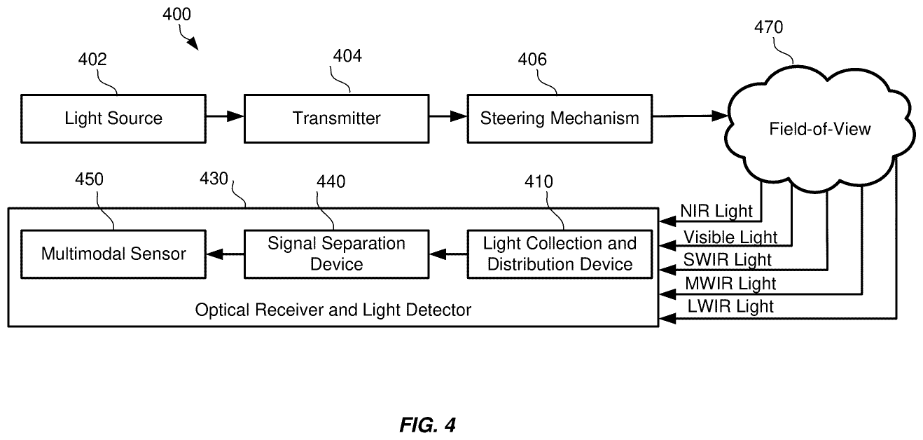

FIG. 4 is a block diagram illustrating an exemplary multimodal detection system 400 with integrated sensors, according to various embodiments. Multimodal detection system 400 can be a part of a LiDAR system (e.g., system 300) or includes a part of a LiDAR system (e.g., system 300). System 400 can also include one or more other sensors such as cameras. In one example where system 400 includes a LiDAR sensor and an image sensor (or includes a LiDAR sensor and one or more other types of sensors), it can be referred to as a Hybrid Detection and Ranging (HyDAR) system. As shown in FIG. 4, in some embodiments, on the transmission side, system 400 can include a light source 402, a transmitter 404, and a steering mechanism 406. These components can form a transmission light path. On the receiver side, system 400 can include an optical receiver and light detector 430, which comprises one or more of a light collection and distribution device 410, a signal separation device 440, and a multimodal sensor 450. In some examples, steering mechanism 406 is also used for receiving light signals from the FOV 470. Therefore, steering mechanism 406 and optical receiver and light detector 430 can form a receiving light path. Light source 402, transmitter 404, and steering mechanism 406 can be substantially the same or similar as light source 310, transmitter 320, and steering mechanism 340, respectively, as described above in connection with FIG. 3.

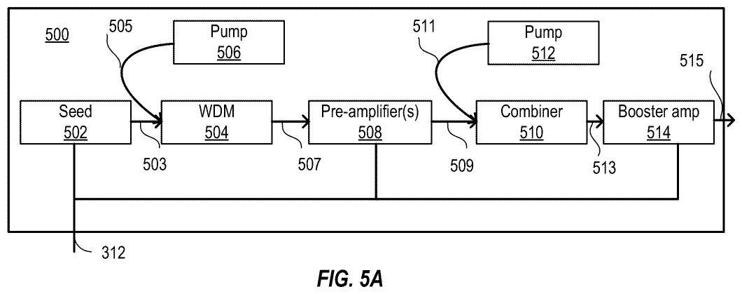

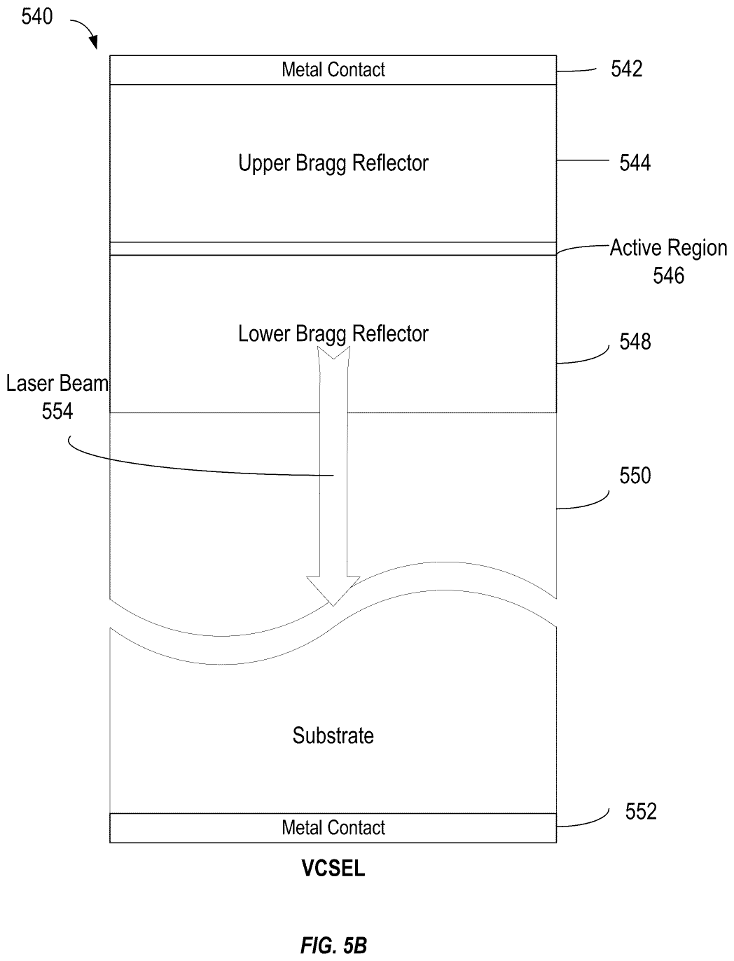

In some examples, light source 402 is an internal light source that generates light for the multimodal detection system 400. Examples of internal light sources include active illumination devices such as laser (e.g., fiber laser or semiconductor based laser used in one or more LiDAR transmission channels of system 400), light emitting diodes, headlights/taillights, etc. An example of light source 402 is described below in more detail in connection with FIGS. 5A and 5B. In some examples, system 400 also receives light from light sources that are external to system 400. These external light sources may not be a part of the system 400. Examples of external light sources include sunlight, streetlight, and other illuminations from light sources external to system 400 (e.g., light from other LiDARs).

As illustrated in FIG. 4, light generated by light source 402 (e.g., laser from a LiDAR system) is provided to transmitter 404. The light generated by light source 402 can include visible light, near infrared (NIR) light, short wavelength IR (SWIR) light, medium wavelength IR (MWIR) light, long wavelength IR (LWIR) light, and/or light in any other wavelengths. The visible light has a wavelength range of about 400 nm-700 nm; the near infrared (NIR) light has a wavelength range of about 700 nm-1.4 μm; the short-wavelength infrared (SWIR) has a wavelength range of about 1.4 μm-3 μm; the mid-wavelength infrared (MWIR) has a wavelength range of about 3 μm-8 μm; and a long-wavelength infrared (LWIR) has a wavelength range of about 8 μm-15 μm.

FIG. 5A is a block diagram illustrating an example fiber-based laser source 500 for implementing light source 310 depicted in FIG. 3 and/or light source 402 depicted in FIG. 4. Fiber-based laser source 500 has a seed laser and one or more pumps (e.g., laser diodes) for pumping desired output power. In some embodiments, fiber-based laser source 500 comprises a seed laser 502 configured to generate initial light pulses of one or more wavelengths (e.g., infrared wavelengths such as 1550 nm), which are provided to a wavelength-division multiplexor (WDM) 504 via an optical fiber 503. Fiber-based laser source 500 further comprises a pump 506 for providing laser power (e.g., of a different wavelength, such as 980 nm) to WDM 504 via an optical fiber 505. WDM 504 multiplexes the light pulses provided by seed laser 502 and the laser power provided by pump 506 onto a single optical fiber 507. The output of WDM 504 can then be provided to one or more pre-amplifier(s) 508 via optical fiber 507. Pre-amplifier(s) 508 can be optical amplifier(s) that amplify optical signals (e.g., with about 10-30 dB gain). In some embodiments, pre-amplifier(s) 508 are low noise amplifiers. Pre-amplifier(s) 508 output to an optical combiner 510 via an optical fiber 509. Combiner 510 combines the output laser light of pre-amplifier(s) 508 with the laser power provided by pump 512 via an optical fiber 511. Combiner 510 can combine optical signals having the same wavelength or different wavelengths. One example of a combiner is a WDM. Combiner 510 provides combined optical signals to a booster amplifier 514, which produces output light pulses via optical fiber 515. The booster amplifier 514 provides further amplification of the optical signals (e.g., another 20-40 dB). The output light pulses can then be transmitted to transmitter 320, transmitter 404, steering mechanism 340, and/or steering mechanism 406 (shown in FIGS. 3 and 4). It is understood that FIG. 5A illustrates one example configuration of fiber-based laser source 500. Laser source 500 can have many other configurations using different combinations of one or more components shown in FIG. 5A and/or other components not shown in FIG. 5A (e.g., other components such as power supplies, lens(es), filters, splitters, combiners, etc.).

In some variations, fiber-based laser source 500 can be controlled (e.g., by control circuitry 350) to produce pulses of different amplitudes based on the fiber gain profile of the fiber used in fiber-based laser source 500. Communication path 312 couples fiber-based laser source 500 to control circuitry 350 (shown in FIG. 3) so that components of fiber-based laser source 500 can be controlled by or otherwise communicate with control circuitry 350. Alternatively, fiber-based laser source 500 may include its own dedicated controller. Instead of control circuitry 350 communicating directly with components of fiber-based laser source 500, a dedicated controller of fiber-based laser source 500 communicates with control circuitry 350 and controls and/or communicates with the components of fiber-based laser source 500. Fiber-based laser source 500 can also include other components not shown, such as one or more power connectors, power supplies, and/or power lines.

FIG. 5B is a block diagram illustrating an example semiconductor-based laser source 540. Semiconductor-based laser source 540 is an example of light source 310 depicted in FIG. 3 and/or light source 402 depicted in FIG. 4. In the example shown in FIG. 5B, laser source 540 is a Vertical-Cavity Surface-Emitting Laser (VCSEL), which is a type of semiconductor laser diode with a distinctive structure that allows it to emit light vertically from the surface of the chip, rather than through the edge of the chip like the edge-emitting laser (EEL) diodes. VCSELs have advantages like high-speed operation and easy integration into semiconductor devices. FIG. 5B shows a cross-sectional view of an example VCSEL 540. In this example, the VCSEL 540 includes a metal contact layer 542, an upper Bragg reflector 544, an active region 546, a lower Bragg reflector 548, a substrate 550, and another metal contact 552. In the VCSEL 540, the metal contacts 542 and 552 are for making electrical contacts so that electrical current and/or voltage can be provided to VCSEL 540 for generating laser light. The substrate layer 550 is a semiconductor substrate, which can be, for example, a gallium arsenide (GaAs) substrate. VCSEL 540 uses a laser resonator, which includes two distributed Bragg reflector (DBR) reflectors (i.e., upper Bragg reflector 544 and lower Bragg reflector 548) with an active region 546 sandwiched between the DBR reflectors. The active region 546 includes, for example, one or more quantum wells for the laser light generation. The planar DBR-reflectors can be mirrors having layers with alternating high and low refractive indices. Each layer has a thickness of a quarter of the laser wavelength in the material, yielding intensity reflectivities above e.g., 99%. High reflectivity mirrors in VCSELs can balance the short axial length of the gain region. In one example of VCSEL 540, the upper and lower DBR reflectors 544 and 548 can be doped as p-type and n-type materials, forming a diode junction. In another example, the p-type and n-type regions may be embedded between the reflectors, requiring a more complex semiconductor process to make electrical contact to the active region, but eliminating electrical power loss in the DBR structure. The active region 546 is sandwiched between the DBR reflectors 544 and 548 of the VCSEL 540. The active region is where the laser light generation occurs. The active region 546 typically has a quantum well or quantum dot structure, which contains the gain medium responsible for light amplification. When an electric current is applied to the active region 546, it generates photons by stimulated emission. The distance between the upper and lower DBR reflectors 544 and 548 defines the cavity length of the VCSEL 540. The cavity length in turn determines the wavelength of the emitted light and influences the laser's performance characteristics. When an electrical current is applied to the VCSEL 540, it generates light that bounces between the DBR reflectors 544 and 548 and exits the VCSEL 540 through, for example, the lower DBR reflector 548, producing a highly coherent and vertically emitted laser beam 554. VCSEL 540 can provide an improved beam quality, low threshold current, and the ability to produce single-mode or multi-mode output.

In some variations, VCSEL 540 can be controlled (e.g., by control circuitry 350) to produce pulses of different amplitudes. Communication path 312 couples VCSEL 540 to control circuitry 350 (shown in FIG. 3) so that components of VCSEL 540 can be controlled by or otherwise communicate with control circuitry 350. Alternatively, VCSEL 540 may include its own dedicated controller. Instead of control circuitry 350 communicating directly with components of VCSEL 540, a dedicated controller of VCSEL 540 communicates with control circuitry 350 and controls and/or communicates with the components of VCSEL 540. VCSEL 540 can also include other components not shown, such as one or more power connectors, power supplies, and/or power lines.

VCSEL 540 can be used to generate laser pulses or continuous wave (CW) lasers. To generate laser pulses, control circuitry 350 modulates the current supplied to the VCSEL 540. By rapidly turning the supply current on and off, pulses of laser light can be generated. The duration, repetition rate, and shape of the pulses can be controlled by adjusting the modulation parameters. As another example, VCSEL 540 can also be a mode-locked VCSEL that uses a combination of current modulation and optical feedback to obtain ultra-short pulses. The mode-locked VCSEL may also be controlled to synchronize the phases of the laser modes to produce very short and high-intensity pulses. As another example, VCSEL 540 can use Q-Switching techniques, which includes an optical switch in the laser cavity, temporarily blocking the lasing action and allows energy to build up in the cavity. When the switch is opened, a high-intensity pulse is emitted. As another example, VCSEL 540 can also have external modulation performed by an external modulator (not shown), such as an electro-optic or acousto-optic modulator. The external modulation can be used in combination with the VCSEL itself to create pulsed output. The external modulator can be used to control the pulse duration and repetition rate. The type of VCSEL used as at least a part of light source 310 or light source 402 depends on the application and the required pulse characteristics, such as pulse duration, repetition rate, and peak power.

With reference back to FIG. 4, multimodal detection system 400 includes a transmitter 404. In some examples, transmitter 404 can include one or more transmission channels, each carrying a light beam. The transmitter 404 may also include one or more optics (e.g., mirrors, lens, fiber arrays, etc.) and/or electrical components (e.g., PCB board, power supply, actuators, etc.) to form the transmission channels. Transmitter 404 can transmit the light from each channel to a steering mechanism 406, which scans the light from each channel to an FOV 470. Steering mechanism 406 may include one or more optical or electrical scanners configured to perform at least one of a point scan or a line scan of the FOV 470.

Light source 402, transmitter 404, and steering mechanism 406 may be a part of a LiDAR or HyDAR system that scans light into FOV 470. The scanning performed by steering mechanism 406 can include, for example, line scanning and/or point scanning. For example, the steering mechanism 406 can be configured to scan all points in lines or an area; scan some points in certain lines or an area, while skip scanning other points; or scan certain lines while skipping other lines. As another example, the steering mechanism 406 of multimodal detection system 400 can be configured to scan certain points/lines in higher resolution while scan other points/lines in lower resolution. For instance, the high resolution scanning may be applied to regions of interest (ROIs) while the low resolution scanning or no scanning may be applied to other regions of the FOV. In some embodiments, to scan an ROI, the steering mechanism 406 containing one or more optical or electrical scanners can be controlled to have different characteristics than those for scanning a non-ROI. For instance, for scanning the ROI, a scanner may be controlled to have slower scanning rate and/or a smaller scanning step, thereby increasing the scanning resolution. Furthermore, the light source 402 may also be configured to increase the pulse repetition rate, thereby increasing the scanning resolution.

With reference to FIG. 4, in some embodiments, if a sensor in a multimodal detection system 400 does not require actively transmitting light and/or scanning the light, one or more of light source 402, transmitter 404, and steering mechanism 406 may not be required for that particular sensor. For example, if system 400 includes a passive image sensor or video sensor (e.g., a camera), it may not require actively sending out light and/or scanning light to the FOV in order to form an image of the FOV. In this disclosure, the terms “image sensor” and “video sensor” are used interchangeably, both referring to a passive sensor that can capture images and/or videos. As a passive sensor, the image sensor may just sense light from the FOV and use the sensed light to form an image. It may not transmit light out to the FOV itself. In some other examples, the image sensor may require a light source (e.g., a flash light or other illuminations) to provide sufficient light conditions for sensing (e.g., capturing an image with enough brightness). In some examples, an image sensor can also perform a point scan or a line scan to obtain better performance such as an improved detection limit and a larger dynamic range. Such an image sensor may have a high image resolution and complex imaging structures and may thus be expensive. However, as described below, integrating such an image sensor with, for example, a LiDAR sensor in the multimodal detection system 400 can reduce the overall cost as compared to two discrete sensors.

FIG. 4 further illustrates that system 400 includes an optical receiver and light detector 430 to receive and detect light from FOV 470. As described above, the transmission side of system 400 may transmit light to FOV 470. A portion of the light transmitted may be reflected or scattered by objects in the FOV 470 to form return light signals. The return light signals may be received by optical receiver and light detector 430. In addition, optical receiver and light detector 430 may also receive light signals from other external light sources, including, for example, sunlight, ambient light, streetlight, and/or other sources of illuminations such as light from other LiDAR or HyDAR systems. The various light signals received by optical receiver and light detector 430 are collectively referred to as the received light signals or collected light signals. The received or collected light signals may include both return light signals formed based on transmitted light of system 400 and other light signals from other light sources. The received light signals may have a narrow or wide spectral range comprising, for example, one or more of visible light, NIR light, SWIR light, MWIR light, and/or LWIR light, etc. One or more of these received light signals can be detected by different types of light detectors (e.g., a LiDAR sensor for detecting IR light signals, and an image sensor for detecting visible light signals). In the present disclosure, one or more of these light detectors can be integrated to form a hybrid detector. The light collection distribution device 410, signal separation device 440, and multimodal sensor 450 of optical receivers and light detector 430 are described in greater detail below.

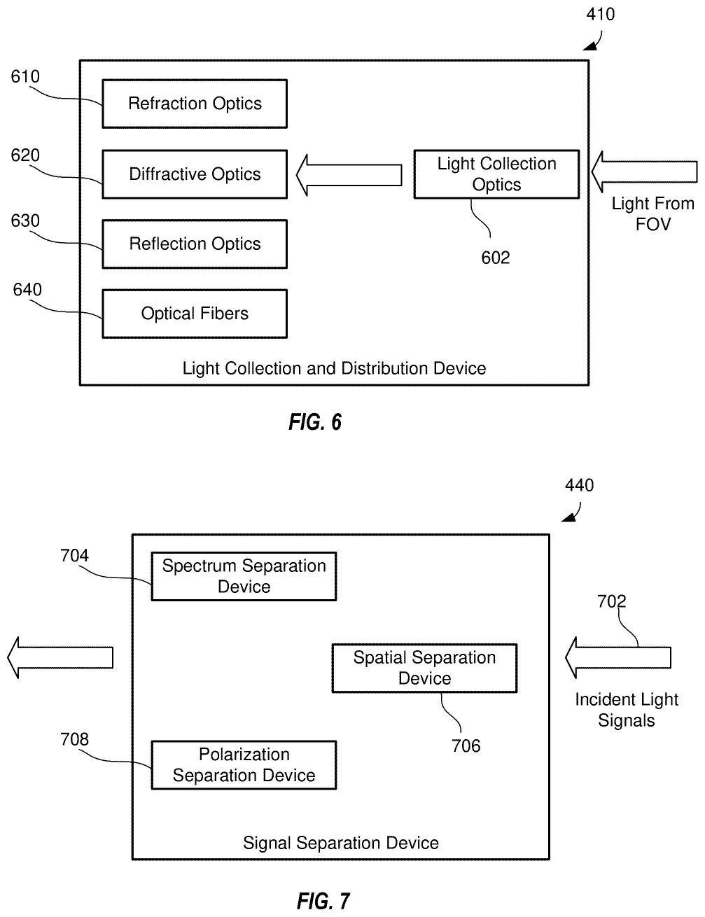

FIG. 6 illustrates an example light collection and distribution device 410. Light collection and distribution device 410 can be configured to perform at least one of collecting light signals from a field-of-view (FOV) and distributing the light signals to a plurality of sensors of a multimodal sensor (e.g., sensor 450). The light signals collected and distributed by device 410 may have a plurality of wavelengths. At least one wavelength is different from one or more other wavelengths. As illustrated in FIG. 6, device 410 can include light collection optics 602, refraction optics 610, diffractive optics 620, reflection optics 630, and/or optical fibers 640. While FIG. 4 illustrates that steering mechanism 406 is a separate device from light collection and distribution device 410, in some embodiments, steering mechanism 406 may be integrated with, or a part of, device 410. For example, steering mechanism 406 may be shared between the transmitter 404 and the optical receiver and light detector 430 for both transmitting light signals to the FOV and for receiving/redirecting light signals from the FOV. This type of configuration is also referred to as a coaxial configuration because the transmitting light path and the receiving light path share some common optical components. Thus, while FIG. 6 does not explicitly illustrate, light collection optics 602 may include a steering mechanism that is shared between the transmitter and receiver.

With reference to FIG. 6, light signals from the FOV can be received or collected by light collection optics 602 (e.g., by a steering mechanism 406). Light collection optics 602 include optics that are configured to collect and focus received light signals. Light collection optics 602 can be optimized to maximize the number of light signals collected from the FOV and direct the light signals toward a specific target, such as one of the refraction optics, diffractive optics, reflection optics, a detector, a sensor, and/or an imaging system. Light collection optics 602 may include one or more types of light collection optics, including one or more lenses, one or more lens groups, one or more mirrors, and one or more optical fibers. For instance, a collection lens or a lens group can be used to collect light signals from a distant object in the FOV and focus the light signals onto another optical components or a detector. Mirrors are another optical component that can be used in light collection optics 602. They can be used to reflect and redirect light toward a specific target. Mirrors can be used alone or in combination with lenses to form complex optical structures for collecting light signals.

In some embodiments as shown in FIG. 6, light collection optics 602 directs the collected light signals to one or more of refraction optics 610, diffractive optics 620, reflection optics 630, and/or optical fibers 640. In some embodiments, light collection optics 602 may be optional or integrated with refraction optics 610, diffractive optics 620, reflection optics 630, and/or optical fibers 640. For instance, the collected light signals can be directed (with or without light collection optics 602) to refraction optics 610. Refraction optics 610 can include optics that bend the light signals as they pass from one medium (e.g., air) to another medium (e.g., glass) with a different refractive index. A refractive index is a measure of how much a medium can bend light signals. When light signals pass from a medium with a high refractive index to a medium with a lower refractive index, the light signals bend away from the normal direction (e.g., the direction perpendicular to the surface at the point where the light enters the second medium). When the light signals pass from a medium with a low refractive index to a medium with a higher refractive index, the light bends toward the normal direction. The amount of bending depends on the angle of incidence (the angle between the incoming light signals and the normal direction of a surface of the medium) and the refractive indices of the two media. The relationship between these variables is described by the Snell's law, which states that the ratio of the sine of the angle of incidence to the sine of the angle of refraction is equal to the ratio of the refractive indices of the two media.

In some embodiments, refraction optics 610 can be implemented using a beam splitter, which can be configured to perform optical refraction such that it transmits a first portion of the incident light signals from the FOV (e.g., received directly or via light collection optics) to a first sensor and reflects a second portion of the received light signals to a second sensor. The first sensor and second sensor can be different sensors located at two different positions.

With continued reference to FIG. 6, light collection and distribution device 410 may also include diffractive optics 620 configured to separate the incident light signals to portions having different wavelengths, intensities, or polarizations. Diffractive optics 620 may include optics having diffractive structures such as a diffractive gratings. Diffractive structures can be made of thin layers of materials that contain features, such as grooves, ridges, or other microstructures, that are configured to manipulate the phase of the incident light signals. These diffractive structures can be used to manipulate the properties of light signals, such as the direction, intensity, polarization, and wavelength. In some examples, diffractive optics 620 can include diffractive gratings, which is a periodic structure that separates light into its spectral components based on its wavelength. In some examples, diffractive optics 620 may also include diffractive lenses, beam splitters, and polarizers. Diffractive lenses can be configured to correct for chromatic aberration and other types of optical distortion, and can be used to provide lightweight and compact optical systems. Diffractive optics 620 can be used to create complex optical elements with a high degree of precision. As a result, they can be used in the multimodal detection system to precisely separate and direct light signals having different properties (e.g., wavelengths, intensities, polarizations, etc.) to different sensors.

FIG. 6 also illustrates that light collection and distribution device 410 may include reflective optics 630. Reflection optics 630 comprises one or more optical components that can reflect the incident light signals. The angle of incidence determines the angle of reflection. The properties of the surface of reflection optics, such as the roughness, shape, and material, can affect the reflection of the incident light signals. In one example, reflection optics 630 comprises a Schmidt-Cassegrain based reflection device configured to direct a portion of the incident light signals to a first sensor and direct another portion of the incident light signals to a second sensor. In some examples, reflection optics 630 includes a Newtonian-based reflection device configured to direct a portion of the incident light signals to a first sensor and direct another portion of the incident light signals to a second sensor. The first sensor and second sensor can be different sensors located at different physical positions. They can also be different types of sensors (e.g., a LiDAR sensor and an image sensor).

In another embodiments, the incident light signals collected by light collection optics 602 can be directed to different sensors by using optical fibers 640. Optical fibers 640 can be flexible and have any desired lengths. Therefore, using optical fibers 640, the incident light signals can be directed to different sensors located at different physical positions.

As described above and shown in FIG. 4, multimodal detection system 400 may include a signal separation device 440. FIG. 7 illustrates an example of such a signal separation device 440. Signal separation device 440 is configured to separate the incident light signals to form separated light signals having a plurality of different light characteristics. The signal separation device 440 can perform a variety of separations including spatial separation, intensity separation, spectrum separation, polarization separation, etc. While FIG. 4 illustrates that signal separation device 440 and light collection and distribution device 410 are two different devices, in some embodiments, signal separation device 440 may be at least partially combined with light collection and distribution device 410. For instance, as described above, light collection and distribution device 410 can include one or more of refraction optics, diffractive optics, reflection optics, etc., to perform spatial distribution of the incident light signals. Thus, these optical components may form a part of the signal separation device 440 (e.g., as spatial separation device) to separate incident light signals to different portions and direct the different portions to different detectors at different physical locations.

With reference to FIG. 7, signal separation device 440 may include a spatial separation device 706, a spectrum separation device 704, a polarization separation device 708, and/or other separation devices (not shown). Spatial separation device 706 is configured to separate light signals to form separated light signals corresponding to at least one of different spatial positions of the plurality of sensors or different angular directions of the light signals. Thus, the light signals from spatial separation device 706 can have different physical locations and/or different angular directions. The spectrum separation device 704 is configured to separate the light signals to form separated light signals having different wavelengths (e.g., NIR light, visible light, SWIR light, etc.). The polarization separation device 708 is configured to separate the light signals to form the separated light signals having different polarizations (e.g., horizontal or vertical).

The devices included in signal separation device 440 can be configured and structured in any desired manner. In one embodiment, spatial separation device 706 may be disposed upstream to receive the incident light signals 702 and to direct the spatially separated light signals to spectrum separation device 704 and/or polarization separation device 708. In another embodiment, spectrum separation device 704 may be disposed upstream to receive the incident light signals 702 and to direct the spectrally separated light signals to spatial separation device 706 and/or polarization separation device 708. Similarly, polarization separation device 706 can be disposed upstream. In other words, signal separation device 440 can be configured such that the spectrum separation, spatial separation, polarization separation, and/or any other separations can be performed in any desired order. In other embodiments, two or more types of separations can be performed together. For example, as described above, a prism or a beam splitter may separate light signals both spectrally and spatially. Each of the devices 704, 706, and 708 is described in greater detail below.

One example of a spatial separation device 706 is a fiber bundle. The incident light signals 702 are coupled to the optical fiber bundle, which may include many optical fibers bundled together such that they are physically located close to each other at one end of the fiber bundle. Different optical fibers of the fiber bundle can then be routed to different sensors located at different physical locations. Another example of a spatial separation device 706 shown in FIG. 7 comprises a micro lens array configured to separate the incident light signals to form the separated light signals and direct the separated light signals to respective sensors. The micro lens array is an optical component comprising an array of small lenses. These small lenses typically have diameters ranging from tens to hundreds of micrometers. Each lens in the micro lens array focuses light signals onto a specific point or a sensor, and the overall effect of the array is to shape or manipulate the light signals in a particular way. A micro lens array can be used to enhance the resolution and sensitivity of imaging systems by focusing light signals onto a detector array or improving light collection efficiency. A micro lens array can also be used to shape light into specific patterns or distributions for use in applications such as image sensing or depth sensing. A micro lens array can also be used to couple light between optical fibers or to improve the coupling efficiency between optical components. A micro lens array can be made from materials such as glass, silicon, or plastic, and can be customized in terms of lens size, shape, and spacing to achieve the desired optical performance.

With continued reference to FIG. 7, signal separation device 440 may also include a spectrum separation device 704, which is configured to separate light signals to form the separated light signals having different wavelengths or colors. Spectrum separation device 704 comprises one or more of a Dichroic mirror, a dual-band mirror, a dual-wavelength mirror, a Dichroic reflector, a red-green-blue (RGB) filter, an infrared light filter, a colored glass filter, an interference filter, a diffractive optics, a prism, diffraction gratings, blazed gratings, holographic gratings, and a Cezrny-Turner monochromator. For example, a prism can refract light signals at different angles depending on the wavelength of the light signals. Using the visible light as an example, when a beam of incident light signals is passed through a prism, the light signals may be separated to different colors for different channels including a red channel, a green channel, and a blue channel. As another example, diffraction gratings can also be used for spectrum separation. They include a series of closely spaced parallel lines or slits that diffract light at different angles depending on the wavelength of the light. Using diffraction gratings, incident light signals can similarly be separated into a red channel, a green channel, and a blue channel. The separated light signals have different wavelengths, which may carry different information that can be more easily processed by a computer vision algorithm.

FIG. 7 also illustrates that signal separation device 440 can include a polarization separation device 708, which is configured to separate light signals to form the separated light signals having different polarizations. In one embodiment, the polarization separation device 708 comprises one or more of absorptive polarizers including crystal-based polarizers, beam-splitting polarizers, Fresnel reflection based polarizers, Birefringent polarizers, thin film based polarizers, wire-grid polarizers, and circular polarizers. For instance, polarization separation can be achieved using polarizing filters, which are optical filters that only transmit light waves with a specific polarization orientation. Polarizing filters can be made from materials such as polarizing films, wire grids, or birefringent crystals. When unpolarized light is passed through a polarizing filter, only the component of the light with the same polarization orientation as the filter is transmitted, while the other polarization component is blocked. This results in polarized light with a specific polarization orientation. For instance, when light signals pass through the polarization separation device 708, the light signals can be separated to light signals having a horizontal polarization, light signals having a vertical polarization, and light signals having all polarizations. Image data formed by light signals having different polarizations can include different information such as different contrast, brightness, color, etc.

Using one or more of the above types of separation devices and other types of separation/processing devices (e.g., an image sensor such as a CCD array), signal separation device 440 can process the incident light signals to differentiate light intensities and/or reflectivity. Light signals reflected or received at different angles by an optical receiver may have different light intensities. The different light intensities may be sensed and represented by signal separation device 440 by, for example, different brightness/colors of the image captured.

With reference back to FIG. 4, as described above, in some embodiments, light collection and distribution device 410 and signal separation device 440 may be two separate devices. For example, device 410 is configured to collect light signals from the FOV 470 and spatially distribute the received light signals, while device 440 is configured to spectrally separate the received light signals. In some embodiments, light collection and distribution device 410 and signal separation device 440 may be combined together, at least partially, to perform one of more of spatial separation, spectrum separation, polarization separation, etc. In another embodiment, light collection and distribution device 410 can directly distribute the light signals to multimodal sensor 450 without using a signal separation device 440.

With continued reference to FIG. 4, when the received light signals are processed by light collection and distribution device 410 and optionally signal separation device 440, they are passed onto multimodal sensor 450. In some embodiments, multimodal sensor 450 includes a plurality of sensors that are positioned corresponding to the respective light emitters to improve the light collection effectiveness. For example, each sensor of the plurality of sensors may be angularly positioned differently corresponding to the different angular positions of a plurality of transmitter channels directing a plurality of transmission light beams to different directions. As such, the receiving aperture for receiving return light signals formed by different transmission light beams can be maximized. Each sensor of multimodal sensor 450 may include one or more detectors or detector elements. The plurality of sensors may have different types. For instance, the plurality of sensors may comprise at least a light sensor of a first type and a light sensor of a second type. The light sensor of the first type can be configured to detect light signals having a first light characteristic, where the light sensor of the second type is configured to detect light signals having a second light characteristic. The first light characteristic can be different from the second light characteristic. For instance, the light sensor of the first type can include a sensor configured to detect light signals having an NIR wavelength for a LiDAR system. The light sensor of the second type can include a sensor configured to detect light signals having the visible light wavelength for a camera. As described above, the NIR wavelength signals can be used by the LiDAR sensor to generate point cloud data for distance measurements; while the visible light can be used by an image sensor to generate image data for visual computing.

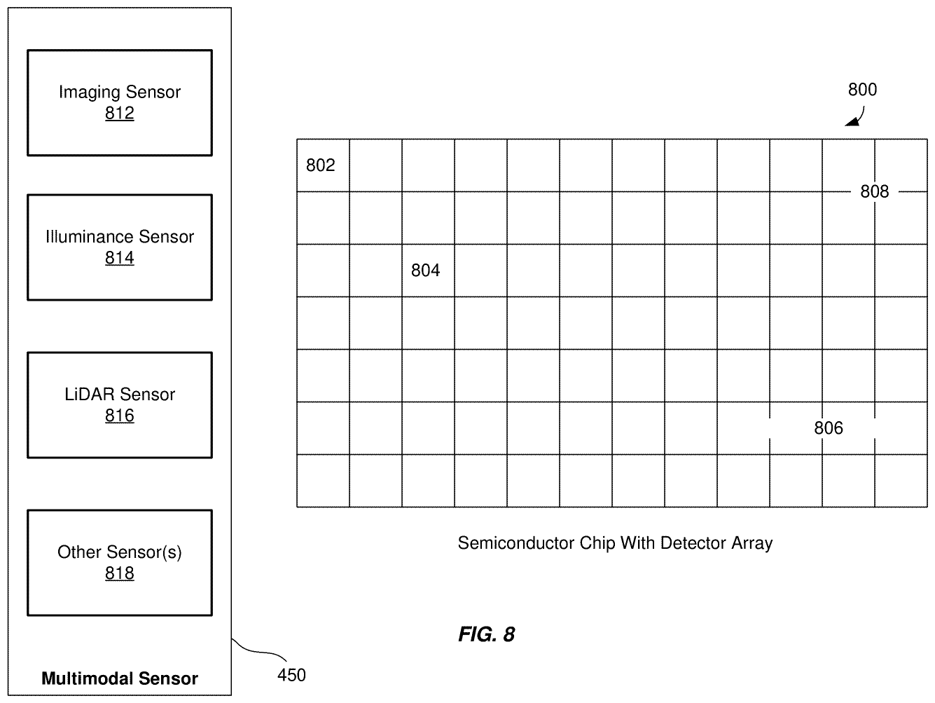

In some embodiments, the plurality of sensors of multimodal sensor 450 can be combined or integrated together. FIG. 8 illustrates example configurations of integrated detectors of a multimodal sensor 450, according to various embodiments of the present disclosure. As shown in FIG. 8, two or more sensors of a multimodal sensor can be integrated in a single device package, detector assembly, a semiconductor chip, or a single printed circuit board (PCB). For instance, a semiconductor chip 800 may include many dies sharing a semiconductor substrate. The dies can be located in the same wafer. At least a part of semiconductor chip 800 may be used as sensors for a multimodal sensor 450. In the embodiment shown in FIG. 8, chip 800 may include four sensors 802, 804, 806, and 808. Sensors 802 and 804 may be disposed in a respective die of chip 800 (one die in chip 800 is illustrated as a small square). Sensors 806 and 808 may be disposed in multiple dies. For example, sensor 806 may include 4 detectors that are disposed across 4 dies horizontally, while sensor 808 may include 4 detectors that are disposed across 4 dies both horizontally and vertically forming a 2×2 array. It is understood that a sensor can be disposed in any desired manner across any number dies. The chip 800 may also include other sensors or circuits. For instance, readout circuits for processing the sensor generated signals can be integrated in chip 800, thereby improving the degree of integration of multimodal sensor 450 and reducing cost.

Sensors that can be integrated in chip 800 may include photodiode-based detectors, avalanche photodiodes (APDs) based detectors, charge-coupled devices (CCDs) based detectors, etc. For example, photodiodes based detectors may be made from Silicon or Germanium materials; APD-based detectors may be made from Silicon, Germanium, Indium Gallium Arsenide (InGaAs), Mercury Cadmium Telluride (MCT); and CCD-based detectors can be made from Silicon, Gallium Arsenide (GaAs), Indium Phosphide (InP), and MCT. In some examples, APDs can be used for sensing infrared light for a LiDAR device, and CCD can be used for sensing visible light for a camera. Therefore, multiple sensors can be integrated together on chip 800 by using semiconductor chip fabrication techniques. It is understood that a sensor included in multimodal sensor 450 can also use other suitable semiconductor materials such as Silicon Germanium (SiGe).

With continued reference to FIG. 8, in some embodiments, chip 800 may also integrate a photonic crystal structure, which is a type of artificial periodic structure that can manipulate the flow of light in a similar way to how crystals manipulate the flow of electrons in solid-state materials. Photonic crystals are made by creating a pattern of periodic variations in the refractive index of a material. This pattern creates a photonic band gap, which is a range of frequencies of light that cannot propagate through the material. The photonic band gap arises from the interference of waves reflected by the periodic structure, leading to destructive interference at certain frequencies and constructive interference at others. The result is a range of frequencies where light cannot propagate, similar to how electronic band gaps prevent the flow of electrons in semiconductors. Photonic crystals can be made from a variety of materials, including semiconductors, metals, and polymers. A photonic crystal structure can be used to implement optical filters, detectors, waveguides, and laser emitters. For instance, the photonic band gap can be used to create optical filters; and the sensitivity of photonic crystals to changes in refractive index can be used to create highly sensitive sensors. Therefore, by using photonic crystal structure, chip 800 can integrate not only sensors or detectors, but also other optical components such as filters, waveguides, and light sources, thereby further improving the degree of integration. Various dies or modules disposed in chip 800 can thus implement different functions. Chip 800 can be bonded to other components (e.g., a readout circuitry, a PCB) using wire bonding, flip-chip bonding, BGA bonding, or any other suitable packaging techniques.

As described above, a multimodal sensor 450 (shown in FIGS. 4 and 8) may include multiple sensors. A sensor includes one or more detectors, one or more other optical elements (e.g., lens, filter, etc.) and/or electrical elements (e.g., ADC, DAC, processors, etc.). In the example shown in FIG. 8, multiple sensors can be integrated or disposed together to form a multimodal sensor 450. Multimodal sensor 450 may be included in a detector assembly, a device package, a device module, or a PCB. The multiple sensors are mounted to the same assembly, device package, device module, or PCB. In other embodiments, multimodal sensor 450 may include two or more assemblies, device packages, modules, or PCBs. Each of the multiple sensors may be mounted to a different assembly, device package, device module, or PCB. The different assemblies, device packages, modules, or PCBs may be disposed close to each other or in a housing to form an integrated multimodal sensor package.

In the example shown in FIG. 8, the multiple sensors included in multimodal sensor 450 comprise an imaging sensor 812, an illuminance sensor 814, a LiDAR sensor 816, and one or more other sensors 818. An imaging sensor 812 can include a detector that detects light signals and converts the light signals to electrical signals to form images. Therefore, imaging sensor 812 can be used as a part of cameras. The imaging sensor 812 can be a CCD sensor, a CMOS sensor, an active-pixel sensor, a thermal-imaging sensor, etc. An illuminance sensor 814 can include a detector that facilitates measuring the amount of light falling on a surface per unit area, referred to as illuminance. Illuminance can be represented for example, by the amount of lumen per square meter. Illuminance sensor 814 can include detectors comprising photodiodes, phototransistors, photovoltaic cells, photoresistors, etc. Illuminance sensor 814 can be used for lighting control, brightness control, environmental monitoring, etc.

LiDAR sensor 816 can include detectors that detect laser light (e.g., in the infrared wavelength range). The detected laser light can be used to determine the distance of an object from the LiDAR sensor. LiDAR sensor 816 can be used to generate a 3D point cloud of the surrounding area. The detectors used for a LiDAR sensor can be an avalanche photodiode, Mercury-Cadmium-Telluride (HgCdTe) based infrared detectors, Indium Antimonide (InSb) based detectors, etc. LiDAR sensor 816 can be implemented using one or more components of LiDAR system 300 described above. FIG. 8 also illustrates that multimodal sensor 450 may include one or more other sensors 818. These other sensors 818 can facilitate temperature sensing, chemical sensing, pressure sensing, motion sensing, light sensing, proximity sensing, etc. One or more sensors 818 can include detectors such as light emitting diodes (LEDs), photoresistors, photodiodes, phototransistors, pinned photodiodes, quantum dot photoconductors/photodiodes, silicon drift detectors, photovoltaic based detectors, avalanche photodiode (APD), thermal based detectors, Bolometers, microbolometers, cryogenic detectors, pyroelectric detectors, thermopiles, Golay cells, photoreceptor cells, chemical-based detectors, polarization-sensitive photodetectors, and graphene/silicon photodetectors, etc.

With reference to FIGS. 4 and 8, The plurality of sensors of multimodal sensor 450 can include multiple types of sensors integrated or mounted together to share, for example, a semiconductor wafer, a module, a printed circuit board, and/or a semiconductor package. The sensors may also share one or more components the transmission light path (e.g., light source 402, transmitter 404, and/or steering mechanism 406) and/or in the receiving light path (e.g., light collection and distribution device 410, signal separation device 440). As a result, the multimodal sensor 450 can have a compact dimension, thereby enabling the multimodal detection system to be also compact. A compact multimodal detection system can be disposed in, or mounted to, any location within a moveable platform such as a motor vehicle. For instance, comparing to mounting multiple discreate sensors like one or more cameras, one or more LiDARs, one or more thermal imaging devices, one or more ultrasonic devices, etc., mounting a compact multimodal detection system can significantly reduce the complexity of integration of the multiple sensing capabilities into a vehicle, and/or also reduce the cost. As illustrated in FIGS. 4 and 8, a multimodal detection system (e.g., system 400) that includes a multimodal sensor (e.g., sensor 450) is also sometimes referred to as a hybrid detection and ranging system (HyDAR).

With continued reference to FIGS. 4 and 8, in some embodiments, the plurality of detectors or sensors of a multimodal sensor 450 can be configured to detect light signals received from the same FOV. For instance, FIG. 4 illustrates that light signals received from the same FOV 470 may include two or more of: NIR light, visible light, SWIR light, MWIR light, LWIR light, and other light. These light signals are mixed together but can be detected by the same multimodal sensor 450. For instance, as described above, the mixed light signals can be collected and distributed by device 410, and then separated according to one or more of the light characteristics (e.g., wavelength, polarization, angle of incidence, etc.) by signal separation device 440. The separated light signals can then be detected by a corresponding light sensor included in multimodal sensor 450. In this manner, multimodal detection system 400 provides integrated multimodal sensing capabilities, reducing or eliminating the need for multiple discreate or separate sensors like cameras, LiDARs, thermal imaging devices, etc. This will make the sensing device more integrated and compact, reducing the cost, and improving the sensing efficiency. As one example, when discreate sensors are separately mounted to a vehicle (or another moveable platform), data captured by different sensors (e.g., a LiDAR sensor and an image sensor like a camera) often need to be time synchronized and/or converted to use the same coordinate system. This data fusion process can be cumbersome, error prone, inefficient, and power consuming. By integrating multiple sensors together in a multimodal sensor disclosed herein, at least some of the above problems can be solved. For instance, if a LiDAR sensor and an image sensor are integrated together (e.g., disposed in one device package, PCB, and sharing at least a part of the transmitting/receiving light paths), data from the two sensors can be fused together directly without having to perform time synchronization or coordinates conversion first, or with minimum fusion effort.

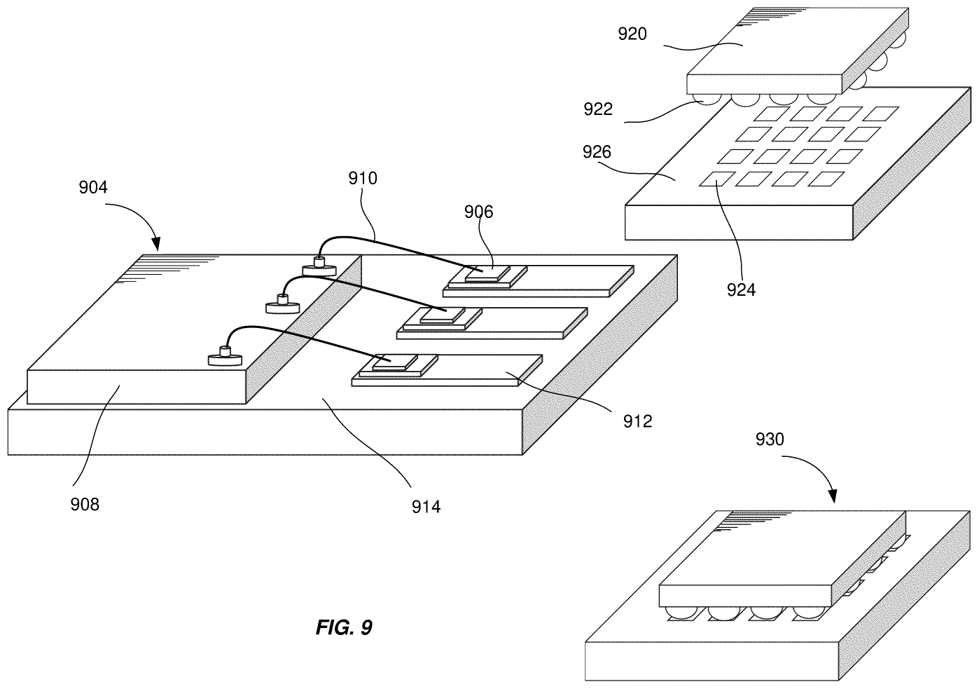

As described above, multimodal sensor 450 can include an integrated sensor array comprising multiple sensors having different types. FIG. 9 illustrates example packaging configurations for integrated sensors, according to various embodiments of the present disclosure. As shown in FIG. 9, a multimodal sensor device 904 may include a plurality of sensors 906, each of which is disposed on a heatsink 912. The sensors 906 may be of the same type of different types. Each of the sensors 906 can be wired bonded to an integrated circuit chip 908. The IC chip 908 can be used to process electrical signals generated by the sensors 906, thereby implementing a readout circuitry. The IC chip 908 can further include other signal processing circuits such as rendering images, performing digital signal processing functions, etc. In this configuration, the sensor array is integrated with the readout circuitry in the same device package (e.g., both IC chip 908 and sensor array 906 are disposed on the same PCB 914). In other embodiments, the sensor array and the readout circuitry may be individually packaged in separate modules. The two separate modules can then be mounted to a PCB board so that signals can be passed between the two modules.

FIG. 9 also illustrates another packaging configuration where the readout circuits 920 are disposed in one semiconductor chip and the integrated sensor array 924 are disposed in another semiconductor chip 926. The two chips 920 and 926 are bonded together via flip-chip technologies so that electrical signals can be delivered from the sensor array 924 to the readout circuits 920 via solder bumps 922. Once bonded, the two chips 920 and 926 can be packaged together as a single device 930. It is understood that other packaging techniques can also be used, for example, through-hole packaging, surface-mounting packaging, ball grid array packaging, chip-scale packaging, etc.

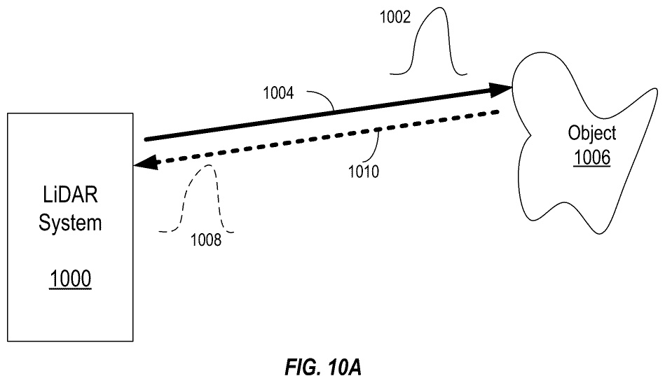

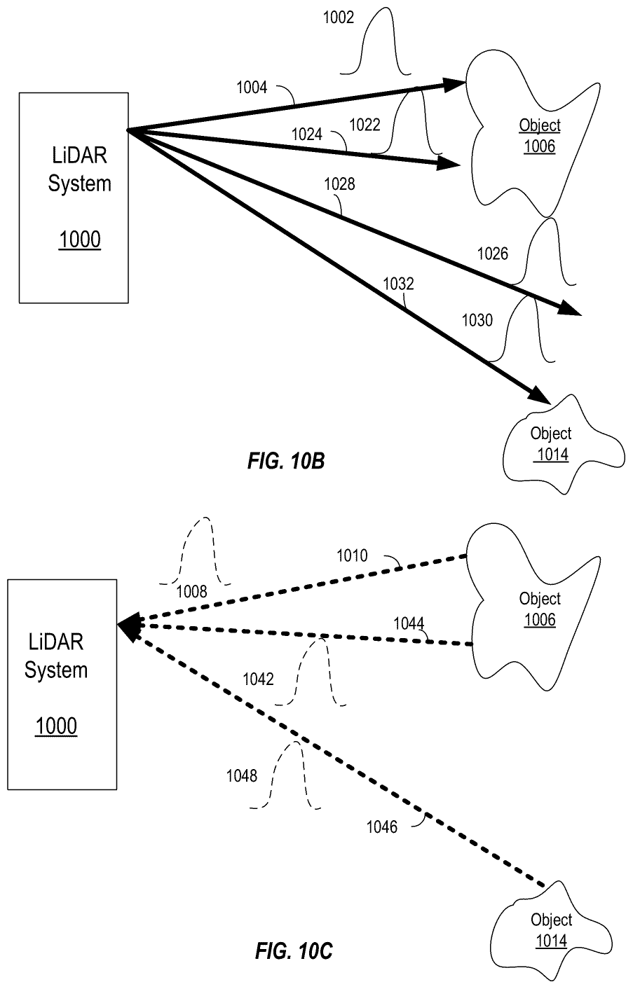

As described above, some LiDAR or HyDAR systems use the time-of-flight (ToF) of light signals (e.g., light pulses) to determine the distance to objects in a light path. The following description uses LiDAR system 1000 as an example. It is understood that the LiDAR device or sensor in a HyDAR system may operate similarly. For example, with reference to FIG. 10A, an example LiDAR system 1000 includes a laser light source (e.g., a fiber laser), a steering mechanism (e.g., a system of one or more moving mirrors), and a light detector (e.g., a photodetector with one or more optics). LiDAR system 1000 can be implemented using, for example, LiDAR system 300 described above. LiDAR system 1000 transmits a light pulse 1002 along light path 1004 as determined by the steering mechanism of LiDAR system 1000. In the depicted example, light pulse 1002, which is generated by the laser light source, is a short pulse of laser light. Further, the signal steering mechanism of the LiDAR system 1000 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 10A (e.g., illustrating a time-of-flight LiDAR system that uses light pulses), when light pulse 1002 reaches object 1006, light pulse 1002 scatters or reflects to form a return light pulse 1008. Return light pulse 1008 may return to system 1000 along light path 1010. The time from when transmitted light pulse 1002 leaves LiDAR system 1000 to when return light pulse 1008 arrives back at LiDAR system 1000 can be measured (e.g., by a processor or other electronics, such as control circuitry 350, within the LiDAR system). This time-of-flight combined with the knowledge of the speed of light can be used to determine the range/distance from LiDAR system 1000 to the portion of object 1006 where light pulse 1002 scattered or reflected.

By directing many light pulses, as depicted in FIG. 10B, LiDAR system 1000 scans the external environment (e.g., by directing light pulses 1002, 1022, 1026, 1030 along light paths 1004, 1024, 1028, 1032, respectively). As depicted in FIG. 10C, LiDAR system 1000 receives return light pulses 1008, 1042, 1048 (which correspond to transmitted light pulses 1002, 1022, 1030, respectively). Return light pulses 1008, 1042, and 1048 are formed by scattering or reflecting the transmitted light pulses by one of objects 1006 and 1014. Return light pulses 1008, 1042, and 1048 may return to LiDAR system 1000 along light paths 1010, 1044, and 1046, respectively. Based on the direction of the transmitted light pulses (as determined by LiDAR system 1000) as well as the calculated range from LiDAR system 1000 to the portion of objects that scatter or reflect the light pulses (e.g., the portions of objects 1006 and 1014), the external environment within the detectable range (e.g., the field of view between path 1004 and 1032, inclusively) can be precisely mapped or plotted (e.g., by generating a 3D point cloud or images).

If a corresponding light pulse is not received for a particular transmitted light pulse, then LiDAR system 1000 may determine that there are no objects within a detectable range of LiDAR system 1000 (e.g., an object is beyond the maximum scanning distance of LiDAR system 1000). For example, in FIG. 10B, light pulse 1026 may not have a corresponding return light pulse (as illustrated in FIG. 10C) because light pulse 1026 may not produce a scattering event along its transmission path 1028 within the predetermined detection range. LiDAR system 1000, or an external system in communication with LiDAR system 1000 (e.g., a cloud system or service), can interpret the lack of return light pulse as no object being disposed along light path 1028 within the detectable range of LiDAR system 1000.

In FIG. 10B, light pulses 1002, 1022, 1026, and 1030 can be transmitted in any order, serially, in parallel, or based on other timings with respect to each other. Additionally, while FIG. 10B depicts transmitted light pulses as being directed in one dimension or one plane (e.g., the plane of the paper), LiDAR system 1000 can also direct transmitted light pulses along other dimension(s) or plane(s). For example, LiDAR system 1000 can also direct transmitted light pulses in a dimension or plane that is perpendicular to the dimension or plane shown in FIG. 10B, thereby forming a 2-dimensional transmission of the light pulses. This 2-dimensional transmission of the light pulses can be point-by-point, line-by-line, all at once, or in some other manner. That is, LiDAR system 1000 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHZ. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHZ (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-23, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

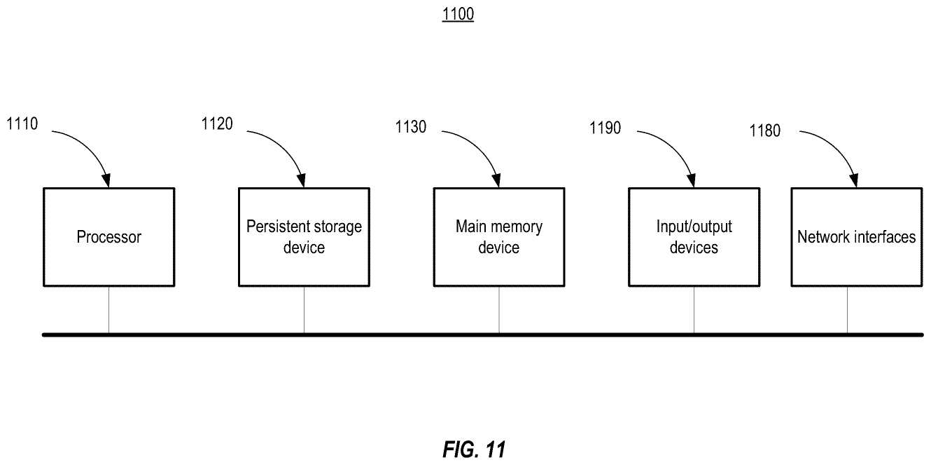

A high-level block diagram of an example apparatus that may be used to implement systems, apparatus and methods described herein is illustrated in FIG. 11. Apparatus 1100 comprises a processor 1110 operatively coupled to a persistent storage device 1120 and a main memory device 1130. Processor 1110 controls the overall operation of apparatus 1100 by executing computer program instructions that define such operations. The computer program instructions may be stored in persistent storage device 1120, or other computer-readable medium, and loaded into main memory device 1130 when execution of the computer program instructions is desired. For example, processor 1110 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-23 can be defined by the computer program instructions stored in main memory device 1130 and/or persistent storage device 1120 and controlled by processor 1110 executing the computer program instructions. For example, the computer program instructions can be implemented as computer executable code programmed by one skilled in the art to perform an algorithm defined by the method steps discussed herein in connection with at least some of FIGS. 1-23. Accordingly, by executing the computer program instructions, the processor 1110 executes an algorithm defined by the method steps of these aforementioned figures. Apparatus 1100 also includes one or more network interfaces 1180 for communicating with other devices via a network. Apparatus 1100 may also include one or more input/output devices 1190 that enable user interaction with apparatus 1100 (e.g., display, keyboard, mouse, speakers, buttons, etc.).

Processor 1110 may include both general and special purpose microprocessors and may be the sole processor or one of multiple processors of apparatus 1100. Processor 1110 may comprise one or more central processing units (CPUs), and one or more graphics processing units (GPUs), which, for example, may work separately from and/or multi-task with one or more CPUs to accelerate processing, e.g., for various image processing applications described herein. Processor 1110, persistent storage device 1120, and/or main memory device 1130 may include, be supplemented by, or incorporated in, one or more application-specific integrated circuits (ASICs) and/or one or more field programmable gate arrays (FPGAs).

Persistent storage device 1120 and main memory device 1130 each comprise a tangible non-transitory computer readable storage medium. Persistent storage device 1120, and main memory device 1130, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1190 may include peripherals, such as a printer, scanner, display screen, etc. For example, input/output devices 1190 may include a display device such as a cathode ray tube (CRT), plasma or liquid crystal display (LCD) monitor for displaying information to a user, a keyboard, and a pointing device such as a mouse or a trackball by which the user can provide input to apparatus 1100.

Any or all of the functions of the systems and apparatuses discussed herein may be performed by processor 1110, and/or incorporated in, an apparatus or a system such as LiDAR system 300. Further, LiDAR system 300 and/or apparatus 1100 may utilize one or more neural networks or other deep-learning techniques performed by processor 1110 or other systems or apparatuses discussed herein.

One skilled in the art will recognize that an implementation of an actual computer or computer system may have other structures and may contain other components as well, and that FIG. 11 is a high-level representation of some of the components of such a computer for illustrative purposes.

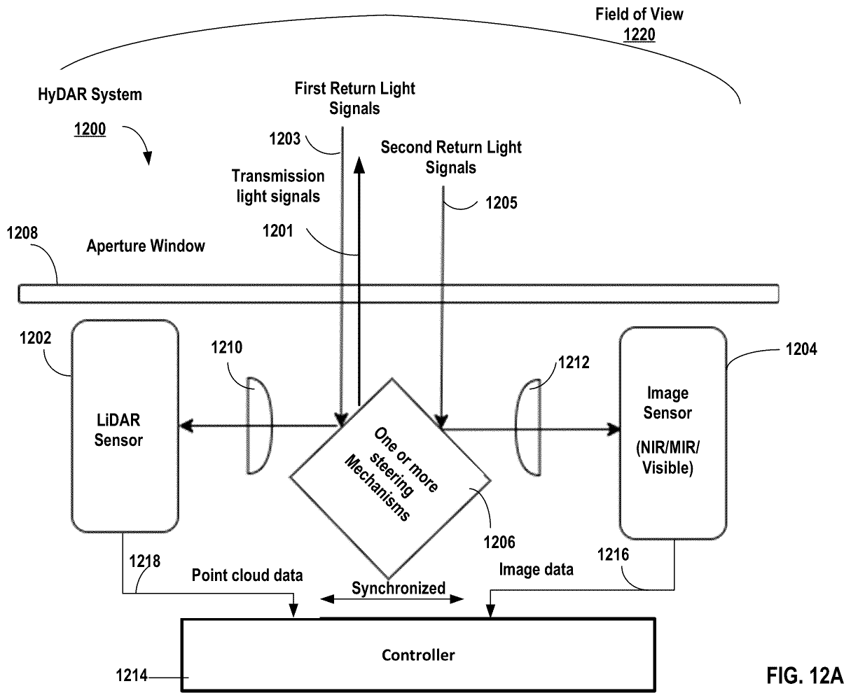

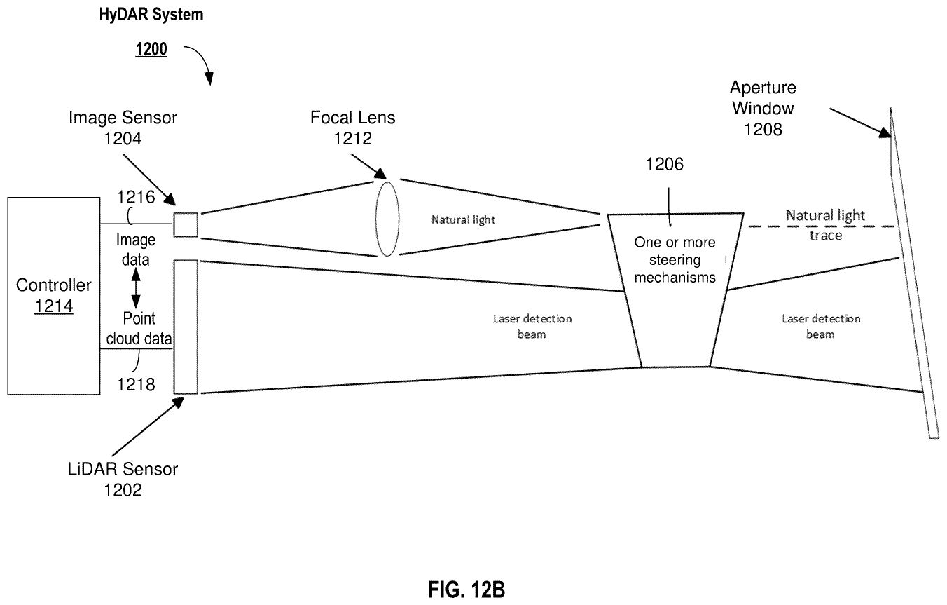

FIG. 12A is block diagram illustrating an example HyDAR system 1200 according to various embodiments. FIG. 12B is a block diagram illustrating the example HyDAR 1200 system in a side view, according to various embodiments. In some examples, as shown in FIGS. 12A and 12B, HyDAR system 1200 includes a LIDAR sensor 1202 and an image sensor 1204. As described above, LiDAR sensor 1202 and image sensor 1204 may be integrated together (e.g., disposed in a same semiconductor die or package) or combined together to form a multimodal sensor. The LiDAR sensor 1202 can be configured to detect first return light signals having a first wavelength (e.g., light signals in the infrared wavelength range) and the image sensor 1204 can be configured to detect second return light signals having a second wavelength (e.g., light signals in the visible light wavelength range). The LiDAR sensor 1202 may include, for example, at least a part of optical receiver and light detector 330 described above in connection with FIG. 3 and/or at least a part of optical receiver and light detector 430 of the multimodal detection system 400 described above in connection with FIG. 4. The multimodal sensor formed by the LiDAR sensor 1202 and the image sensor 1204 can be substantially the same as the multimodal sensor 450 described above. The image sensor 1204, in some examples, can include a near-infrared (NIR) sensor, a mid-infrared (MIR) sensor, and/or a visible light sensor.

With reference still to FIG. 12A, HyDAR system 1200 also includes, for example, one or more steering mechanisms 1206, lens or lens groups 1210 and 1212, an aperture window 1208, and a controller 1214. Other components of the HyDAR system 1200 are omitted from FIG. 12A for simplicity. For example, FIG. 12A does not show a light source but it is understood that a light source, transmitter, and other components similar to those described above for a multimodal detection system (e.g., system 400) can be included in HyDAR system 1200.

The LiDAR sensor 1202 and image sensor 1204 shown in FIG. 12A form a multimodal sensor and thus share some of the transmitting and receiving light paths. For instance, as shown in FIG. 12A, one or more steering mechanisms 1206 can be shared between the LiDAR sensor 1202 and image sensor 1204. A light source (not shown in FIG. 12A) sends laser light signals to the steering mechanisms 1206 (which can include a polygon mirror, an oscillation mirror, a prism, a lens, and/or any other optical components configured to steer light). The one or more steering mechanisms 1206 redirect the laser light signals to form transmission light signals 1201, which are scanned across the FOV 1220 in both horizontal and vertical directions to illuminate one or more objects in the FOV 1220. The transmission light signals 1201 may have a wavelength in the infrared wavelength range. When the transmission light signals 1201 are scattered or reflected by one or more objects in FOV 1220, first return light signals 1203 are formed. The first return light signals 1203 have the same wavelength as the transmission light signals 1201 and are directed back to steering mechanisms 1206. In turn, steering mechanisms 1206 redirect the first return light signals 1203 toward LiDAR sensor 1202 via one or more receiving optical components such as a collection lens or lens group 1210. Thus, one or more steering mechanisms 1206 is used to perform both transmission of laser light signals toward the aperture window 1208 and receiving first return light signals 1203 formed based on at least a portion of the laser light signals provided by the laser light source.

At least a part of the light path described above associated with the LiDAR sensor 1202 can be shared with the image sensor 1204. Image sensor 1204 may be a camera that senses second return light signals 1205 (e.g., NIR/MIR/visible light). The second return light signals 1205 are formed from light provided by one or more external light sources external to the HyDAR system 1200. Such light sources may include, for example, sunlight, moonlight, light from vehicle headlights, and/or streetlights. These light sources can directly emit light to the HyDAR system 1200. The second return light signals 1205 can also include reflection, transmission, and/or refraction of the light emitted by the aforementioned light sources. Other visible light sources are also possible, and the second return light signals 1205 are not limited to the above-described light signals. The second return light signals 1205 are also received by one or more steering mechanisms 1206. Steering mechanisms 1206 then redirect the second return light signals 1205 to image sensor 1204 via one or more receiving optical components like collection lens or lens group 1212 (FIG. 12A). Lens or lens group 1212 may be a focal lens (FIG. 12B). In some examples, collection lens 1210 and focal lens 1212 may be the same lens, and other optical components (e.g., a mirror, a wavelength splitter, etc.) be used to separate the first and second return light signals and redirect them to respective LiDAR sensor 1202 and image sensor 1204. The details of light collection and distribution, and signal separation are described above in connection with FIGS. 6 and 7, and are therefore not repeatedly described.

While FIG. 12A illustrates that the LiDAR sensor 1202 and image sensor 1204 are located at two opposite sides of the one or more steering mechanisms 1206, they may be located at the same side. FIG. 12B illustrates a side view of such a configuration, where the LiDAR sensor 1202 and the image sensor 1204 are located at the same side of steering mechanisms 1206 and are aligned to receive the respective return light signals. In some examples, because the wavelengths of the return light signals received by the image sensors 1204 and LiDAR sensors 1202 are different, a focal lens 1212 is used to adjust the focal length of the optical path of the second return light signals 1205. As shown in FIG. 12B, the image sensor 1204 and LiDAR sensor 1202 may be placed on a same semiconductor substrate/die/package/PCB, and thus, the focal lens 1212 can adjust the focal length of the visible light received and redirected by the steering mechanisms 1206.

As shown in FIG. 12B, in some examples, the LiDAR sensor 1202 and image sensor 1204 at least share a part of the receiving light path. In particular, the first return light signals 1203 and second return light signals 1205 are both received through the aperture window 1208, redirected by steering mechanisms 1206 and other shared optical components (e.g., a same collection lens). The focal length of one optical path for the second return light signals 1205 may be adjusted by using a focal lens 1212. Therefore, the first return light signals 1203 and the second return light signals 1205 may be time and space synchronized already at the hardware level, when they are received by the LiDAR sensor 1202 and image sensor 1204, respectively.

With reference still to FIGS. 12A and 12B, the LiDAR sensor 1202 obtains one or more frames of point cloud data based on the received first return light signals 1203 (e.g., return pulses in the infrared wavelength range). For instance, the LiDAR sensor 1202 can convert the first return light signals 1203 to analog electrical signals, which can then be sampled and digitized to form one or more frames of point cloud data 1218. Point cloud data 1218 represents the FOV 1220 based on the scanning of the FOV 1220 using the transmission light signals 1201 in the first wavelength (e.g., infrared light). The image sensor 1204 obtains one or more frames of image data 1216 based on the second return light signals 1205 (e.g., reflected visible light from one or more objects in the FOV 1220). For instance, the image sensor 1204 can be a camera that has a high resolution such that it captures the FOV 1220 based on the received light signals in a second wavelength (visible/NIR/MIR light). The image sensor 1204 (e.g., a CMOS camera, a CCD camera) converts the detected light signals to electrical signals to form one or more frames of image data 1216.

As described above, if discreate sensors are separately mounted to a vehicle (or another moveable platform), data captured by different sensors (e.g., a LiDAR sensor and an image sensor like a camera) often need to be time synchronized and/or converted to use the same coordinate system. This is because the discreate sensors are not time synchronized so the images captured by the discreate sensors may be shifted in timing. Moreover, the discreate sensors may be mounted to different locations of the vehicle (e.g., a LiDAR sensor mounted to the rooftop of the vehicle, while the camera is mounted to a side mirror of the vehicle). Thus, the angles from which they capture the images are different. To fuse the image data provided by the discreate sensors, coordinate systems need to be transformed. This complex process is often referred to as data fusion. The data fusion process can involve a large number of computational efforts using vectors and matrixes, because both the LiDAR sensor and the image sensor can generate a large amount of data over every unit of time (e.g., per second, minute, or hour). And if the LiDAR sensor and the image sensor operate for an extended period of time (like when they are used for a vehicle and operate for hours), they can generate even a huge amount of data over time. The data fusion process thus typically requires a very large computational capability of the system, and therefore often requires additional hardware (e.g., many GPUs) and/or software support. The data fusion process can thus be cumbersome, error prone, inefficient, costly, and power consuming.

By integrating multiple sensors together in a multimodal sensor (e.g., sensor 450) disclosed herein, at least some of the above problems can be solved. For instance, in FIG. 12A, a LiDAR sensor 1202 and an image sensor 1204 are integrated together. Thus, LiDAR sensor 1202 and image sensor 1204 are disposed in one semiconductor die/device package/PCB, and can share at least a part of the transmitting/receiving light paths. As shown in FIGS. 12A and 12B, the steering mechanisms 1206 may have an optical scanner (e.g., a polygon mirror, an oscillation mirror, or a combination thereof) that is configured to perform: (1) scanning the laser light signals 1201 in both horizontal and vertical directions; (2) receiving the first return light signals 1203 and the second return light signals 1205; and (3) directing the first return light signals 1203 and the second return light signals 1205 to the LiDAR sensor 1202 and the image sensor 1204, respectively. Because of the hardware-level integration, the point cloud data 1218 generated by LiDAR sensor 1202 and the image data 1216 generated by image sensor 1204 are time-and-space synchronized. In particular, as shown in FIG. 12A, the corresponding frames between the point cloud data 1218 and the image data 1216 are already synchronized in time. Moreover, the angles from which the LiDAR sensor 1202 and the image sensor 1204 capture the FOV 1220 are the same. Thus, there is no need to perform coordinate transformation. Data 1218 and 1216 from the two sensors 1202 and 1204, respectively, can be fused together directly by controller 1214 without having to perform time synchronization or coordinate transformation. The data fusion process is thus enabled early by the hardware configurations (e.g., by using the same steering mechanism 1206 and sharing other optical components). This kind of data fusion is thus referred to as early fusion, as compared to data fusion performed by software by the vehicle planning and perception system at a later stage. The latter type of data fusion requires a computer system to take the point cloud data and the image data separately, perform alignment of the timing between the two sets of data, and perform coordinate transformation between the two sets of data to correlate between them. The early fusion thus greatly improves the data processing efficiency, reduces the computational efforts, and power consumption.

As described above, a HyDAR system 1200 may include a controller 1214. The controller 1214 may control the operations of the various components of the HyDAR system 1200 and may also process data generated by the multimodal sensor including the LiDAR sensor 1202 and the image sensor 1204. Based on the data (e.g., the already fused data at the hardware level), the controller 1214 may also be configured to detect one or more degradation factors affecting the HyDAR system's performance, and cause adjustment of one or more device configurations and/or one or more operational conditions of the HyDAR system to remove or reduce the impact of the degradation factors. In some other cases, other than the controller 1214, there may be another circuitry or computer system connected with the HyDAR system 1200 for performing at least some of the aforementioned operations. As described above, various external and internal factors may affect the HyDAR system's performance, and thus over time, the HyDAR system's performance may degrade. A HyDAR system's degradation factors may include, for example, at least a partial window blockage of the aperture window, interference signals provided by one or more interference light sources, extrinsic calibration degradation measured by a relation between the HyDAR system and a moveable platform to which the HyDAR system is mounted, and intrinsic calibration degradation associated with misaligned internal components of the HyDAR system. Each one of these degradation factors is described in detail below.

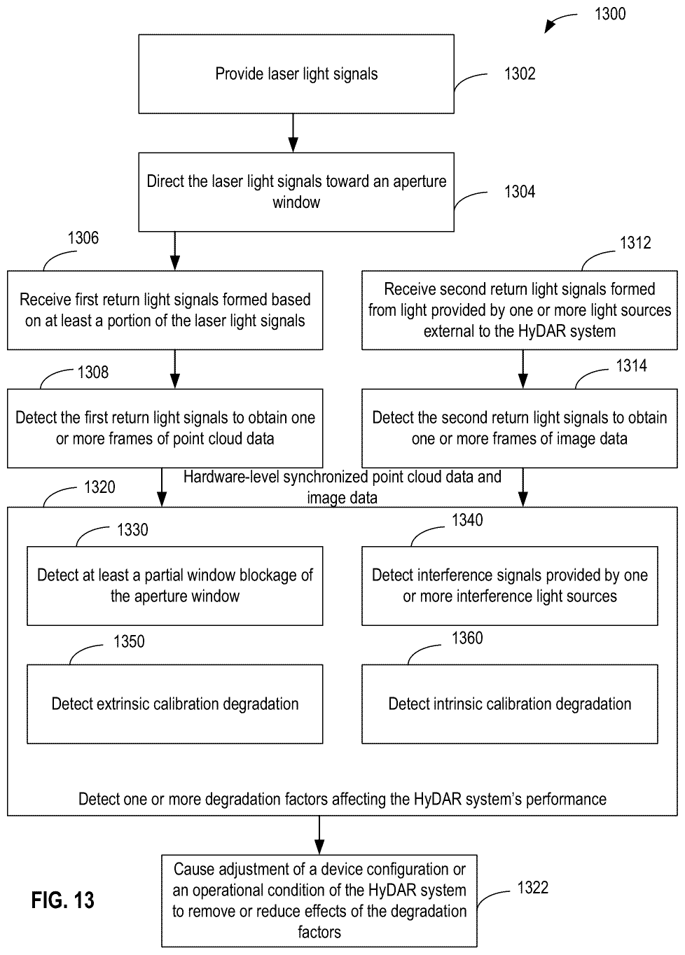

FIG. 13 is a flowchart 1300 illustrating a method for detecting operation of a HyDAR system (e.g., HyDAR system 1200) for detecting one or more of the performance degradation factors, according to various embodiments. As shown in FIG. 13, in some examples, a light source or transmitter in the HyDAR system provides laser light signals (block 1302). The one or more steering mechanisms of the HyDAR system direct the laser light signals toward an aperture window (block 1304). Absent a complete window blockage at the aperture window, the laser light signals go through the aperture window. In block 1306, the HyDAR system receives the first return light signals formed based on at least a portion of the laser light signals. In block 1312, the HyDAR system receives the second return light signals provided by one or more light sources external to the HyDAR system. The first return light signals and second return light signals may be received by the same steering mechanism of the HyDAR system as described above.

Next, in block 1308, a LiDAR sensor in the HyDAR system detects the first return light signals to obtain one or more frames of point cloud data. In block 1314, an image sensor of the HyDAR system detects the second return light signals to obtain one or more frames of image data. As described above, the point cloud data and the image data are time-and-space synchronized at the hardware level such that no additional processor (e.g., GPU) or software is needed for synchronizing them. The controller of the HyDAR system, based on one or both of the point cloud data and the image data, can perform detection of one or more performance degradations factors affecting the HyDAR system's performance (block 1320). Such detections include detecting at least a partial window blockage of the aperture window (block 1330), detecting interference signals provided by one or more interference light sources (block 1340), detecting extrinsic calibration degradation measured by a relation between the HyDAR system and a moveable platform to which the HyDAR system is mounted (block 1350), and detecting intrinsic calibration degradation associated with misaligned internal components of the HyDAR system (block 1360). In some examples, the controller of the HyDAR system may also cause adjustments of device configuration and/or an operational condition of the HyDAR system to remove or reduce the negative impact of the degradation factors (block 1322). Blocks 1330, 1340, 1350, and 1360 are described in greater detail below.

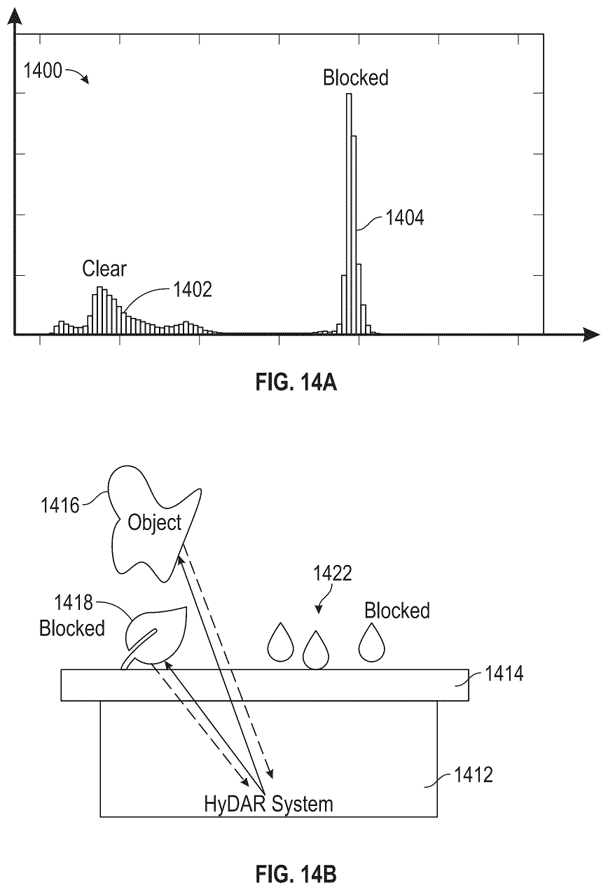

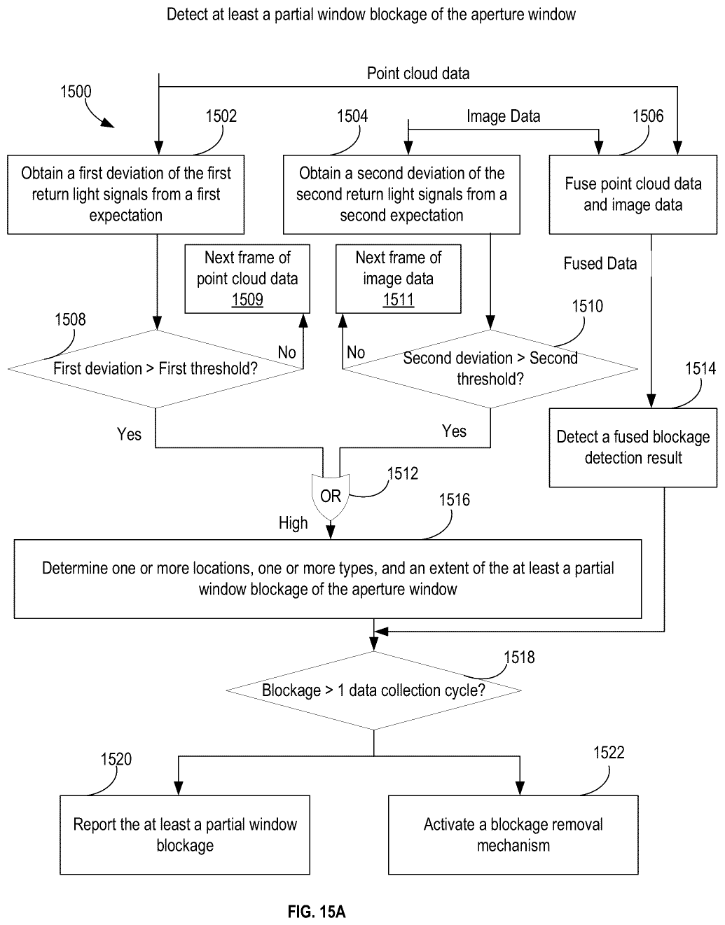

Beginning with block 1330, the detection of at least a partial window blockage of the HyDAR system is described in detail. FIG. 14A is a histogram chart illustrating a comparison of return signal intensities between an at least partially blocked aperture window and an unblocked aperture window, according to various embodiments. In FIG. 14A, the vertical axis represents the signal intensity, and the horizontal axis represents the number of received return light signals falling in each of the bin of the signal intensity. As shown in FIG. 14A, signals 1402 and 1404 represent first return light signals that are formed based on transmitted laser signals from the HyDAR system. If an aperture window (e.g., window 1208 shown in FIGS. 12A and 12B) is not blocked, the return light signals 1402 may have the normal intensity, depending on if the return light signals 1402 are formed by an object located at or proximate to the aperture window or by an object located at a distance far away from the aperture window. Generally, the further away the object is located, the smaller the intensity of the return light signals. In contrast, if an aperture window is at least partially blocked, the return light signal 1404 has a higher signal intensity compared to that of return light signal 1402 (which is received based on normal scattering without blockage). This is because the laser light signals from the HyDAR system is scattered more towards the detectors due to the blockage. Thus, the return light signal 1404 is formed by scattering of the transmitted light signals by the blocked aperture window, the objects that block the aperture window, and/or other internal components of the HyDAR system. As such, the signal intensity of the return light signals 1404 can be considerably large. An aperture window blockage can therefore be detected based on the signal intensity of the return light signals formed based on the transmitted laser light signals. In other words, in some cases, the window blockage can be detected using the point cloud data generated by the LiDAR sensor alone. In other examples, the window blockage can be detected using both the point cloud data generated by the LiDAR sensor and the image data generated by the image sensor, as described in more detail below. The addition of the image data provides more information of the blockage and helps to improve the blockage detection precision and/or the classification of the blocking objects.

Many types of objects may cause window blockage for an aperture window of a HyDAR system. FIG. 14B is a diagram illustrating at least a partial aperture window blockage for a HyDAR system due to several different types of objects, according to various embodiments. For instance, as shown in FIG. 14B, an aperture window 1414 of a HyDAR system 1412 may be blocked (or partially blocked) by object 1418 (e.g., a leaf) or object 1422 (e.g., water condensations/rain drops). Objects 1418 and/or 1422 may be located at or proximate to the aperture window, therefore blocking at least a portion of the window 1414. Other types of objects may also block the window 1414, like a plastic bag, a paper, debris, dirt, snow, etc. If window 1414 is at least partially blocked, the transmission light signals emitted from a laser light source of the HyDAR system 1412 may be blocked or scattered by, e.g., objects 1418 and/or 1422. The return signals generated by objects 1418 and/or 1422 may correspond to the signals 1404 in FIG. 14A, which have a high signal intensity. FIG. 14B shows that aperture window 1414 is partially blocked, and therefore, the transmission light signals can go through window 1414 and possibly reach an object 1416 in the FOV. Object 1416 may be an object located at a distance away from the aperture window 1414 (near or far), and may form first return light signals corresponding to signals 1402 in FIG. 14A. The below disclosure describes several embodiments of methods for detecting at least a partial window blockage of an aperture window and determining the locations, types, and extent of the blockage.

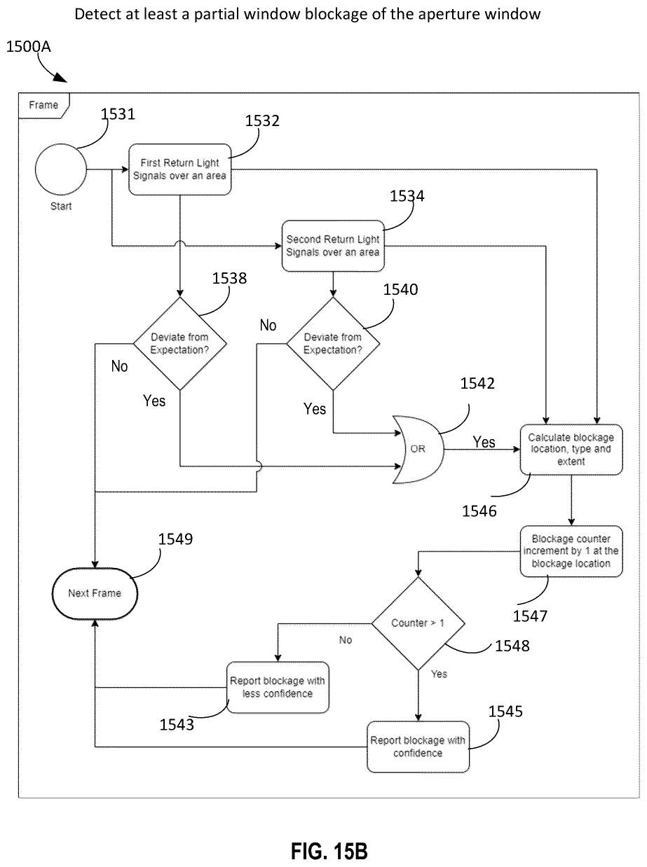

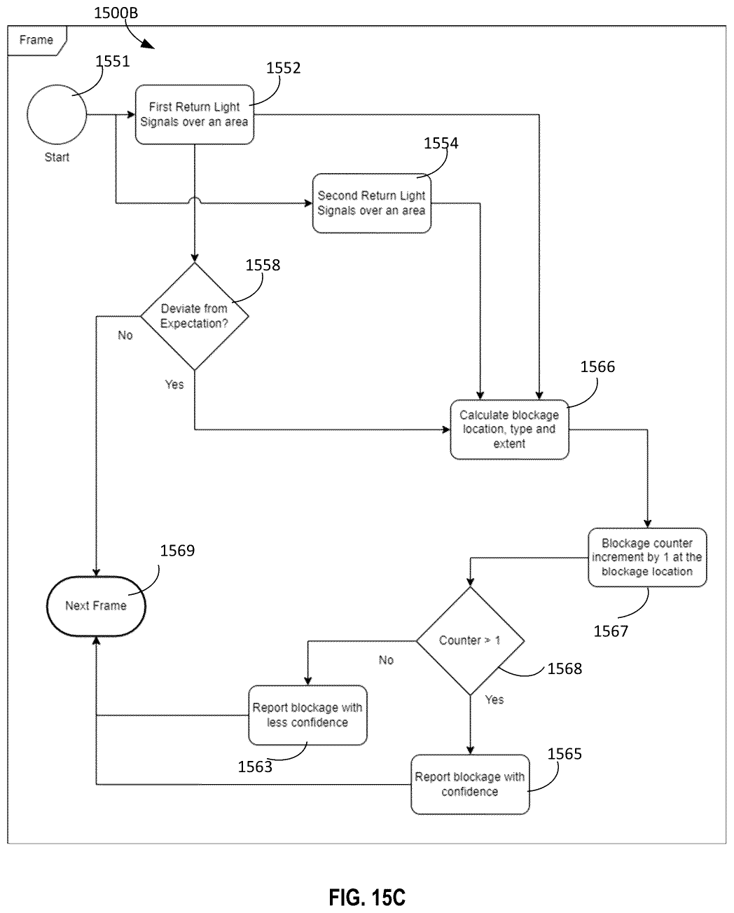

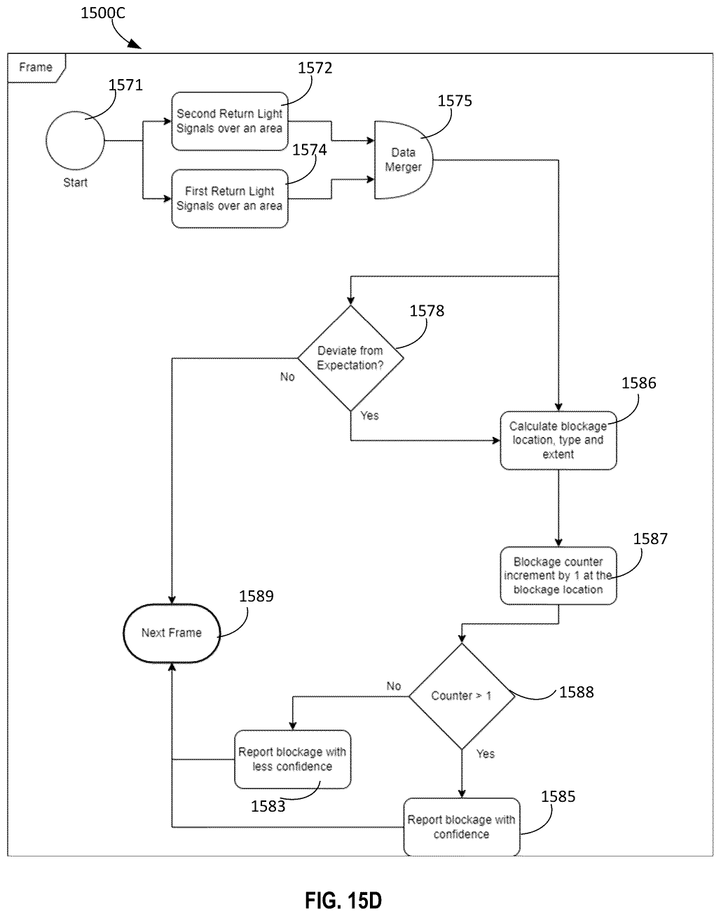

FIGS. 15A-15D are flowcharts illustrating various methods for detecting aperture window blockage of a HyDAR system, according to various embodiments. FIG. 15A provides an overview of the methods for detecting aperture window blockage using point cloud data, image data, a combination thereof, and/or fused data. As shown in FIG. 15A, method 1500 can be performed by a controller (e.g., control circuitry 350 or controller 1214 described above) or another computing device (e.g., a device shown in FIG. 11). A controller may include both analog circuitry for processing analog signals (e.g., analog voltage or current signals converted from return light signals), digital circuitry for processing digital signals (e.g., digitized/sampled analog voltage or current signals), or mixed signal circuitry for processing mixed signals, For simplicity, method 1500 is described below by using a controller to detect at least a partial window blockage of the aperture window of a HyDAR system. Method 1500 corresponds to block 1330 of FIG. 13.

As described above, in a HyDAR system (e.g., system 1200), a LiDAR sensor (e.g., sensor 1202) can convert first return light signals (e.g., signals 1203) to electrical signals, based on which point cloud data (e.g., data 1218) are generated. An image sensor (e.g., sensor 1204) can convert second return light signals (e.g., signals 1205) to electrical signals, based on which image data (e.g., data 1216) are generated. The point cloud data may include one or more frames. A frame of point cloud data may correspond to a one complete scan of the FOV. Similarly, the image data may include one or more frames. A frame of the image data may refer to a captured image at a predetermined resolution. The methods described below in FIGS. 15A-15D include detecting window blockage using a serial pipeline based on both point cloud data and image data; using a parallel pipeline based on both point cloud data and image data; using fused point cloud data and image data; and using image data only or using point cloud data only.

FIG. 15A is an overview of various methods for blockage detection and thus not all blocks in FIG. 15A may be necessary. For example, if fused point cloud data and image data are used (block 1506), then determination blocks 1508 and 1510 may not be necessary. With reference to FIG. 15A, in block 1502 of method 1500, the controller obtains, based on the one or more frames of the point cloud data, a first deviation of the first return light signals from a first expectation. In block 1504 of method 1500, the controller obtains, based on the one or more frames of the image data, a second deviation of the second return light signals from a second expectation. One or both of blocks 1502 and 1504 can be performed. The first return light signals correspond to a first area of the aperture window. The second return light signals correspond to a second area of the aperture window.

The first area and the second area of the aperture window may or may not be the same area. Thus, the LiDAR sensor and the image sensor may or may not capture the same area of the aperture window at the same time. In one example, the two sensors may obtain the first return light signals and second return light signals corresponding to the same area of the aperture window at the same particular time. As such, the point cloud data generated by the LiDAR sensor and the image data generated by the image sensor are automatically synchronized in time and space for the particular time. In other examples, the first area of the aperture window and the second area of the aperture window may overlap at a particular time. Therefore, the point cloud data generated by the LiDAR sensor and the image data generated by the image sensor are automatically and partially synchronized in time and space for the particular time. Point cloud data and image data that are partially synchronized may be useful for applications that may not require strict synchronizations.

As described above using FIGS. 14A and 14B, if an aperture window of a LiDAR sensor or HyDAR system is at least partially blocked, the return light signals may deviate from the expected values. For a LIDAR sensor, FIG. 14A illustrates a comparison between the intensities of first return light signals 1402 where there are no window blockage and first return light signals 1404 where there is at least a partial window blockage. If there is a blockage, the signal intensity is much higher than expected values or a range values compared to if there is no blockage. For an image sensor, if there is a window blockage, the return signal intensity may be much lower than if there is no window blockage. For instance, if a leaf is covering a part of the aperture window, an image sensor (e.g., a camera) would detect a much lower light intensity.

Signal intensity is only one of the characteristics that can be used for detecting deviations from expectations. Other characteristics may include, but are not limited to, an average signal intensity; a distribution of the signal intensity; a size and/or a shape associated with one or both of the first area and the second area of the aperture window over time; sensitivity to a predetermined wavelength range; a point count of the point cloud data; or a distribution of the distances represented by the point cloud data or the image data. For all these characteristics, there may be predetermined expectations (e.g., normal ranges of intensity, distribution, sensitivity, point count, distribution of distances). Based on the point cloud data, the controller can detect changes in these characteristics, which represent the first deviation. Similarly, based on the image data, the controller can detect changes in some of these characteristics, which represent the second deviation.

With reference still to FIG. 15A, in some examples, the controller performs at least one of blocks 1508 or 1510. That is, the controller determines if the first deviation exceeds a first threshold (block 1508), if the second deviation exceeds a second threshold (block 1510), or both. For any of the first deviation or the second deviation, if the deviation from the expectation is small (e.g., smaller than the respective first or second threshold), it probably means that there is unlikely an aperture window blockage or not a noticeable blockage. For instance, the deviation may be caused by other factors like noise, interference, extrinsic calibration degradations, intrinsic calibration degradations, etc. (described below). As such, no further detection of the window blockage may be performed. If the first deviation, the second deviation, or both exceeds the respective thresholds, it may mean that there is likely a window blockage. If any of the deviation does not exceed the respective threshold, the method 1500 can loop back to obtain the next frame of point cloud data and/or the next frame of image data.

As shown in FIG. 15A, the controller can perform a logic OR operation (block 1512) of the outputs of blocks 1508 and 1510, and if the result of the OR operation is positive (or high), the controller determines (block 1516) one or more locations, one or more types, and the extent of the at least a partial window blockage of the aperture window. For instance, the point cloud data may have, or be used to derive, the location information (X, Y coordinates), reflectivity information associated with the first return light signals, the distance information, and other information (e.g., speed, orientation, etc. derived from first return light signals). The image data may have a much higher resolution than the point cloud data. The image data may also have information that are not included in the point cloud data. For example, the image data may include color information, brightness, contrast, etc. Therefore, if the controller determines that there is likely an aperture window blockage (e.g., because the first or second deviations, or both, exceed the respective thresholds), the point cloud data and the image data can be used to determine the location, the type, and the extent of the window blockage. For instance, if for a particular area of the aperture window, the first deviation indicates that the signal intensity is abnormally high (because the LiDAR transmission light signals are reflected by the blocking object) and the second deviation indicates that the signal intensity at the same area is abnormally low (because the visible light from an external light source is blocked from entering the image sensor), then the controller can determine that the area has a window blockage.

Based on the point cloud data, the image data, or both, the controller can further determine the shape and size of the area that is blocked. Based on the values of the first deviation and/or the second deviation, the controller may also determine the extent of the window blockage. For instance, if the values of the first deviation and/or the second deviation do not exceed the respective thresholds too much, it may mean that the object blocking the aperture window can still allow some transmission light signals to go out or some return light signals to come in from external of the HyDAR system. This type of objects may include, for example, water condensation, rain drops, plastic bags, or other transparent, or semi-transparent objects. In contrast, if the values of the first deviation and/or the second deviation exceed the respective thresholds a lot, it may mean that the object blocking the aperture window is rather opaque (e.g. a leaf).

The shape or size of the blocking object can be obtained by, for example, obtaining a deviation distribution of the point cloud data and/or the image data. The deviation values corresponding to the area of the aperture window that is blocked may have values that are significantly different from those areas that are not blocked. As such, the shape and size of the blocked area can be derived. In some examples, using the image data, and one or more pattern recognition algorithms (e.g., AI/ML based pattern recognition algorithms), the controller can even identify the type of the blocking object. For example, using a neural network that is trained to recognize objects, the controller may determine that that blocking object is a plastic bag, a leaf, rain drops, etc.

With reference still to FIG. 15A, if the controller determines that the first deviation does not exceed a first threshold (block 1508), it may just obtain a next frame of point cloud (block 1509) for processing, and the process loops back to block 1502 to obtain a first deviation based on the next frame of point cloud data. Similarly, if the controller determines that the second deviation does not exceed a second threshold (block 1510), it may just obtain a next frame of image data (block 1511) for processing, and the process loops back to block 1504 to obtain a second deviation based on the next frame of image data.

As described above, if any or both of the determinations at blocks 1508 and 1510 are yes, the controller determines (block 1516) that there is at least a partial blockage of the aperture window and further determines the locations, types, and extent of the at least partial window blockage. In method 1500 shown in FIG. 15A, the controller may further determine (block 1518) whether the at least a partial window blockage persists over no less than one data collection cycle. In certain scenarios, blockage of the aperture window may not be persistent. For instance, an object (e.g., a leaf, a plastic bag, a flower, etc.) that blocks the window may disappear or move its location the next second. Therefore, the controller can be configured to detect if the window blockage is persistent over no less than one data collection cycle. A data collection cycle may be a time period for collecting one frame of the point cloud data and/or the image data. It may also correspond to be a time period having other predetermined lengths.

In some examples, if the controller determines that the at least partial window blockage is persistent over no less than one data collection cycle, it can perform at least one of: reporting (block 1520) the at least partial window blockage; or activating (block 1522) a blockage removal mechanism for removing the at least a partial window blockage. For example, the controller may activate one or more nozzles to dispense fluid (e.g., compressed air, water, etc.) to try to blow away the objects that caused the at least partial window blockage. It may activate a window shield wiper or any other mechanisms (e.g., heater for removing condensation, fans to blow away plastic bags or leaves, etc.) to remove the blocking objects. If the partial window blockage cannot be removed after certain removal mechanisms are activated, the controller may report the at least partial window blockage to the user or to a system (e.g., a vehicle planning system or a vehicle control system).

The processes described above use the point cloud data and image data in separate processing pipelines for detecting at least a partial window blockage. FIG. 15 also illustrates another process of detecting at least a partial window blockage using fused point cloud data and image data. As described above, in the described multimodal sensor of a HyDAR system, when the point cloud data is provided by the LiDAR sensor and the image data is provided by the image sensor, they are already time-and-space synchronized at the hardware level. Therefore, the point cloud data and image data can be easily fused together (block 1506) to obtain fused data. The fusing process may not require timing shift and/or coordinate transformation between the point cloud data and the image data, or may require significantly less computational efforts. In one example, for further fusion, the outputs from both the LiDAR sensor and the image sensor are provided to a fusion processor or a data merger (e.g., a part of the controller, a dedicated processor, or any other computers). Based on the fused data, the controller can detect (block 1514) a fused blockage detection result. For example, because the fused data incorporate both the point cloud data and the image data, the blockage detection confidence can be enhanced. For example, if the controller only uses the point cloud data from the LiDAR sensor to detect blockage, the confidence of a blockage detection may be only 50%. If the controller uses fused data, which incorporates the image data, the confidence of a blockage detection (or lack thereof) may be increased to 90%. After the blockage detection is performed, the process can proceed to block 1518, 1520 and 1522, which are the same as described above.

FIG. 15A provides an overview of the method 1500 (corresponding to block 1330 in FIG. 13) for detecting at least a partial window blockage. FIGS. 15B-15D provide several particular embodiments of method 1500. With reference to FIG. 15B first, in method 1500A, the controller can start (block 1531) by obtaining a frame of data including the point cloud data and the image data. The point cloud data represents the first return light signals over a first area (block 1532) and the image data represents the second return light signals over a second area (block 1534). As described above, the first area and the second area may be the same area, or may be different areas having an overlap. In blocks 1538 and 1540, the controller determines if there is a first deviation of the point cloud data from the first expectation (block 1539) and if there is a second deviation of the image data from the second expectation (block 1540). The first and second deviations may represent one or more changes in a signal intensity or an average signal intensity, changes in a distribution of the signal intensity; changes in a size and/or a shape associated with one or both of the first area and the second area of the aperture window over time; changes in sensitivity to a predetermined wavelength range; changes in a point count of the point cloud data; and/or changes in a distribution of the distances represented by the point cloud data or the image data.

In some examples, in blocks 1538 and 1540, the controller further determines if the first deviation and second deviation exceed a first threshold and a second threshold, respectively. If so, the outputs from blocks 1538 and/or 1540 are “yes”, and vice versa. In some examples, the controller just determines whether there are any deviations from the expectations, and if so, the outputs from blocks 1538 and/or 1540 are “yes”, and vice versa. It is understood that the blocks 1538 and 1540 can be performed in any order. For example, the determination of the deviations of point cloud data and image data from their respective expectations can be performed in parallel in timing. Alternatively, the determination of deviation of point cloud data from its expectation can be performed before the determination of deviation of image data from its expectation, or vice versa. As shown in FIG. 15B, the outputs of the determinations in blocks 1538 and 1540 are “ORed” such that if any of the outputs of the determinations is “yes”, the controller calculates the blockage location, the type of the blockage, and the extend of the blockage. And if both of the outputs of the determinations from blocks 1538 and 1540 are “no”, the controller can proceed with obtaining the next frame of data (block 1549).

In some examples, if the determinations from blocks 1538 and 1540 are different, the controller may also determine a priority or confidence levels based on certain rules or settings, environmental conditions, or other factors. For example, the controller may be configured to set that the determination result from block 1538 (i.e., the determination based on point cloud data provided by the LiDAR sensor) has a higher priority than the determination from block 1540 (i.e., the determination based on the image data provided by the image sensor), or vice versa. The controller may also be configured to set the confidence level higher for the determination result from block 1538 than the determination result from block 1540, or vice versa. The controller may be further configured to set the priority or confidence level based on factors like environmental conditions. For instance, under certain weather conditions, one sensor may perform better than the other sensor, and therefore, the priority or confidence level can be set higher for the sensor that performs better. As one example, when the image sensor is directly facing the Sun, it may be saturated and not capturing any useful information. In contrast, a LiDAR sensor may perform well under this condition. In this scenario, the determination based on the point cloud data provided by the LiDAR sensor may be set to have a higher priority or higher confidence. It is understood that the controlled can be configured to have other settings of priority and/or confidence levels associated with the determination of deviations based on point cloud data and image data.

In method 1500A shown in FIG. 15B, the controller can increase a blockage counter by 1 for the detected blockage location of the aperture window (block 1547). The blockage counter may correspond to the data collection cycle described above in FIG. 15A. Thus, if the blockage persists more than 1 data collection cycle, the blockage counter is greater than 1. In other examples, there may be multiple block counters, each corresponding to a particular location of the aperture window. Thus, values of the block counters in different areas of the aperture window may be different. For instance, a particular location of the aperture window may have a higher counter value, indicating that the particular location may be blocked more than another location (e.g., it may be blocked for many data collection cycles and/or allowing less light to pass through).

With reference still to FIG. 15B, in block 1548, the controller may compare the counter value to a threshold (e.g., 1). If the counter value is greater than the threshold, the controller may report the window blockage with confidence (block 1545). If the counter value is less than the threshold, the controller may report the window blockage with less confidence. (block 1543). While in FIG. 15B, the threshold value is shown as 1, it can be any other number. The controller can report the window blockage to a user and/or a system (e.g., a vehicle planning and perception system), and may activate one or more mechanisms to remove the blocking object, similar to those described above using FIG. 15A. The method 1500A in FIG. 15B described above is also referred to as a parallel pipeline for detecting window blockage.

FIG. 15C illustrates another method 1500B for detecting at least a partial window blockage using only the point cloud data and determining the blockage location, type, and extent using the image data. Method 1500B starts with obtaining a frame of data (block 1551) including point cloud data and image data. The point cloud data represents the first return light signals over a first area (block 1552) and the image data represents the second return light signals over a second area (block 1554). The first area and the second area may or may not the same area, and may be overlapping with each other. In method 1550B, unlike method 1550A, the controller uses only the point cloud data to determine if there is a first deviation of the point cloud data from the first expectation (block 1558). The controller does not use the image data to determine if there is a second deviation of the image data from the second expectation. The first deviation may represent one or more changes in a signal intensity or an average signal intensity, changes in a distribution of the signal intensity; changes in a size and/or a shape associated with one or both of the first area and the second area of the aperture window over time; changes in sensitivity to a predetermined wavelength range; changes in a point count of the point cloud data; and/or changes in a distribution of the distances represented by the point cloud data or the image data. The controller may use only the point cloud data for the determination in block 1558 under certain conditions including, e.g., if the point cloud data has a high quality and/or if the environment conditions do not cause many false detections by the LiDAR sensor. In this scenario, it is probably unnecessary, or less necessary, to use the image data for enhancing the confidence of the deviation determination results based only on the point cloud data. As a result, the controller may choose to use only the point cloud data provided by the LiDAR sensor to make the determination in block 1558.

In some examples, in block 1558, the controller further determines if the first deviation exceeds a first threshold. If so, the output from block 1558 is “yes”, and method 1500B proceeds to block 1566. In some examples, the controller just determines whether there are any deviations from the first expectations, and if so, the output from block 1558 is “yes”. If the output of the determinations from block 1558 is “no”, the controller can proceed with obtaining the next frame of data (block 1569).

As shown in FIG. 15C, even if the controller does not use the image data to determine the deviation from an expectation, the controller can use both point cloud data and the image data to calculate (block 1566) the blockage location, the type of the blockage, and the extent of the blockage. After such calculations, the method 1500B can proceed to blocks 1567, 1568, 1565, and 1563. These blocks can be the substantially the same or similar to blocks 1547, 1548, 1545, and 1543 of FIG. 15B, respectively, and therefore are not repeatedly described. In some examples, the controller can calculate (block 1566) the blockage location, the type of the blocking object, and the extent of the blockage without determining the deviation (block 1558) or in parallel with determining the deviation. As shown in FIG. 15C, if there is no deviation from expectation and/or the deviation from expectation is less than an expectation threshold (block 1558), and/or after reporting the blockage (block 1563 or 1565), the controller can proceed to obtain the next frame (block 1569), and repeat method 1500B. The method 1500B described above is also referred to as a LiDAR-only pipeline for detecting window blockage.

FIG. 15D illustrates another method 1500C for detecting at least a partial window blockage using fused point cloud data and image data. Method 1500C starts with obtaining a frame of data (block 1571) including point cloud data and image data. The point cloud data represents the first return light signals over a first area (block 1572) and the image data represents the second return light signals over a second area (block 1574). The first area and the second area may or may not be the same area, and may be overlapping with each other. As described above, in the described multimodal sensor of a HyDAR system, when the point cloud data is provided by the LiDAR sensor and the image data is provided by the image sensor, they are already time-and-space synchronized at the hardware level. Therefore, the point cloud data and image data can be easily fused together (block 1575) by a data merger to obtain fused data. The fusing process may not require timing shift and/or coordinate transformation between the point cloud data and the image data, or may require significantly less computational efforts. In one example, the outputs from both the LiDAR sensor and the image sensor are provided to a fusion processor or a data merger 1575 (e.g., a part of the controller, a dedicated processor, or any other computers) for further processing. Based on the fused data, the controller can determine (block 1578) if there is a deviation from an expectation. The expectation may also be set based on fused expectation data (e.g., fusing the first expectation based on the point cloud data and the second expectation based on the image data). Because the fused data incorporating both the point cloud data and the image data, the blockage detection confidence may be enhanced. For example, if the controller only uses the point cloud data from the LiDAR sensor to detect blockage, the confidence of a blockage detection may be only 50%. If the controller uses fused data, which incorporates the image data, the confidence of a blockage detection (or lack thereof) may be increased to 90%. After the blockage detection is performed, the method 1500C can proceed to block 1586 for calculating the blockage location, the type of the blocking object, and the extent of the blockage. The method 1500C can then proceed to blocks 1587, 1588, 1585, and 1583. These blocks can be the substantially the same or similar to blocks 1547, 1548, 1545, and 1543 of FIG. 15B, respectively, and therefore are not repeatedly described. In some examples, the controller can calculate (block 1586) the blockage location, the type of the blocking object, and the extent of the blockage without determining the deviation (block 1578). As shown in FIG. 15D, if there is no deviation from expectation and/or the deviation from expectation is less than an expectation threshold (block 1578), and/or after reporting the blockage (block 1583 or 1585), the controller can proceed to obtain the next frame (block 1589) and repeat method 1500C. The method 1500C described above is also referred to as a fused data pipeline for detecting window blockage.

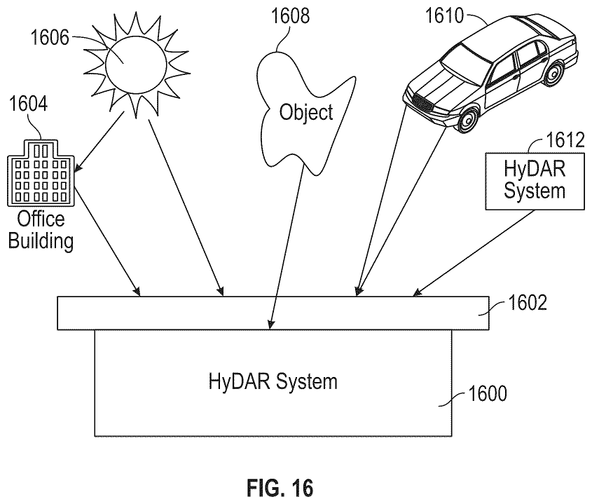

As described above, blockage of an aperture window of a HyDAR system is one degradation factor that may affect the performance of the HyDAR system. Another degradation factor is interference light signals from one or more interference light sources external to the HyDAR system. FIG. 16 is a diagram illustrating a HyDAR system 1600 receiving various interference signals provided by one or more interference light sources external to the HyDAR system 1600, according to various embodiments. As shown in FIG. 16, these external interference light sources may include the Sun 1606, the Moon (not shown), headlights from a vehicle 1610, streetlights (not shown), and another LiDAR or HyDAR system 1612. In other examples, the light from the above-described interference light sources may be reflected, transmitted, and/or refracted by other objects (e.g., object 1608, building 1604, etc.). These reflected, transmitted, and/or refracted light may be received by HyDAR system 1600 as interference light signals via aperture window 1602. The examples shown in FIG. 16 are not exclusive and interference light sources are not limited to the examples shown in FIG. 16. For example, another interference light source may include a malicious laser scrambler.

A LIDAR sensor in a HyDAR system can be sensitive to external interference light sources. Interference light signals may result in noise in the detection results of the HyDAR system 1600, and typically are undesired. In some scenarios, such interference light signals can lead to abnormal behavior of the HyDAR system and may cause harm to the LiDAR sensor and/or users of the HyDAR system. Therefore, the interference light signals need to be detected, reduced, avoided, and/or removed. The methods described herein use both the point cloud data obtained by the LiDAR sensor and/or the image data obtained by the image sensor to detect interference light signals. In some examples, the image sensor integrated in a HyDAR system can improve the system's capabilities of detecting and avoiding interference light signals.

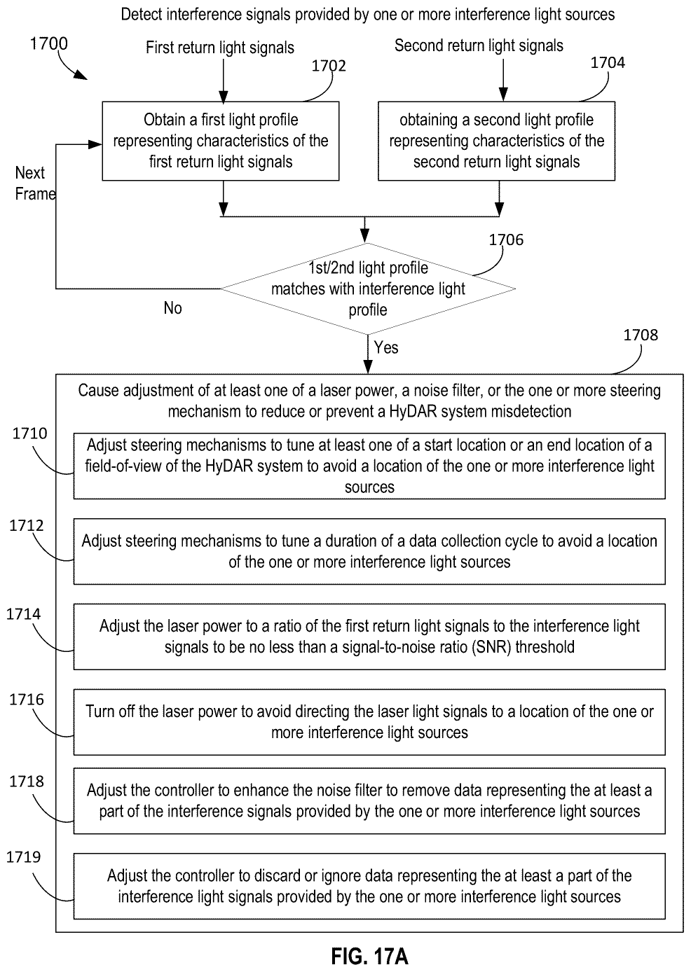

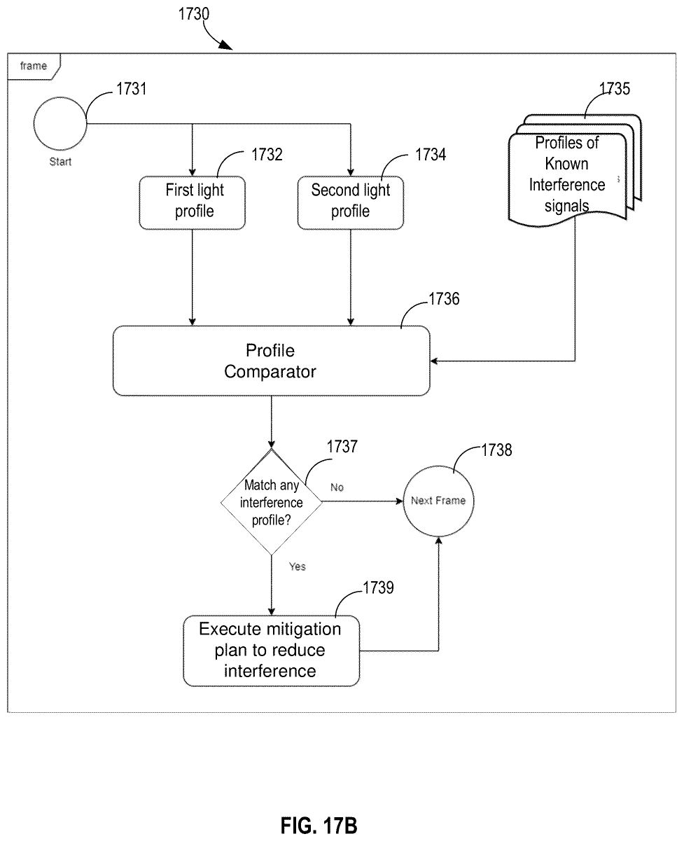

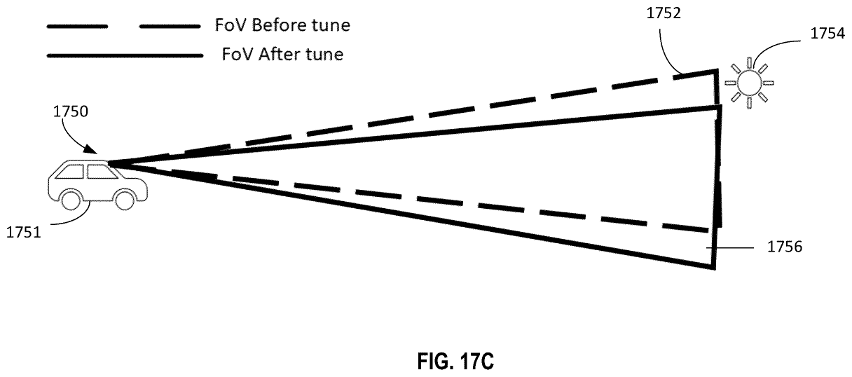

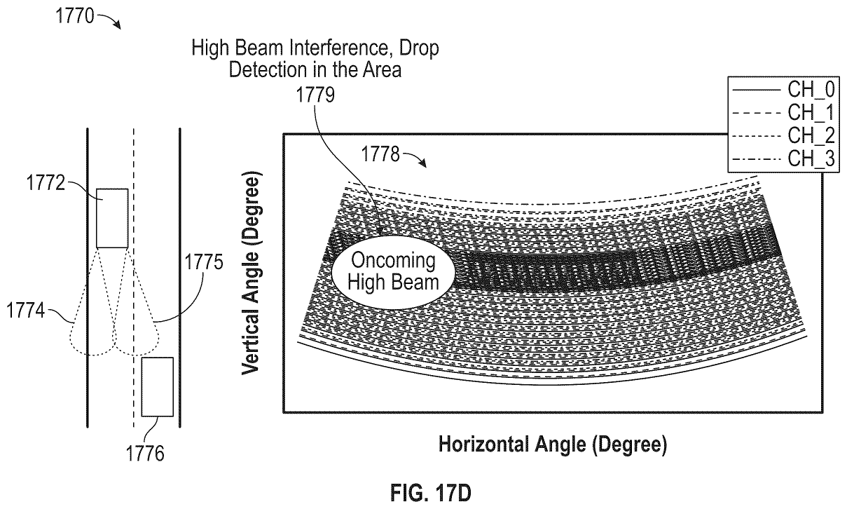

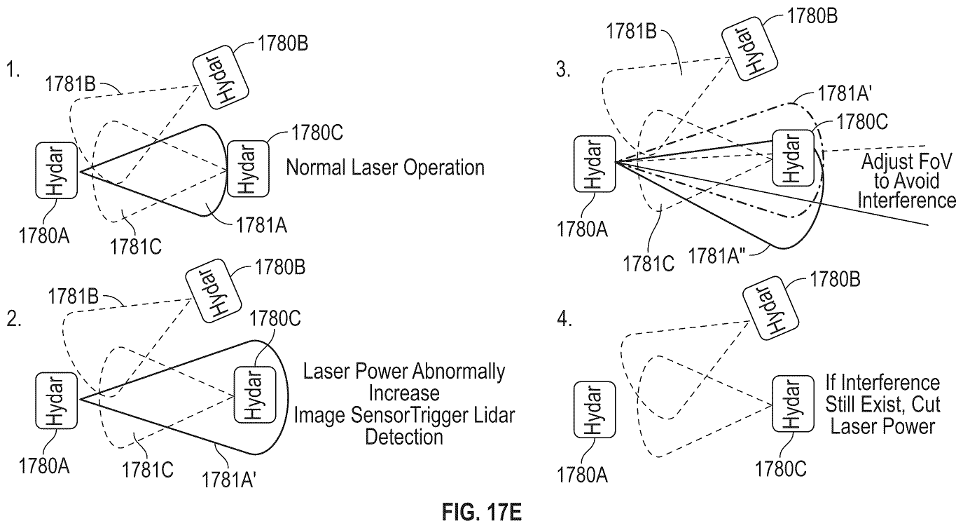

FIGS. 17A-17B are flowcharts illustrating various methods for detecting interference light signals caused by one or more interference light sources, according to various embodiments. FIG. 17A illustrates an example of method 1700 (corresponding to block 1340 in FIG. 13) for detecting interference signals provided by one or more interference light sources external to the HyDAR system. In method 1700, the controller may obtain (block 1702) a first light profile representing characteristics of the first return light signals. As described above, the first return light signals are formed based on the transmission light signals emitted by a laser light source. The first return light signals are detected by the LiDAR sensor (e.g., sensor 1202). The characteristics of the first return light signals may include, for example, signal intensity, wavelength of the first return light signals, signal distribution of the first return light signals, etc. The characteristics of the first return light signals are characteristics associated with the return light signals received by the LiDAR sensor. The first light profile may be formed or extracted from the point cloud data, from the electrical signals converted from the first return light signals, from the first return light signals directly, and/or derived from the above-described signals. For instance, the first light profile may include signal intensity data in the form of digital signals (sampled from the electrical signals converted from the first return light signals). The first light profile may also include signal distributions, which can be histograms derived from the signal intensity data.

Similarly, the controller can obtain (block 1704) a second light profile representing characteristics of the second return light signals. As described above, the second return light signals are formed based on one or more light sources external to the HyDAR system. For example, the second return light signals may be formed by light reflected, scattered, or refracted by one or more objects in the FOV, and are detected by the image sensor (e.g., sensor 1204). The characteristics of the second return light signals may include, for example, signal intensity, wavelength of the second return light signals, signal distribution of the second return light signals, etc. The characteristics of the second return light signals are characteristics associated with the return light signals received by the image sensor (e.g., a camera). The second light profile may be formed or extracted from the image data, from the electrical signals converted from the second return light signals, from the second return light signals directly, and/or derived from the above-described signals. For instance, the second light profile may include signal intensity data in the form of digital signals (sampled from the electrical signals converted from the second return light signals). The second light profile may also include signal distributions, which can be histograms derived from the signal intensity data.

With reference to FIG. 17A, in some embodiments, the controller can determine (block 1706) whether at least one of the first light profile or the second light profile matches with an interference light profile associated with the interference signals provided by the one or more interference light sources. If there is a match, it likely means that the first return light signals and/or the second return light signals include interference light signals, which may affect the LiDAR sensor and/or the image sensor. In turn, it may degrade the HyDAR system's performance. The interference light profiles may be predetermined for one or more known interference light sources. They may be formed or extracted from the point cloud data or the image data obtained based on detections of known interference light sources, from the electrical signals converted from predetermined interference light signals from known interference light sources, from the predetermined interference light signals directly, and/or derived from the above-described signals. For instance, an interference light profile may include signal intensity data in the form of digital signals (sampled from the electrical signals converted from the predetermined interference light signals). The interference light profile may also include signal distributions, which can be histograms derived from the signal intensity data. Several examples of interference light profile are described below.

In some embodiments, for matching between the first/second light profile with the interference light profile, the controller compares data represented by these light profiles. Such data may include a measured direction along which the first return light signals and/or the second return light signals are detected by the HyDAR system; an absolute intensity detected along the measured direction; a relative intensity to different spectral ranges detected along the measured direction; a detectable size or shape of interference signals associated with the at least one of the one or more interference light sources; and a distribution of distances over multiple data collection cycles.

As one example shown in FIG. 17C, at any given time of a day, the HyDAR system mounted to a vehicle 1751 may determine the direction of the Sun (or Moon). Such directions of the Sun (or Moon) can be data included in an interference light profile. Therefore, when the controller obtains the first light profile (based on first return light signals obtained by the LiDAR sensor) and/or the second light profile (based on second return light signals obtained by image sensor), the controller can obtain a measured direction along which the first light profile and/or the second return light signals are detected by the HyDAR system. The controller can thus compare the extracted measured direction with the direction of the Sun (or Moon) included in the interference light profile. If there is a match, it likely means that the first return light signals and/or the second return light signals obtained at the particular direction correspond to interference light signals from the Sun (or the Moon). In some examples, the controller may obtain further information to enhance the confidence of such a determination. For example, the in the direction of the first return light signals and/or the second return light signals, there may be a streetlight or some other light sources (e.g., light reflected from a mirror-surface of a tall building), in addition to the Sun (or the Moon). In this case, the controller may compare the data between the first/second light profiles with the interference light profile for several data collection cycles, may compare wavelengths contained in the first/second light profiles and the interference light profile, and/or may compare absolute light intensities, detected along the measured direction, of the first/second return light signals with the predetermined interference light signals. For instance, if the interference light source is a streetlight, its light intensity may be much smaller than the sunlight, but may be much greater than the moonlight. The wavelength of a streetlight may also be different from that of the sunlight or the moonlight. By comparing multiple types of data included in the first/second light profiles and the interference light profile, the controller can determine if the first/second return light signals contain interference light signals with more confidence.

As another example, based on the first light profile (corresponding to the first return light signals obtained by the LiDAR sensor) and/or the second light profile (corresponding to the second return light signals obtained by image sensor), the controller can extract a relative intensity of different spectral ranges detected along the measured direction for the first light profile and/or the second return light signals. As described above, in a measured direction, there might be object-reflected/scattered light signals that are desired for detection. In the same direction, there might also be other interference lights signals like the streetlight, the sunlight, the moonlight, building reflected light, etc. Therefore, one way to distinguish between desired return light signals and undesired interference light signals is to analyze the relative intensity of the spectral ranges of the light signals. For instance, desired return light signals may have the same wavelength (e.g., 905 nm) as the transmission light signals from the laser light source of the HyDAR system. Therefore, based on the first/second light profiles, the controller of the HyDAR system can analyze the signal intensity of particular return light signals at the particular wavelength (e.g., 905 nm) and at other wavelengths. If the signal intensity of the particular light signals at the particular wavelength falls within a predetermined range with respect to the intensity of other return light signals at the other wavelengths, the controller may determine the particular return light signals are desired return light signals. Otherwise, the controller may determine that they are interference light signals. In other examples, the controller may compare the relative signal intensity of the particular return light signals with predetermined relative signal intensity of known interference light signals. If there is a match, the controller determines that the particular return light signals are interference light signals.

As another example, an object in the FOV of a HyDAR system may reflect visible light from light sources external to the HyDAR system. The reflected visible light may have a normal signal intensity range, depending on the object's reflectivity. Most objects in a HyDAR system's FOV may not have a high reflectivity like a mirror. In some scenarios, there may be buildings having mirror-like surfaces and therefore the signal intensity of the reflected light may have a very high intensity in the visible wavelength range. Such a very high intensity may saturate the image sensor of the HyDAR system and thus, such reflected light signals are interference light signals undesired for generating good image data. The controller may determine that the signal intensity of particular return light signals at the visible light range is higher than a threshold intensity, and determine that the particular return light signals are interference light signals. In other examples, the controller may compare the relative signal intensity of the particular return light signals with predetermined relative signal intensity of known interference light signals. If there is a match, the controller determines that the particular return light signals are interference light signals.

In some examples, based on the first light profile (corresponding to the first return light signals obtained by the LiDAR sensor) and/or the second light profile (corresponding to the second return light signals obtained by image sensor), the controller can detect a size and shape associated with particular return light signals. The controller can compare the detectable size or shape of the particular return light signals with the size and shape of interference signals associated with one or more known interference light sources. As one example, the image sensor of the HyDAR system may receive particular return light signals from the Sun. The particular return light signals, together with other return light signals, may form the second return light signals detected by the image sensor. The controller can obtain a second light profile representing characteristics of the second return light signals. Based on these characteristics (e.g., wavelength, signal intensity, distribution, etc. as described above), the controller can detect a size and shape of possible interference light sources. For example, if a particular part of the second return light signals all have a high signal intensity, a particular wavelength spectrum, and are located at certain direction in the sky, the controller may determine the size and shape of the light source that generated the particular part of the second return light signals. The controller may then compare the detected size and/or shape of the light source with predetermined size and shape of a known interference light source. If there is a match, the controller determines that the particular part of the second return light signals corresponds to interference light signals from a known interference light source (e.g., the Sun).

In some examples, based on the first light profile (corresponding to the first return light signals obtained by the LiDAR sensor) and/or the second light profile (corresponding to the second return light signals obtained by image sensor), the controller can obtain a distribution of distances over multiple data collection cycles. The distribution of distances over multiple data collection cycles can be used for many scenarios where the interference source is not completely in synchronization with the laser emission of the HyDAR system. One example of such an interference source can be sunlight. The sunlight that enters the HyDAR system includes randomly allocated pulses in time. These pulses could cause detections at almost any distance along the direction of the Sun. The distance distribution of the sunlight may thus cover a huge range. The controller of the HyDAR system can therefore use the distance distribution to detect the interference sources, including the Sun and other LiDAR/HyDAR devices.

The example interference light sources described above include one or more of the Sun, vehicle headlights/taillight, street illumination, and a light redistribution mechanism redirecting light from another interference source (e.g., a building having a mirror-like surface or another high reflectivity object). In some examples, the external interference light source may be another HyDAR or LiDAR system that transmits laser light. FIG. 17D illustrates two vehicles 1772 and 1776 travelling in opposite directions of a road. The vehicle 1772 is mounted with a HyDAR or LiDAR system that continuously transmits laser light signals to scan the environment. The transmission laser light signals from vehicle 1772 may be received by a HyDAR or LiDAR system mounted to vehicle 1776, which is travelling in the opposite direction. Thus, the laser light signals from vehicle 1772 can be interference light signals for a HyDAR or LiDAR system mounted to vehicle 1776, and vice versa. Such interference light signals from vehicle 1772 can be detected by the HyDAR or LiDAR system mounted to vehicle 1776 based on, for example, a measured direction along with the light signals are detected (e.g., the direction of the light signals is always from the road lane in the opposite direction), a distribution of distances over multiple data collection cycles (e.g., because the light signals emitted from vehicle 1772 do not correspond to any of the transmission light signals from vehicle 1776, the distances may be super large), wavelengths (e.g., two vehicles may have laser sources having different wavelengths), or other data included in a first/second light profile (corresponding to the first return light signals detected by a LiDAR sensor and second return light signals detected by an image sensor).

It is understood that the data included in the first light profile and/or second light profile are not limited to the above-described examples. Other types of data can be extracted or derived from the first/second light profiles and compared to interference light profiles from known interference light sources. By comparing the light profiles generated based on the return light detected by one or both of the LiDAR sensor and the image sensor, the HyDAR system can improve its performance of detecting interference light signals, compared to if only one sensor is used.

With reference back to FIG. 17A, in block 1706, if the controller determines that at least one of the first light profile or the second light profile matches with the interference light profile (i.e., “yes”), the controller can proceed to cause (block 1708) adjustment of at least one of a laser power, a noise filter, or the one or more steering mechanism to reduce or prevent a HyDAR system misdetection. FIG. 17A provides several non-limiting examples of adjustments, including adjusting (block 1710) steering mechanisms to tune at least one of a start location or an end location of a FOV of the HyDAR system to avoid a location of the one or more interference light sources, adjusting (block 1712) steering mechanisms to tune a duration of a data collection cycle to avoid a location of the one or more interference light sources; adjusting (block 1714) the laser power to a ratio of the first return light signals to the interference light signals to be no less than a signal-to-noise ratio (SNR) threshold; turning off (block 1716) the laser power to avoid directing the laser light signals to a location of the one or more interference light sources; adjusting (block 1718) the controller to enhance the noise filter to remove data representing the at least a part of the interference signals provided by the one or more interference light sources; and (block 1719) adjusting the controller to discard or ignore data representing the at least a part of the interference light signals provided by the one or more interference light sources. Each of the blocks 1710-1719 are described in greater detail below.

As a first example for adjustment, based on detection of the interference light signals, the controller adjusts (block 1710) steering mechanisms to tune at least one of a start location or an end location of a FOV of the HyDAR system to avoid a location of the one or more interference light sources. One such example is illustrated in FIG. 17C, which is a diagram illustrating an example process for adjusting a steering mechanism of the HyDAR system to avoid a location of an interference light source like the Sun, according to various embodiments. With reference to FIGS. 17C and 12A, a HyDAR system 1750 may be mounted to a vehicle 1751 (e.g., at the vehicle roof). HyDAR system 1750 may be substantially the same or similar to HyDAR system 1200 described above. HyDAR system 1750 may scan, using a steering mechanism (e.g., steering mechanism 1206), an FOV 1752 in its normal setting. The normal setting may be, for example, a default setting under vehicle's normal operating conditions. As shown in FIG. 17C, if vehicle 1751 is operating during a time period in a late afternoon, the HyDAR system 1750 may receive sunlight of the Sun 1754 at a low Sun angle (i.e., the Sun is close to the horizon, such that the angle between the direction of sunlight and the road surface may be very small. In this scenario, the Sun appears in the FOV of the HyDAR system and the sunlight directly enters the detector. As a result, much more sunlight may enter the HyDAR system 1750 directly (compared to indirectly when a large portion of the visible light received by the HyDAR system 1750 is only reflected/scattered sunlight). Therefore, the sunlight received by the HyDAR system 1750 may have a very high intensity. As a result, the sunlight from the Sun 1754 at this time of the day may affect (e.g., saturate) the image sensor and/or the LiDAR sensor of the HyDAR system 1750, and therefore it is desired to avoid the sunlight as interference light signals.

In one embodiment, as shown in FIG. 17C, to avoid the interference light source like the Sun 1754 at a particular time period (e.g., close to sunset time), the controller of HyDAR system 1750 may adjust at least one of the one or more steering mechanisms to tune at least one of a start location or an end location of a field-of-view of the HyDAR system 1750 to avoid a location of the interference light source like the Sun 1754. FIG. 17C thus illustrates, after tuning the start and end locations of the FOV, the HyDAR system 1750 scans a new FOV 1756, which is different from the FOV 1752 under the normal setting. The new FOV 1756 does not overlap with the direction of the Sun 1754, and therefore, the LiDAR sensor and/or the image sensor of HyDAR system 1750 can avoid receiving the direct sunlight or reduce the received direct sunlight. Accordingly, tuning the FOV to avoid the interference light source can significantly reduce the noise or interference light signals received by the HyDAR system 1750 and thus reduce or prevent the HyDAR system from misdetection.

In some examples, the interference light source of a current HyDAR/LiDAR system may be from another HyDAR or LiDAR system that transmits laser signals, which can be referred to as the interference HyDAR/LiDAR system (e.g., a HyDAR system mounted to vehicle 1776 is an interference to the HyDAR system mounted to vehicle 1772 shown in FIG. 17D). The interference HyDAR/LiDAR system may transmit laser signals, based on which the return light signals are formed. Such return light signals may be interference light signals with respect to the current HyDAR/LiDAR system. In some examples, if the current HyDAR/LiDAR system and the interference HyDAR/LiDAR system use different light signal wavelengths, the interference light signals from the interference HyDAR/LiDAR system can be distinguished from the return light signals for the current HyDAR/LiDAR system by wavelength. However, in some examples, the HyDAR/LiDAR systems interfering with each other may have the same light signal wavelengths. Thus, the current HyDAR/LiDAR system may need to adjust the steering mechanism (e.g., mechanism 1206) to tune a duration of the data collection cycle. As described above, a data collection cycle corresponds to the time for collecting a frame of data (e.g., point cloud data). A frame of data may be obtained when the steering mechanism scans the entire FOV once. Thus, by adjusting the steering mechanism, the data collection cycle can be adjusted. If the data collection cycle of the current HyDAR/LiDAR system is different from the data collection cycle of the interference HyDAR/LiDAR system, the current HyDAR system can avoid the location of the interference source or reduce the likelihood of receiving the interference signals at the current HyDAR/LiDAR system. In one example, the adjustment of the data collection cycle changes the dimensions of the frame (e.g., a frame length). Therefore, the data collection rate and/or the return light directions may be different between the current HyDAR/LiDAR system and the interference HyDAR/LiDAR system (e.g., usually, two systems may not be transmitted light pulses from the same angle or detecting return light pulses at the same rate). As a result, by adjusting the data collection cycle, the possible synchronization between two HyDAR/LiDAR systems is reduced. As a result, the current HyDAR/LiDAR system can reduce the likelihood of receiving the interference signals generated by the interference HyDAR/LiDAR system (e.g., the systems are out of synchronization).

Another way to reduce or eliminate false detection by a current HyDAR or LiDAR system due to interference light pulses is to adjust laser power of the light source (light source 310) in the HyDAR system (e.g., system 1200) or the LiDAR system (e.g., system 300). Adjusting the FOV of the current HyDAR/LiDAR system as described above may be combined with adjusting the laser power, as illustrated in FIG. 17E. FIG. 17E are diagrams illustrating an example scenario of adjusting a current HyDAR/LiDAR system to avoid interference light signals and/or to adjust the laser power of the HyDAR system to reduce the impact of the interference light signals, according to various embodiments. FIG. 17E uses HyDAR systems as examples, but the process may be applied to a LiDAR system too. FIG. 17E has four diagrams, named as diagrams 1-4. The process shown by diagrams 1-4 illustrates one example order in which the adjustment of FOV and adjustment of laser power can be applied. It is understood that the order can be changed.

The first diagram (i.e., diagram #1) of FIG. 17E shows that in one scenario, there may be multiple HyDAR systems (e.g., systems 1780A, 1780B, and 1780C). Each of the HyDAR systems 1780A-1780C transmits laser light signals to scan a respective FOV. For instance, HyDAR systems 1780A, 1780B, and 1780C scan FOVs 1781A, 1781B, and 1781C, respectively. In this scenario shown in the first diagram of FIG. 17E, FOVs 1781B and 1781C at least partially overlap with the FOV 1781A. Therefore, with respect to the current HyDAR 1780A, HyDAR systems 1780B and 1780C are interference light sources emitting interference light signals. The interference light signals emitted by HyDAR systems 1780B and 1780C may be detected by the methods described above (e.g., comparing light profiles of the return light signals received by the LiDAR sensor and/or the image sensor with an interference light profile of a known interference light source). In another example, the HyDAR system 1780A may detect the interference light signals emitted by interference HyDAR systems 1780B and 1780C by using the image data provided by the image sensor (e.g., the image sensor of HyDAR system 1780A may capture images of HyDAR system 1780B and 1780C (and/or the vehicles to which they are mounted), and the controller may compare the images with known HyDAR/LiDAR systems to determine if they are interference HyDAR systems).

The second diagram (i.e., diagram #2) of FIG. 17E illustrates that, to reduce the impact of the interference light signals generated by the interference HyDAR systems 1780B and 1780C, the controller of the current HyDAR system 1780A may cause the laser power of the laser source to adjust. For instance, the controller of HyDAR system 1780A may significantly increase the laser power of its laser light source, such that the signal intensity of the first return light signals is also increased. In turn, when the LiDAR sensor of HyDAR system 1780A receives the first return light signals, the signal-to-noise (SNR) ratio is increased. This is because the interference light signals remain unchanged. Thus, with respect to the interference light signals emitted by interference HyDAR systems 1784B and 1784C, if the signal intensity (or signal power) of the first return light signals increases, the ratio of the signal intensity of the first return light signals to the signal intensity of the interference light signals increases. This ratio is referred to as the signal-to-noise ratio (SNR) associated with the HyDAR system 1780A. The controller of HyDAR system 1780A can increase the laser power to a level that the SNR associated with HyDAR system 1780A is no less than a SNR threshold. When the laser power of the light source increases, the detection range of the HyDAR system 1780A also increases.

Thus, comparing the first and second diagrams of FIG. 17E, the FOV of HyDAR system 1780A changes from FOV 1781A to 1781A′. FOV 1781A′ is bigger than FOV 1781A and the transmission laser signals from HyDAR 1780A can travel farther distances. On the detection side, with the improved SNR, the performance degradation of the LiDAR sensor and/or the image sensor of HyDAR system 1780A due to the interference light signals emitted by the interference HyDAR systems 1780B and 1780C can be reduced or prevented. In turn, it reduces or prevents false detection by the HyDAR system 1780A.

The third diagram (i.e., diagram #3) of FIG. 17E illustrates that in addition to adjusting the laser power, the controller of the current HyDAR system 1780A may cause the steering mechanism to adjust the FOV to further reduce the impact of the interference light signals generated by the interference HyDAR systems 1780B and 1780C. As described above, when the current HyDAR system 1780A detects the interference light signals from interference HyDAR systems 1780B and 1780C, the controller of HyDAR system 1780A increases the laser power to increase the SNR of the return light signals to the interference light signals to improve the detection. Sometimes, simply increase the laser power may not be sufficient to increase the SNR to a desired level. In addition, increasing the laser power too much may have safety concerns too. Therefore, in some examples, the controller of the current HyDAR system 1780A can cause the steering mechanism to adjust the FOV to avoid at least some of interference light sources. As described above, after increasing the laser power, the FOV 1781A of HyDAR system 1780A changes to FOV 1781A′. Nonetheless, FOV 1781A′ of HyDAR system 1780A may still overlap significantly with FOV 1781C of interference HyDAR system 1780C and overlap partially with FOV 1781B of interference HyDAR system 1780B. As such, the LiDAR sensor and/or the image sensor of HyDAR system 1780A still receives significant interference light signals from HyDAR system 1780C and some interference light signals from HyDAR system 1780B.

To further reduce the interference light signals received by the HyDAR system 1780A, the controller of system 1780A can control the steering mechanism (e.g., steering mechanism 1206) to turn the FOV range, as described above. For instance, as shown in the third diagram of FIG. 17E, the steering mechanism can be adjusted such that the HyDAR system 1780A changes its scanning range to cover FOV 1781A″. Compare to the FOV 1781A′, FOV 1781A″ only partially overlaps with the FOV 1781C from the interference HyDAR system 1780C and docs not overlap with the FOV 1781B from the interference HyDAR system 1780B. As a result, the LiDAR sensor and/or the image sensor of the current HyDAR system 1780A receive less interference light signals from interference HyDAR system 1780C and receives no or minimum interference light signals from interference HyDAR system 1780B. In turn, because the signal intensity of the interference light signals reduces, the SNR of the detected return light signals at the HyDAR system 1780A further improves. A further improved SNR can better prevent false detection by the HyDAR system 1780A.

In some scenarios, the interference HyDAR systems 1780B and/or 1780C may be located very close to the current HyDAR system 1780A. As a result, the interference light signals may have a very high intensity. Increasing the laser power (diagram #2 of FIG. 17E) may not be sufficient to obtain a sufficiently large SNR ratio. Further, because the interference HyDAR systems 1780B and/or 1780C are located very close, adjusting the steering mechanism may not be able to avoid the significant overlapping of the FOVs between the current HyDAR system 1780A and the interference HyDAR systems 1780B and/or 1780C. In some other scenarios, the interference light signals may be generated by HyDAR system 1780A itself (e.g., if the system 1780A has a blockage of the aperture window, or if some internal components of the system 1780A has a high signal reflection, or if system 1780A has a degraded intrinsic calibration). In these scenarios, the controller of HyDAR system 1780A may reduce the laser power or even turn off the laser power as illustrated in the fourth diagram (i.e., diagram #4) of FIG. 17E. Turning off the laser power can avoid directing laser light signals to a location of the interference light sources. In some cases, the controller may report to adjustments it made to a user or to another system (e.g., a vehicle planning and perception system). Based on the report, the user or the other system may determine that decisions (e.g., vehicle planning or perception decisions) should not be made while the laser power is turned off at HyDAR system 1780A.

With reference back to FIG. 17D, it is a diagram illustrating another example process for making adjustment based on detected interference light signals. FIG. 17D shows adjusting the controller to discard or ignore data representing the at least a part of the interference signals provided by the one or more interference light sources, according to various embodiments. With reference to FIG. 17D, in one example, the HyDAR system mounted to vehicle 1776 may receive interference light signals 1775 from vehicle 1772. The interference light signals 1775 may be a high beam of the headlight of vehicle 1772, or may be transmission laser signals from a LiDAR or HyDAR system mounted to vehicle 1772. Vehicle 1772 may send other light signals 1774 (light beams from another headlight), which may not be received by the HyDAR system mounted to vehicle 1776, and are therefore not interference light signals.

As shown in FIG. 17D, in some embodiments, the controller of the current HyDAR system (e.g., the one mounted to vehicle 1776) can adjust to discard or ignore the data representing the at least a part of the interference light signals 1775 provided by the interference light sources (e.g., the high beam from vehicle 1772). FIG. 17D illustrates scanlines 1778 generated by the controller of the current HyDAR system, and data corresponding to area 1779 in the scanlines 1778 may be identified to have too much noise due to the interference light signals 1775. The controller can thus discard or ignore such data corresponding to the area 1779. In turn, because such data are not used for object detection, the current HyDAR system's performance degradation can be reduced or prevented.

While not explicitly shown in FIG. 17D, in some embodiments, a controller of the current HyDAR system may apply or enhance a noise filter to remove data representing the at least a part of the interference light signals provided by the interference light sources. For example, a noise filter can be applied to discard all data points along a particular direction corresponding to the location of the interference light sources; to discard all data points that have signal intensities satisfying certain threshold (either high or low threshold); and/or discard data points based on signal distribution and inter-spacing between the data points. The noise filter may be implemented by hardware and/or software. The noise filter can be applied before discarding or ignoring data completely. In some examples, a noise filter having a first level of filtering can be applied to all data points in the point cloud data and/or the image data obtained by the current HyDAR system; while an enhanced noise filter having a second level of filtering can be applied to a part of the data points that correspond to interference light signals from particular interference light sources. Referring to FIG. 17D, for example, a default level of noise filtering may be applied to all data points corresponding to the scanlines 1778, while an enhanced level of noise filtering may be applied to the data point corresponding to area 1779.

FIGS. 17A and 17C-17E illustrate various methods of detecting interference light signals as a degradation factor for a HyDAR system and making adjustments to reduce or prevent HyDAR misdetection. FIG. 17B shows an example implementation of the methods described above for detecting interference light signals and causing adjustments to reduce or prevent misdetection. Specifically, in an implementation of a method 1730, the controller (e.g., controller 1214 or control circuitry 350) starts (block 1731) by obtaining a frame of data (e.g., a frame of point cloud data generated by the LiDAR sensor and/or a frame of image data generated by the image sensor). The controller can extract a first light profile (block 1732) and a second light profile (block 1734) from the frame of data. As described above, the first light profile may represent characteristics of the first return light signals (e.g., intensity, wavelength, distribution, etc. of the return signals detected by the LiDAR sensor); and the second light profile may represent characteristics of the second return light signals (e.g., intensity, wavelength, distribution, etc. of the return signals detected by the image sensor).

In block 1736 of the process 1730, the controller has a profile comparator configured to compare the first light profile and/or the second light profile with one or more profiles of known interference signals (block 1735). The profiles of known interference signals are stored in a storage device of the HyDAR system or stored somewhere else (e.g., in a cloud storage). The profile comparator can be implemented using hardware and/or software, for more efficient and faster comparison. In some cases, the comparison and other steps in method 1730 are performed in real time such that the results of method 1730 (e.g., determining the interference light signals and making adjustments accordingly) can be delivered quickly for real-time operation of a vehicle.

In block 1737, the controller determines if the first/second light profiles match with the profiles of known interference signals. If yes, the controller can cause the execution of mitigation plans to reduce or prevent misdetection caused by the interference light signals. As described above, the controller may cause the adjustments of one or more of the steering mechanisms, a noise filter, laser power, etc. to reduce or prevent the misdetection caused by the interference light signals. After the adjustment and if there is no match from block 1737, the controller can proceed to obtain (block 1738) the next frame of data.

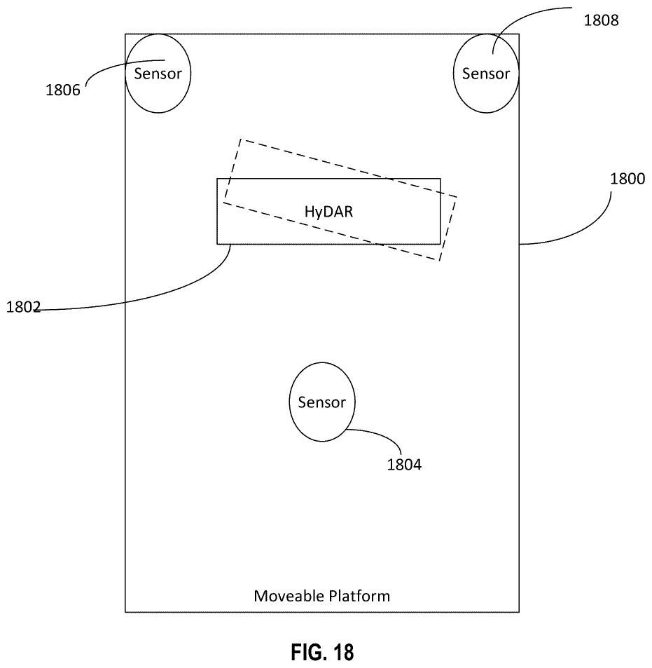

Window blockage and interference light signals are two factors that may degrade the performance of a HyDAR system. Another degradation factor is extrinsic calibration degradation. FIG. 18 is a block diagram illustrating a moveable platform 1800 mounted with a HyDAR system 1802 and various sensors, according to various embodiments. The moveable platform 1800 can be a vehicle, a robot, etc. HyDAR system 1802 can be substantially the same or similar to systems 400 or 1200 described above. Sensors 1804, 1806, and 1808 may include, for example, cameras, ultrasonic sensors, radars, etc. or a combination thereof. There may be other components mounted to the moveable platform 1800 and are not shown. When the HyDAR system 1802 is manufactured and mounted to moveable platform 1800, its position and orientation is calibrated such that it can correctly operate to detect the objects in the desired FOV around the moveable platform 1800. For example, the HyDAR system 1802's roll, pitch, yaw are set and calibrated to the desired values for the system to operate in a desired manner. This type of calibration is referred to as the extrinsic calibration of the HyDAR system 1802, because the calibration is with respect to the moveable platform 1800 (or its components, other sensors mounted thereto, etc.) located external to the HyDAR system 1802.

After the moveable platform 1800 operates for some time, the HyDAR system 1802 may change its position and orientation relative to the vehicle due to, for example, vibration, shock, humidity, temperature, or other environmental, operational, or user related factors. As shown in FIG. 18, HyDAR system 1802 may change its position and orientation (e.g., roll, pitch, and yaw) with respect to its original position (and therefore also with respect to the moveable platform 1800). In some examples, over time, one or more components in the HyDAR system 1802 may change their positions and orientations with respect to the moveable platform 1800, sensors 1804, 1806, and/or 1808; and/or other components mounted to the moveable platform 1800. Accordingly, there is a need to detect the extrinsic calibration degradation and cause adjustments to compensate for the degradation.

If a LiDAR system or a camera are discrete sensors (compared to integrated multimodal sensor in a HyDAR system) mounted to a vehicle, extrinsic calibration of the discrete LiDAR system or the camera can be difficult or cumbersome, because it requires accurate synchronization between the sensors and the specific calibration setup. By using the HyDAR system described herein, which includes a multimodal sensor integrating the LiDAR sensor and the image sensor together, the extrinsic calibration can be performed or monitored with no additional synchronization required. As described above, in a HyDAR system described herein, the point cloud data provided by the LiDAR sensor and the image data provided by the image sensor are time-and-space synchronized at the hardware level. Therefore, no additional computational efforts are required for synchronization above the hardware level. Furthermore, if the extrinsic degradation is within a predetermined threshold, the HyDAR system can adjust itself during operation. Thus, it minimizes the impact on the vehicle's operation (e.g., the vehicle can keep operating with the HyDAR system continuously providing detection results).

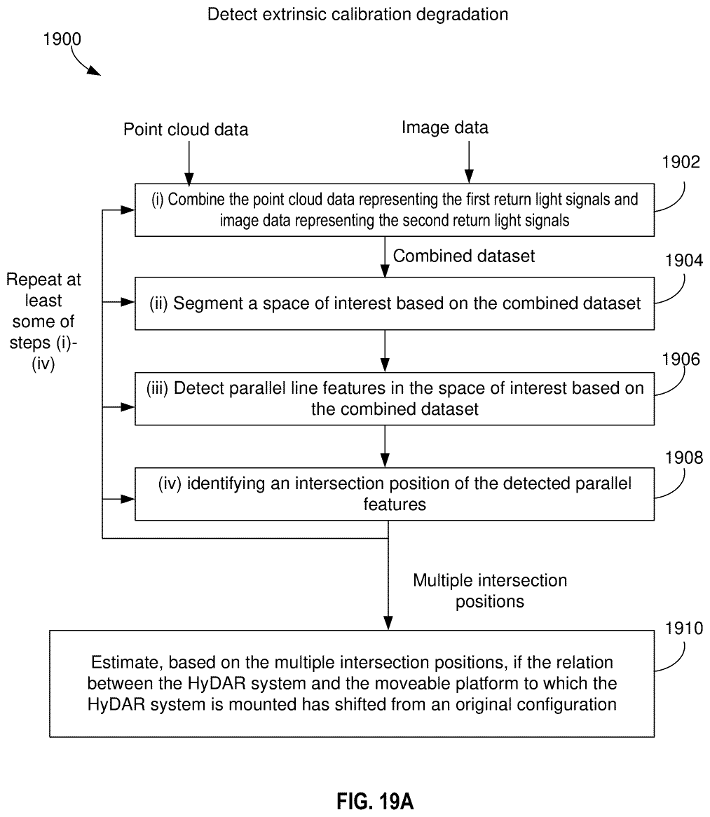

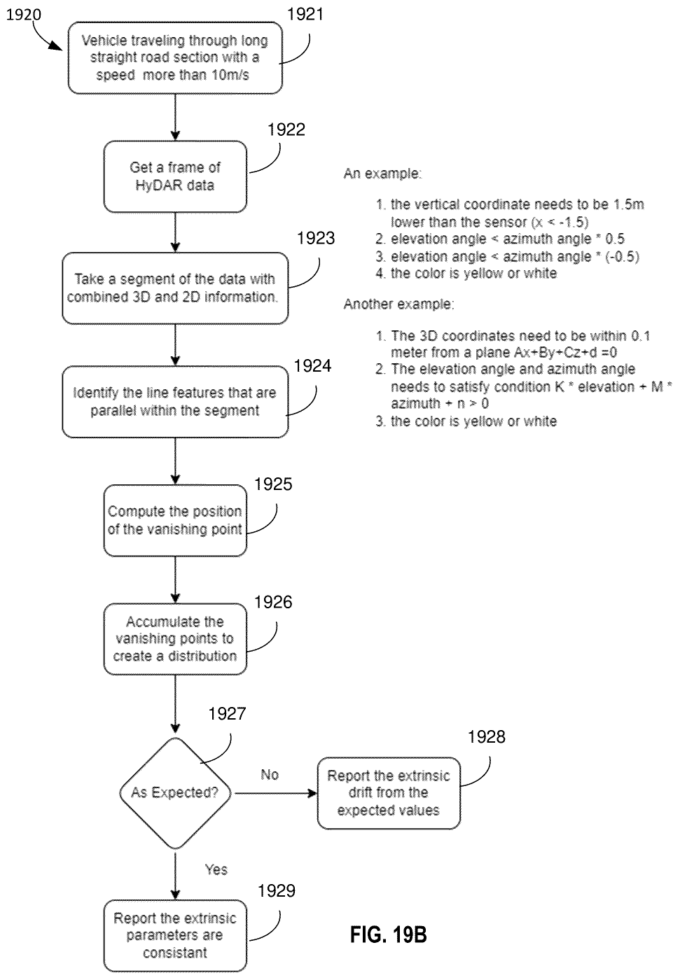

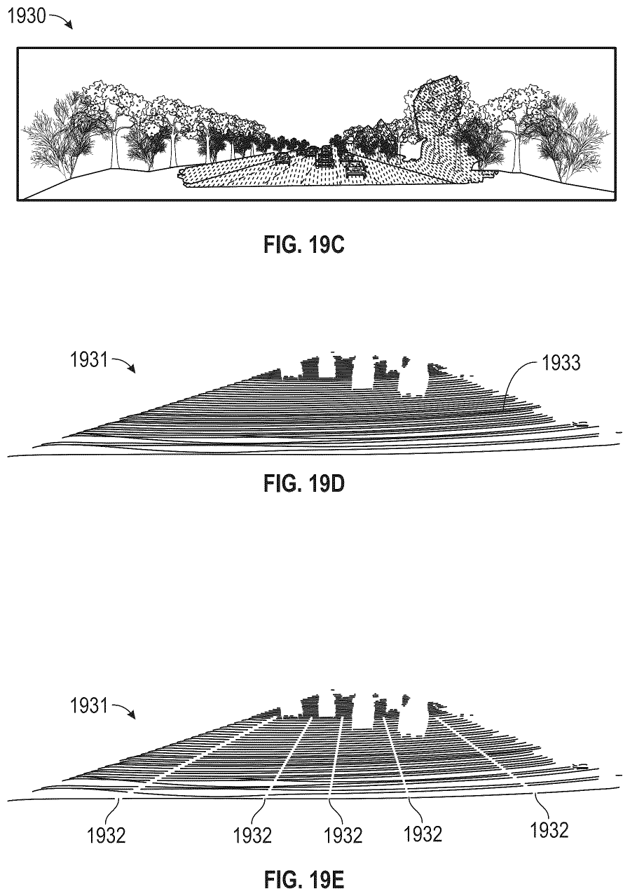

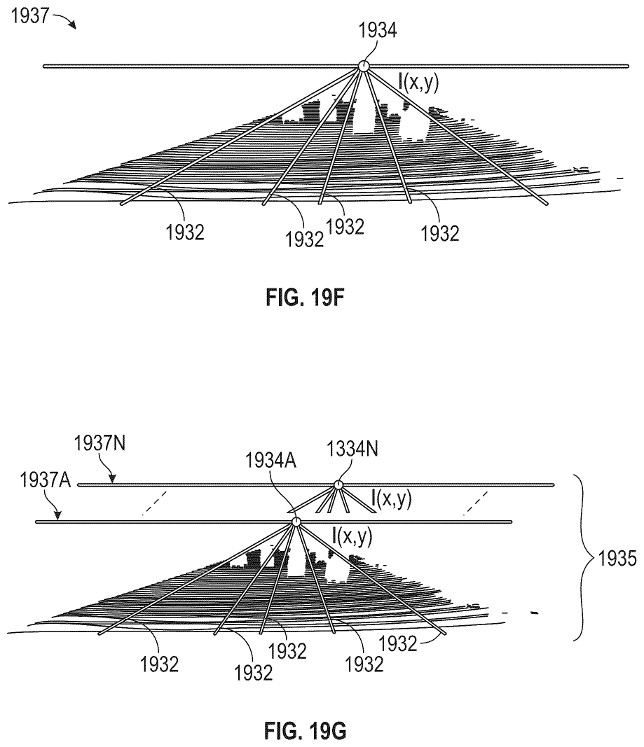

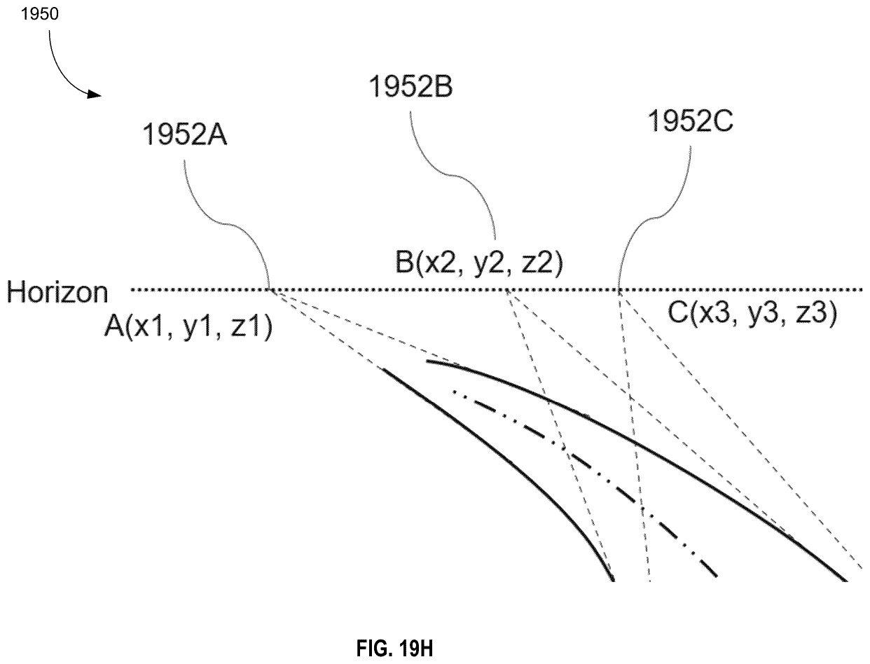

FIGS. 19A-19B are flowcharts illustrating methods for detecting extrinsic calibration degradation of a HyDAR system (e.g., system 1200 or 1802) mounted to a moveable platform (e.g., platform 1800), according to various embodiments. FIGS. 19C-19G are diagrams illustrating an example method of detecting extrinsic calibration degradation of a HyDAR system (e.g., system 1200 or 1802) using parallel line features extending along a road surface, according to various embodiments. The HyDAR system includes a LiDAR sensor and an image sensor integrated together to form a multimodal sensor, as described above. The flowchart of FIG. 19A is described first with the examples shown in FIGS. 19C-19H. FIG. 19A shows a method 1900, which corresponds to the block 1350 in FIG. 13. With reference to FIG. 19A, in some embodiments, the controller begins the method 1900 by obtaining the point cloud data generated by the LiDAR sensor and the image data generated by the image sensor. In block 1902, the point cloud data representing the first return light signals and image data representing the second return light signals are combined to obtain a combined dataset. A controller can perform the combing of the point cloud data and the image data. Because the point cloud data and the image data are synchronized in time and space at the hardware level, there is no extra synchronization required. FIG. 19C illustrates an example image 1930 representing the combined point cloud data and the image data. Image 1930 may also represent just the point cloud data or just the image data.

In block 1904, the controller segments a space-of-interest based on the combined dataset. Comparing image 1930 in FIG. 19C and image 1931 in FIG. 19D, the controller extracts the space-of-interest 1933 and removed (e.g., filtered out) other features that are not of interest. In this example, the space-of-interest 1933 corresponds to the features of a road surface on which a vehicle mounted with the HyDAR system operates. Other features in image 1930 are removed or filtered out. Such features may include, for example, other vehicles operating on the road surface, the sky, trees, and other roadside objects. Extracting the features from the combined dataset to segment the space of interest can be performed using, for example, a machine-learning based algorithm and/or other pattern recognition algorithms. For example, the image data in the combined dataset may include color information and shape information of the road surface (e.g., a rough triangular shape as shown in FIG. 19C if the road is straight, and curved if the road is turning). The point cloud data in the combined dataset may include distance and height information of the objects in image 1930. For instance, in image 1930, any objects that has a height less than a threshold (e.g., 0.1 m) can be considered the road surface. Based on these types of information contained in the combined dataset, the controller can accurately identify the road surface and segment the road surface (i.e., the space-of-interest in this example) from the other features (e.g., trees, vehicles, sky, etc.). In some examples, the controller may also use other data to determine the operating conditions before performing the segmentation to obtain a space of interest. For instance, based on the GPS data and/or the combined dataset, the controller may determine that the vehicle is moving forward; that there is no apparent turning; that the vehicle speed is within a certain threshold; etc. When all these operating conditions are satisfied, the controller segments the space-of-interest 1933 (e.g., road surface) based on the combined dataset.

Next, with reference back to FIG. 19A, in block 1906, the controller detects parallel line features in the space-of-interest 1933 based on the combined dataset. This is illustrated in FIG. 19E, where parallel line features 1932 are identified from the space-of-interest 1933. The parallel line features 1932 can correspond to the lane lines on a road surface. The lane lines can be identified using the image data in the combined dataset. For example, the lane lines may have a higher signal intensity (e.g., because they include reflection materials) and are thus distinguishable from other features of the road surface. The parallel line features 1932 may also correspond to other objects like curbs, isolating islands, buildings, or any other objects disposed along the road surface. In one example, a Hough Line transformation can be performed to extract the parallel line features 1932. For more accurate extraction, freeway lane lines may be better because they are straight, and their lane curvature is more stable or slow changing.

With reference back to FIG. 19A, in block 1908, the controller identifies an intersection position of the detected parallel line features 1932. This is illustrated in FIG. 19F. For example, the parallel line features 1932 can be extrapolated to find the intersection position 1934 at the horizon 1937. The controller can identify the intersection position 1934 by its coordinates (x, y, z). FIG. 19H is a diagram illustrating another example where the lane features are curved (compared to straight lines in FIG. 19F). In this case, the controller may identify a set of intersection positions 1952A-1952C) based on the curved line features. The set of intersection positions 1952A-1952C can be identified by their coordinates (e.g., A (x1, y1, z1); B (x2, y2, z2); and C (x3, y3, z3)). For example, based on the curvatures of lanes at different locations, the controller can identify a set of intersection points 1952A-1952C.

With reference back to FIG. 19A, the process including blocks 1902, 1904, 1906, and 1908 can be repeated multiple times to obtain multiple intersection positions. This is illustrated in FIG. 19G, where multiple intersection positions 1934A-1934N at the horizon 1937A-1937N at different time points are calculated. In one example, each combined dataset corresponds to one frame of point cloud data and image data. Each combined dataset can be processed by the controller to obtain an intersection position. Thus, multiple combined datasets 1935 can be used to obtain multiple intersection positions 1934A-1934N.

With reference back to FIG. 19A, based on the multiple intersection positions, the controller can estimate if the relation between the HyDAR system (e.g., system 1200 or 1802) and the moveable platform (e.g., platform 1800) to which the HyDAR system is mounted has shifted from an original configuration. For example, the controller can compare the multiple intersection positions with one or more corresponding stored extrinsic positions of the HyDAR system. The stored extrinsic positions may be the calibration results obtained at the time the HyDAR system was mounted to the moveable platform at a factory and thus may be factory-calibrated positions (also referred to as ground truth). The stored extrinsic positions may also be calibration results obtained at any other previous time points (e.g., during a later vehicle maintenance service).

In some examples, because a combined dataset includes both the point cloud data generated by the LiDAR sensor and the image data generated by the image data, the controller can calculate a first intersection position using the point cloud data and calculate a second intersection position using the image data. The controller can similarly acquire multiple first intersection positions using multiple frames of point cloud data and acquire multiple second intersection positions using multiple frames of image data. For detecting intrinsic calibration degradation, the controller can compare the multiple first intersection positions with the multiple second intersection positions. This comparison using data from difference sensors (e.g., the LiDAR sensor and the image sensor) of the HyDAR system may be necessary if the factory calibrated positions (ground truth) are not available. For instance, as described above in connection with FIG. 19H, if the lane features are curved, the controller may calculate multiple intersection positions 1952A-1952C. Because the curvature of the road may not be precisely estimated at the time the HyDAR system is manufactured or mounted to the vehicle, there may not be ground truth data. In this situation, the controller cannot compare intersection points with ground truth data. The controller may perform the comparison between the multiple first intersection positions calculated using the point cloud data with the multiple second intersection positions calculated using the image data. In some other examples, this comparison can also be performed as an additional check even if the factory calibrated positions (ground truth) are available. In other examples, the calculation of the intersection positions may be compared with calculations based on a high definition map. The calculation of the intersection positions may also be refined by using an IMU sensor to improve accuracy. For example, the HD map and/or the IMU sensor may provide additional information about the slope of the road surface, which may be used to improve the calculation accuracy.

The comparison results can be used to determine if the relation between the HyDAR system (e.g., system 1200 or 1802) and the moveable platform (e.g., platform 1800) to which the HyDAR system is mounted has shifted from an original configuration. If the comparison results are within a predetermine threshold, the controller can determine that the HyDAR system has not shifted and the extrinsic calibration has not degraded (or not degraded beyond a threshold). If the comparison results are greater than a predetermined threshold, the controller can determine that the extrinsic calibration has degraded beyond the threshold. As such, the HyDAR system may need to adjust or recalibrated.

FIG. 19B illustrates a particular example method 1920 of detecting the extrinsic calibration degradation for a HyDAR system mounted to a vehicle. Method 1920 can correspond to block 1350 shown in FIG. 13. In block 1921, the controller of the HyDAR system may detect that the vehicle is traveling through a long straight road section with a speed more than a threshold speed (e.g., 10 m/s). In block 1922, the controller of the HyDAR system may obtain a frame of the HyDAR data, which includes a combined dataset. The combined dataset has point cloud data generated by a LiDAR sensor and image data generated by an image sensor. In block 1923, based on the frame of the HyDAR data that includes the combined dataset, the controller segments the data with combined 2D and 3D information. As described above, the point cloud data may include 3D information like the horizontal and vertical coordinates and distance information. The image data may include 2D information. The image data may have color information and are higher resolution. The controller can segment a space-of-interest using the combined data, as described above. FIG. 9B further provides some examples of segmentations that can be performed by the controller of the HyDAR system. In one example, the controller may perform the segmentation to obtain a space-of-interest based on a set of criteria including (1) the vertical coordinates needs to be 1.5 m lower than the sensor; (2) the elevation angle is less than the azimuth angle*0.5; (3) the elevation angle is less than the azimuth angle*(−0.5); and (4) the color is yellow or white. In another example, the controller may perform the segmentation to obtain a space-of-interest based on a set of criteria including (1) the 3D coordinates need to be within 0.1 meter from a plane Ax+By+Cz+d=0; (2) the elevation angle and azimuth angle needs to satisfy condition K*elevation+M*azimuth+n>0; and (3) the color is yellow or white. In the above equations, A, B, C, d, K, M, and n are configurable constant.

In block 1924, the controller identifies the line features that are parallel within the segmented space-of-interest. The line features may correspond to lane lines on a freeway, for example. In bock 1925, the controller computes the position of the intersection point (also referred to as the vanish point). In block 1926, the controller accumulates the positions of the intersection points, also referred to as the vanishing points, (e.g., by repeating blocks 1922-1925) to create a distribution. In block 1927, the controller determines if the distribution of the positions of the vanishing points are expected. This may be performed by comparing the vanish points' positions distribution with a distribution obtained by factory calibration (ground truth). If the controller determines the distribution is as expected (e.g., it is within a threshold from the ground truth), it reports (block 1929) that the extrinsic parameters are consistent. That is, the extrinsic calibration did not degrade (or degraded slightly but still within a tolerance range). Otherwise, the controller reports (block 1928) that the extrinsic calibration has drifted from the expected values).

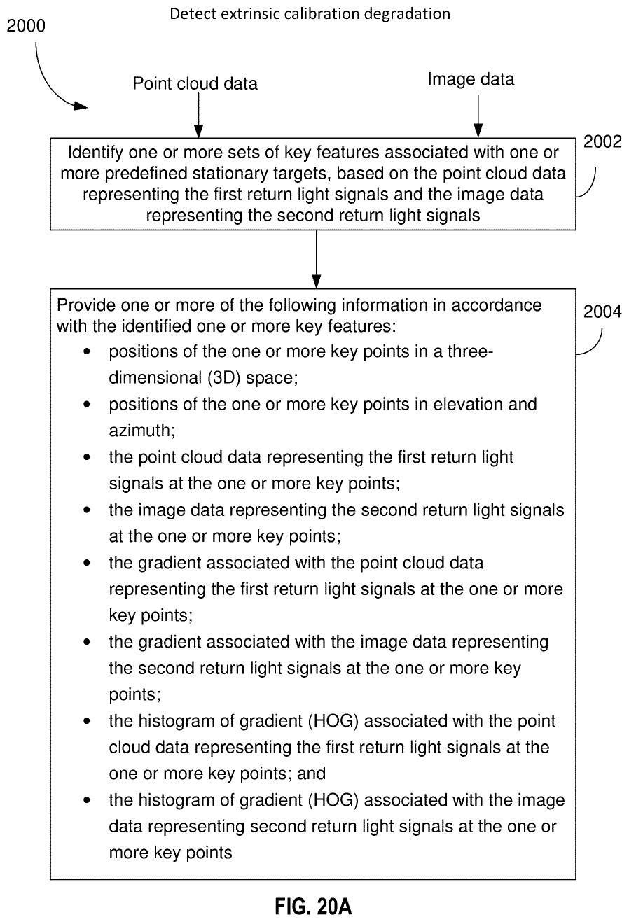

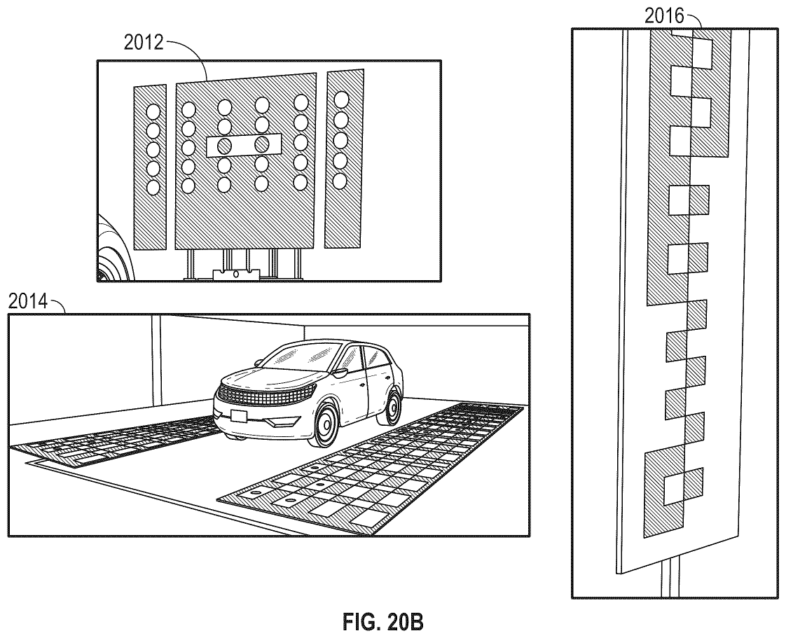

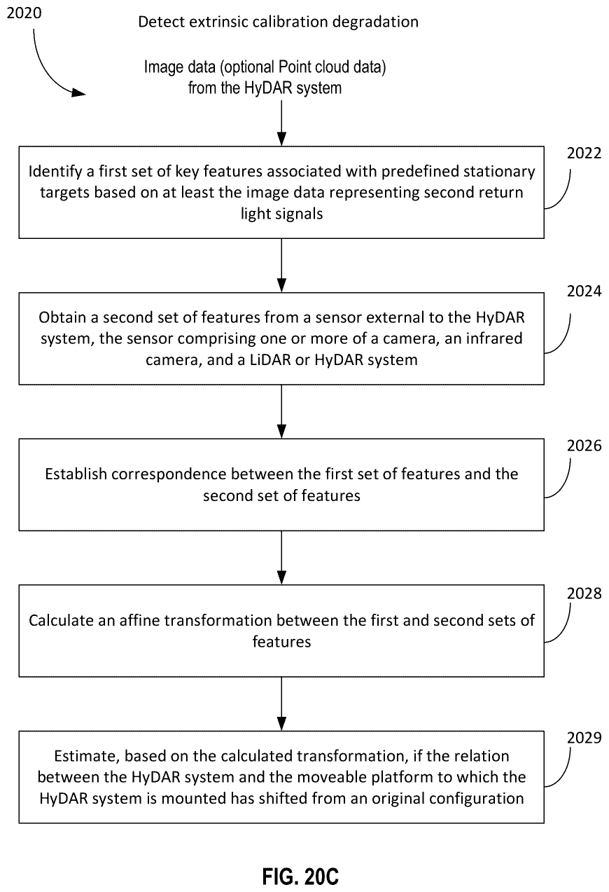

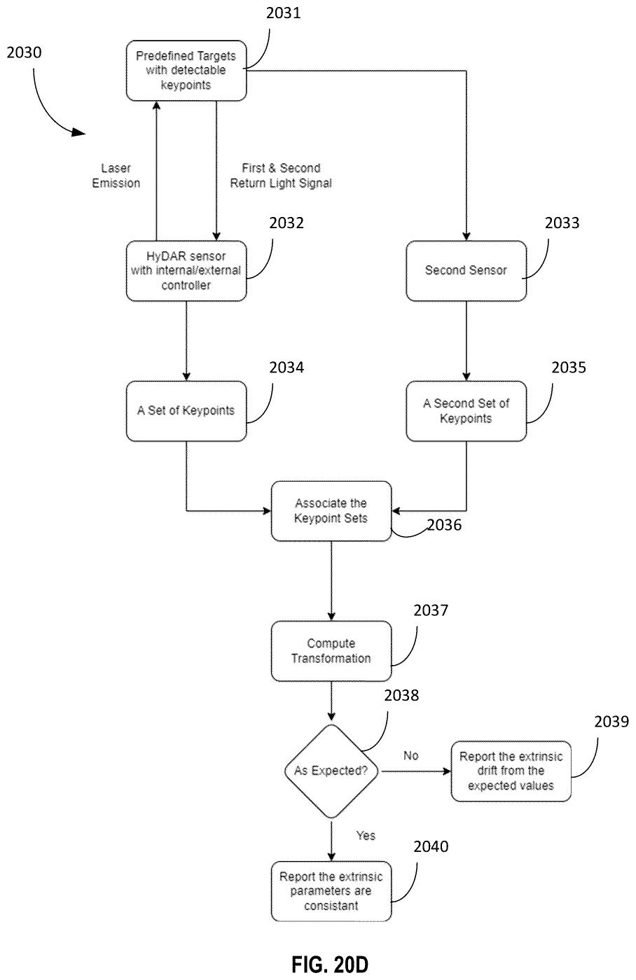

The above-described methods 1900 and 1920 for detecting extrinsic calibration degradation can be performed during vehicle operation using line features of a road surface and are referred to as dynamic extrinsic calibration or simply dynamic calibration. In some other embodiments, the detection extrinsic calibration can be performed using one or more set of features of predefined stationary targets. These sets of features are also referred to as key features or key points. FIG. 20A is a flowchart illustrating another method 2000 for providing information related to key features of predefined stationary targets used for detecting the extrinsic calibration degradation obtained from point cloud data and image data, according to various embodiments. Method 2000 can be a part of block 1350 in FIG. 13.

With reference to FIG. 20A, in block 2002, the controller identifies one or more sets of features associated with one or more predefined stationary targets, based on the point cloud data representing the first return light signals and the image data representing the second return light signals. Examples of the predefined stationary targets are shown in FIG. 20B. For instance, stationary target 2012 may have an array of circles having a predefined pattern (e.g., two black circles in the middle with white circles around them as shown in FIG. 20B). Another example stationary target 2014 may have a checkboard pattern. Another stationary target 2016 may have a pattern with alternating black and white blocks as shown in FIG. 20B. It is understood that predefined stationary targets are not limited to the examples shown in FIG. 20B. The key features (or key points) identified in these predefined stationary targets may include certain particular points, scale-invariable features, and/or features that are not affected by the viewing angle, the FOV size, or the like. These features can be used for detecting extrinsic calibration degradation with an improved accuracy.

With reference still to FIG. 20A, the key features that are identified from the predefined stationary targets may have specific characteristics design for making accurate extrinsic calibrations. These specific characteristics may be related to the intensity or the environment conditions of the key features. When detecting the extrinsic calibration degradation, the HyDAR system is turned on to capture images of the predefined stationary targets using both the LiDAR sensor and the image sensor. The key features can thus be extracted from the point cloud data and the image data.

FIG. 20A further illustrates that in block 2004, the controller can provide one or more of the following information in accordance with the identified one or more sets of features. For example, the controller may provide the positions of the one or more sets of features in a three-dimensional (3D) space; the positions of the one or more sets of features in elevation and azimuth; the point cloud data representing the first return light signals at an area associated with the one or more sets of features; the image data representing the second return light signals at the one or more features; the gradient associated with the point cloud data representing the first return light signals at the one or more sets of features; the gradient associated with the image data representing the second return light signals at the one or more sets of features; the histogram of gradient (HOG) associated with the point cloud data representing the first return light signals at the one or more sets of features; and the histogram of gradient (HOG) associated with the image data representing second return light signals at the one or more sets of features. At least some of the above information are derived (e.g., calculated, transformed, determined, etc.) from the point cloud data and the image data captured by the HyDAR system with respect to the predefined stationary targets.

FIG. 20C is a flowchart illustrating a method 2020 of detecting extrinsic calibration degradation of a HyDAR system using sets of features based on image data and LiDAR point cloud data, according to various embodiments. Method 2020 corresponds to the block 1350 in FIG. 13. With reference to FIG. 20C, the controller obtains the image data and optionally the point cloud data from the HyDAR system. In block 2022, the controller identifies a first set of features associated with predefined stationary targets based on at least the image data representing second return light signals. If the controller also obtains the point cloud data as a part of the combined dataset, the first set of features may also be identified based on both the image data and the point cloud data. The controller may provide various information (e.g., positions, gradient, histogram, etc.) in accordance with the first set of features as described above in connection with FIG. 20A.

In block 2024, the controller obtains a second set of features from a sensor external to the HyDAR system. The sensor may include one or more of a camera, an infrared camera, and a LiDAR or HyDAR system. This external sensor is not a part of the HyDAR system, for which the detection of extrinsic calibration is being performed. This external sensor may be mounted to the same moveable platform (e.g., a vehicle) as the HyDAR system. The first set of features and the second set of features may be obtained by using the same predefined stationary targets. The HyDAR system and the external sensor may be positioned to face the same predefined stationary targets. Similarly, based on the second set of features, the controller may provide various information (e.g., positions, gradient, histogram, etc.) in accordance with the second set of features similar to those described above in connection with FIG. 20A.

Next, in block 2026, the controller establishes correspondence between the first set of features and the second set of features. For example, the controller may identify the corresponding features/gradients/positions/histograms/data in both sets of features. In block 2028, the controller calculates an affine transformation between the first and second sets of features. An affine transformation is a type of geometric transformation that preserves points, straight lines, and planes. It includes transformations such as translations, rotations, scaling (resizing), and shearing (skewing). In the affine transformation, for example, any straight line before the transformation remains a straight line after transformation; parallel lines remain parallel after transformation; and the ratio of distances between points on a straight line remains the same after transformation. The affine transformation can be represented by matrix multiplication and addition, where a coordinate (x, y) is transformed into a new coordinate (x′, y′) using a matrix and a translation vector. Thus, the first set of feature can be transformed to the second set of features using an affine transformation, and vice versa. Using the first set of features and the second set of features, the controller can calculate the affine transformation between them.

With reference still to FIG. 20C, in block 2029, the controller can estimate, based on the calculated transformation, if the relation between the HyDAR system and the moveable platform to which the HyDAR system is mounted has shifted from an original configuration. For example, the affine transformation between the first and second sets of features can be compared to a factory calibrated affine transformation (a ground truth). If they are different more than a threshold, it means the HyDAR system's extrinsic calibration has degraded (changed with respect to the external sensor).

In another example, in blocks 2028-2029, the controller can calculate the relation between two coordination systems associated with the two sets of features. After a coordination system transformation, the first set of features become a first set of transformed features. If the first set of transformed features matches with the second set of features (e.g., within a threshold), then there is no shift of the positions of the HyDAR system. In turn, this means the HyDAR system's extrinsic calibration has not degraded. In other examples, both sets of features can also be transformed to a common coordinate system for comparison.

As described above, in one example, the detection of the extrinsic calibration degradation based on predefined stationary targets can use the image data only, because it has a higher resolution than the point cloud data. But the controller can also use a combined dataset including both the point cloud data and the image data to identify the key features. Also as described above, the method 2020 requires using an external sensor to determine if the HyDAR system's extrinsic calibration has degraded. While the HyDAR system includes a LiDAR sensor and an image sensor, they are integrated together. Therefore, the internal image sensor or the LiDAR sensor cannot be used to perform extrinsic calibration degradation detection, because they are likely to shift in their positions and orientations together. Thus, an external sensor is often required. However, if the LiDAR sensor and the image sensor in the same HyDAR system are separately mounted and they do not shift in their positions and orientations together, they may also be used to do extrinsic calibration degradation detection.

FIG. 20D is a flowchart illustrating a particular example method 2030 of detecting the extrinsic calibration degradation for a HyDAR system mounted to a vehicle. Method 2030 corresponds to the block 1350 of FIG. 13. As shown in FIG. 20D, in block 2031, a HyDAR system (e.g., system 1200 or 1802) and a second sensor external to the HyDAR system are placed to face predefined stationary targets with dateable key points (e.g., key features). In block 2032, The HyDAR system sends laser emissions including laser light signals to the predefined stationary targets. The HyDAR system detects first return light signals by its LiDAR sensor and detects second return light signals by its image sensor. In block 2033, a second sensor can also detect return light signals. The second sensor is external to the HyDAR system and may be a LiDAR sensor, a camera, or any other sensors. The HyDAR system has an internal or external controller. The second sensor may have an internal or external controller too.

In block 2034, the controller of the HyDAR system (or another computer or control circuit) identifies a first set of key points based on the first return light signals and second return light signals detected by the HyDAR system. In block 2035, a second set of key points is also identified by, for example, the internal or external controller of the second sensor external to to the HyDAR system. In block 2036, the controller of the HyDAR system establishes correspondence between the first and second sets of key points, similar to those described above. In block 2037, the controller of the HyDAR system computes a transformation (e.g., an affine transformation or any other transformation that translate one coordinate system to another). In block 2038, the controller can determine if the transformation is as expected (e.g., by comparing with a ground truth). If yes, the controller reports (block 2040) that the extrinsic parameters are consistent, which means there is no or minimum extrinsic calibration needed. If no, the controller reports (block 2039) that the extrinsic calibration has drifted from the expected values. As described above, the controller can also compare the transformed first set of key points with the second set of key points, and vice versa. Or the controller can transform both the first set of key points and the second set of key points to a common coordinate system, and then compare the transformed first and second sets of key points. Based on the comparison, the controller can determine if the HyDAR system has an extrinsic calibration degradation.

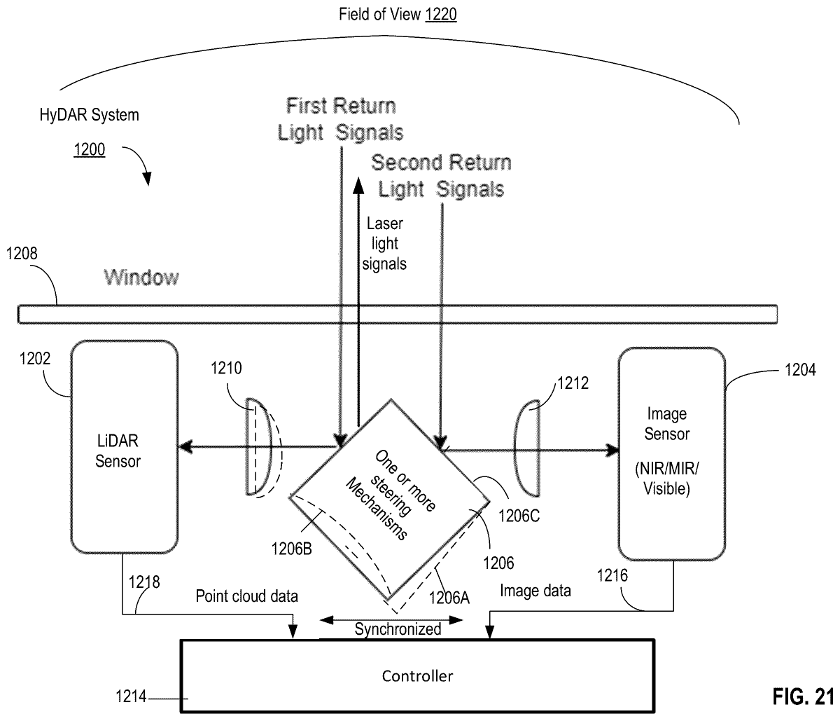

In addition to extrinsic calibration degradation, a HyDAR system (or a LiDAR system) may also have intrinsic calibration degradation. FIG. 21 is a block diagram illustrating a HyDAR system 1200 that may have intrinsic calibration degradation, according to various embodiments. When a HyDAR system is manufactured, the position and orientation relations between its internal components are carefully configured and set. The HyDAR system may be mounted to a moveable platform like a vehicle. Thus, the HyDAR system may operate outdoor under all-weather conditions where it may encounter vibration, wear and tear, shock, and/or other external damages or impacts. As a result, when the HyDAR system operates over time, the relations between its internal components may change. For instance, as shown in FIG. 21, some facets of the one or more steering mechanisms 1206 may have varied flatness; the steering mechanism 1206 may shift horizontally or vertically with respect to its original position; its pitch, yaw, and roll may also change with respect to other components; and/or the collection lens 1210 may also change its distance from the LiDAR sensor 1202 such that the first return light signals may not be focused well onto the LiDAR sensor 1202. These types of relation changes between internal components of a HyDAR system is referred to as the intrinsic calibration degradation. It is understood that intrinsic calibration degradation is not limited to the examples shown in FIG. 21.

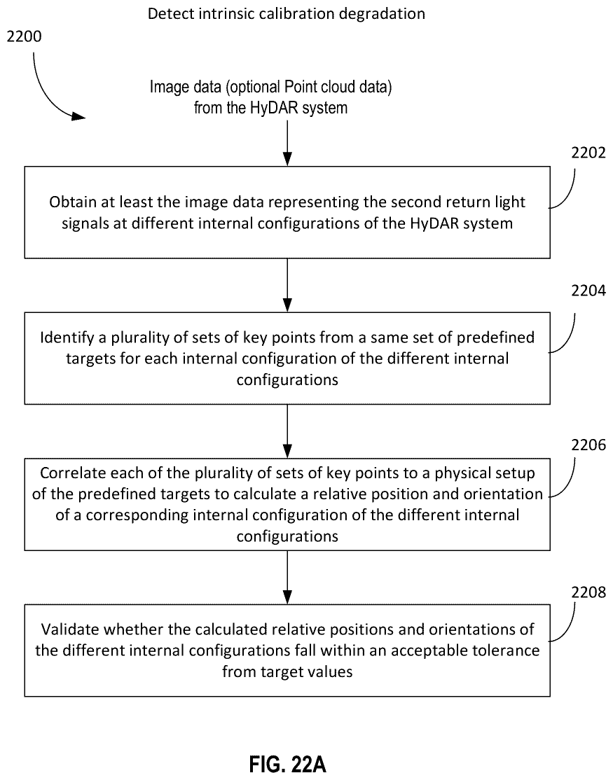

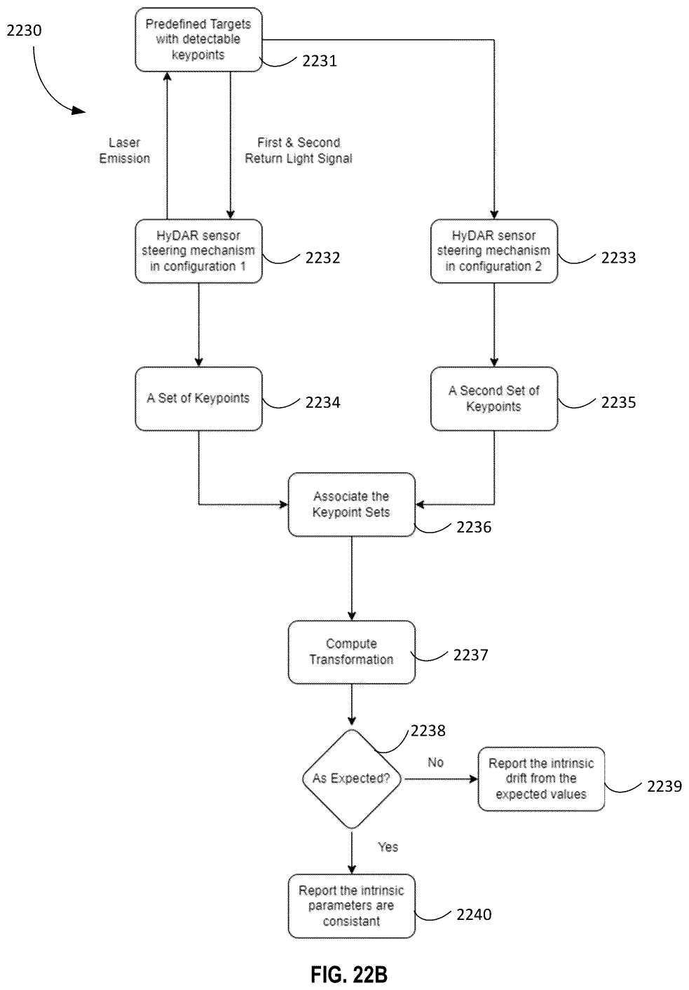

FIG. 22A is a flowchart illustrating an example method 2200 for detecting intrinsic calibration degradation of a HyDAR system, according to various embodiments. Method 2200 corresponds to block 1360 of FIG. 13. As shown in FIG. 22A, in block 2202 of method 2200, a controller obtains at least the image data representing the second return light signals at different internal configurations of the HyDAR system. Optionally, the controller can obtain point cloud data or the combined dataset including the point cloud data and the image data. As described above, the configuration of a HyDAR system described herein has an integrated multimodal sensor including a LiDAR sensor and an image sensor. Therefore, the point cloud data and the image data are time-and-space synchronized at the hardware level. The method 2200 can be performed with just the image data or the combined dataset, and the below description uses the image data for illustration.

The image data may include data representing the second return light signals detected at two or more internal configurations of the HyDAR system. For instance, with reference to FIG. 21, the image data may be generated based on second return light signals received by two different facets of the steering mechanism 1206, or based on second return light signals formed from laser light signals transmitted by two different facets. Specifically, in one configuration, facet 1206A is used to transmit laser light signals and to receive second return light signals; while in another configuration, facet 1206B is used to transmit laser light signals and to receive the second return light signals. Facet 1206A and 1206B may be identical at the factory when the HyDAR system 1200 is manufactured; but over time, one or both facets may become skewed/wrapped/distorted/etc., as shown in FIG. 21.

As another example, the multiple different configurations may include using different levels of laser power (e.g., high or low), different laser light signals repetition rates, different data collection cycles, different LiDAR sensor and/or image sensor sensitivities, etc. That is, the multiple internal configurations of the HyDAR system have different operational parameters or hardware configurations.

With reference back to FIG. 22A, in block 2204, the controller identifies a plurality of sets of features from a same set of predefined targets for each internal configuration of the different internal configurations. The predefine targets may be stationary targets as described above, or may be moving targets. As long as the same set of targets are used for each internal configuration of the multiple different internal configurations, the resulted sets of features can be used for detecting intrinsic calibration degradation.

In block 2206 of method 2200, the controller correlates each of the plurality of sets of features to a physical setup of the predefined targets to calculate a relative position and orientation of a corresponding internal configuration of the different internal configurations. For example, with reference to FIG. 21, assuming facet 1206A and 1206C are supposed to measure the same portion of the FOV, and facet 1206A is slightly off by 0.5 degree in the horizontal direction (but the controller does not know) as illustrated in FIG. 21. The same feature in the FOV is detected at azimuth=0 deg by the controller while using facet 1206C (configuration 1), and again detected at azimuth=1 degree by the controller using facet 1206A (configuration 2). From the difference between the detection of the same feature using different configuration, the controller can deduce the internal offset between facets 1206A and 1206C.

In block 2208, the controller can validate whether the calculated relative positions and orientations of the different internal configurations fall within an acceptable tolerance from target values. For instance, a first set of features may be obtained when the HyDAR's system operates using the first internal configuration that has a first relative position and orientation; and a second of feature may be obtained when the HyDAR system operates using the second internal configuration that has a second relative position and orientation. The first and second relative positions and orientations can be used to calculate a transformation (e.g., an affine transformation). Or the first relative position and orientation can be transformed to a coordinate system under the second internal configuration, or vice versa.

Similar to described above for detecting the extrinsic calibration degradation, the intrinsic calibration degradation can be detected by comparing the transformation between the relative positions and orientations under two different internal configurations with a ground truth (or simply that they should not have any difference or have only minimum difference). The intrinsic calibration degradation can also be detected by comparing a relative position and orientation transformed from the coordinate system under the first configuration to the coordinate system under the second configuration, and vice versa. In other words, the intrinsic calibration degradation can be detected by comparing the relative positions and orientations obtained under two different internal configurations, with proper coordinate transformation. It is essentially using the relative position/orientation under one configuration as the basis for determining if the relative position/orientation under the other configuration changes beyond an acceptable tolerance from target values.

FIG. 22B illustrates a flowchart of an example method 2230 for detecting intrinsic calibration degradation using two configurations of the steering mechanism (e.g., mechanism 1206 in FIG. 21). In block 2231 of method 2230, the HyDAR system is placed to face the predefined targets with detectable key points. The predefined targets can be those shown above in FIG. 20B. In block 2232, the HyDAR system operates to transmit laser light signals and receive first and second return light signals using the steering mechanism under the first configuration (e.g., receiving the return light signals using a first facet 1206A). In block 2233, the HyDAR system operates to transmit laser light signals and receive first and second return light signals using the steering mechanism under the second configuration (e.g., receiving the return light signals using a second facet 1206B).

In block 2234, a first set of key points are obtained based on the first and second return light signals received by the HyDAR system under the first configuration. In block 2235, a second set of key points are obtained based on the first and second return light signals received by the HyDAR system under the second configuration.

In block 2236, the controller correlates between the first set of key points and the second set of key points. In block 2237, the controller computes a transformation between the two sets of key points. In block 2238, the controller determines if the transformation is as expected. If yes, the controller reports (block 2240) that the intrinsic parameters are consistent, which means no or minimum intrinsic calibration degradation is detected. If no, the controller reports (block 2239) that the intrinsic calibration has drifted from the expected values. Blocks 2236-2240 can be substantially the same or similar to blocks 2036-2040, respectively in method 2030 for detecting extrinsic calibration degradation shown in FIG. 20D, and are thus not repeatedly described.

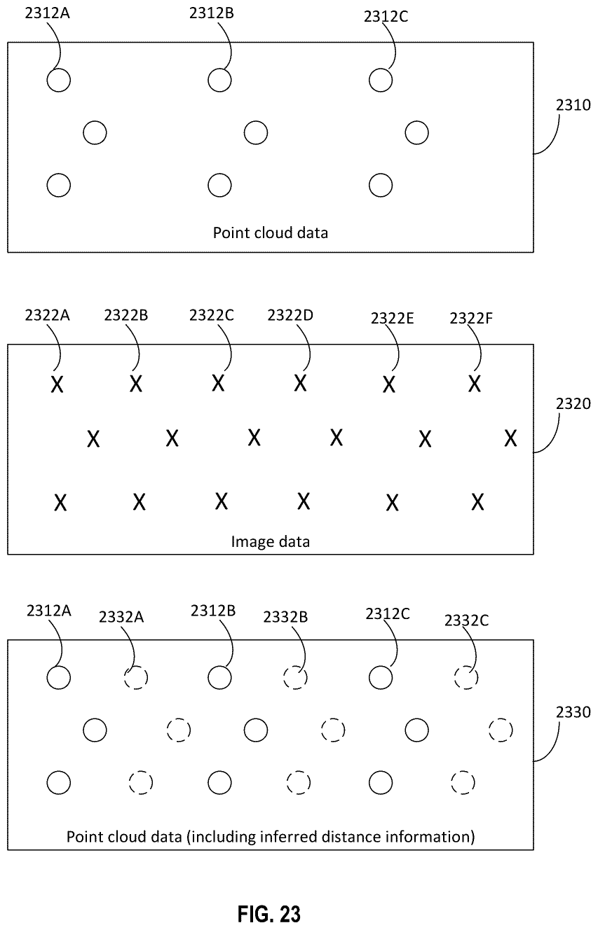

As described above, the HyDAR system described herein can perform early fusion of the point cloud data and the image data to detect one or more degradation factors including window blockage, interference light signals, extrinsic calibration degradation, and intrinsic calibration degradation. In addition, the early fusion can be used to enhance the point cloud data resolution. FIG. 23 are diagrams illustrating enhanced point cloud data resolution using image data, according to various embodiments. As shown in FIG. 23, point cloud data 2310 are generated by the LiDAR sensor; and the image data 2320 are generated by the image sensor. Oftentimes, the point cloud data 2310 has a lower resolution than the image data 2320. This is because the image sensor nowadays has a very large pixel array (e.g., in the tens or hundreds of millions), while the LiDAR sensor resolution is limited by the scanning speed, number of scanning beams, and laser pulse triggering rate.

Therefore, when a HyDAR system has an integrated multimodal sensor that includes both a LiDAR sensor and an image sensor, at least a part of the image data representing the second return light signals has corresponding point cloud data representing the first return light signals. On the other hand, a part of the image data representing the second return light signals may have no corresponding point cloud data representing the first return light signals. As shown in FIG. 23, for instance, when the LiDAR sensor and the image sensor of a HyDAR system senses return light from the same FOV, data points 2312A, 2312B, and 2312C in the point cloud data 2310 correspond to data points 2322A, 2322C, and 2322E, respectively, in the image data 2320. However, data points 2322B, 2322D, and 2322F in the image data 2320 has no corresponding data points in the point cloud data 2310, because the point cloud data 2310 has a lower point cloud resolution.

In some examples, the controller of a HyDAR system can infer distance information using the part of the image data representing the second return light signals that have no corresponding point cloud data representing the first return light signals, based on the at least a part of the image data representing the second return light signals that has corresponding point cloud data representing the first return light signals. For example, as shown in FIG. 23, in point cloud data 2330, the data points 2312A, 2312B and 2312C are acquired data points based on the first return light signals detected by a LiDAR sensor of the HyDAR system. They are the same as those in point cloud data 2310. The controller can find their corresponding data points 2322A, 2322C and 2322E in the image data 2320. Because the image data 2320 has a higher resolution, there might be one or more additional data points between these data points 2322A, 2322C, and 2322E. As shown, between data points 2322A and 2322C in image data 2320, there is one additional data point 2322B. The controller can determine if the data point 2322B has any changes from its neighboring data points 2232A and 2232C, and the extent of change. The changes can be changes in brightness, contrast, color, etc. When the change is small, it means that the physical distance in the FOV represented by the neighboring data points 2232A, 2232B, and 2232C are small. Otherwise, the physical distance may be large.

Therefore, using the information obtained from the extent of changes between the data points 2322A, 2322B, and 2322C, the controller can infer distance information for an inferred data point 2332 between real data points 2312A and 2312B in point cloud data 2330. The inferred data point 2332 is not actually acquired by detecting a first return light signal. Instead, it is an inferred data point. For example, if the controller determines that the change is small from data point 2322B to 2322A and from data point 2322B to 2322C, it means the physical distance changes for the inferred data point 2332A to 2312A and from inferred data point 2332A to 2312B are likely small. The physical distance changes can be calculated or inferred based on the calculated changes between the data points 2322A, 2322B, and 2322C. As a result, the distance at the inferred data point 2332A can be inferred or estimated with a relatively high confidence.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A Hybrid Detection and Ranging (HyDAR) system configured for detecting signals with multiple wavelengths, the system comprising:
a laser light source providing laser light signals;
an aperture window;
one or more steering mechanisms configured to perform:
directing the laser light signals toward the aperture window,
receiving first return light signals formed based on at least a portion of the laser light signals provided by the laser light source,
receiving second return light signals formed from light provided by one or more light sources external to the HyDAR system;
a multimodal sensor including a Light Detection and Ranging (LiDAR) sensor and an image sensor,
the LiDAR sensor being configured to detect the first return light signals to obtain one or more frames of point cloud data, and
the image sensor being configured to detect the second return light signals to obtain one or more frames of image data, wherein the point cloud data and the image data are at least partially time-and-space synchronized at hardware-level of the HyDAR system; and
a controller configured to perform:
detecting one or more degradation factors affecting performance of the HyDAR system,
in response to detecting the one or more degradation factors, causing adjustment of a device configuration or an operational condition of the HyDAR system to remove or reduce effects of the degradation factors.

2. The system of claim 1, wherein the image sensor comprises at least one of a near-infrared (NIR) sensor, a mid-infrared (MIR) sensor, or a visible-light sensor.

3. The system of claim 1, wherein the one or more steering mechanisms comprise an optical scanner configured to perform:
scanning the laser light signals in both horizontal and vertical directions;
receiving the first return light signals and the second return light signals; and
directing the first return light signals and the second return light signals to the LiDAR sensor and the image sensor, respectively.

4. The system of claim 1, wherein the first return light signals are formed by scattering or reflecting at least a portion of the laser light signals by at least one of:
an object located at or proximate to the aperture window, the object blocking at least a portion of the aperture window, or
an object located at a distance away from the aperture window.

5. The system of claim 1, wherein the second return light signals are formed by scattered or reflected at least one of NIR, MIR, or visible light from the one or more light sources external to the HyDAR system.

6. The system of claim 5, wherein the visible light from the one or more light sources external to the HyDAR system comprises one or more of:
(a) sunlight;
(b) moonlight;
(c) light from vehicle headlights;
(d) streetlights;
(e) reflection, transmission, and/or refraction of (a)-(d); and
(f) other visible light sources.

7. The system of claim 1, further comprising a focal lens, wherein the one or more steering mechanisms are configured to direct the second return light signals to the image sensor via the focal lens.

8. The system of claim 1, wherein detecting the one or more degradation factors affecting the performance of the HyDAR system comprises detecting one or more of:
at least a partial window blockage of the aperture window;
interference signals provided by one or more interference light sources;
extrinsic calibration degradation measured by a relation between the HyDAR system and a moveable platform to which the HyDAR system is mounted; and
intrinsic calibration degradation associated with misaligned internal components of the HyDAR system.

9. The system of claim 8, wherein detecting the at least a partial window blockage of the aperture window comprises:
obtaining, based on the one or more frames of the point cloud data, a first deviation of the first return light signals from a first expectation, the first return light signals corresponding to a first area of the aperture window;
obtaining, based on the one or more frames of the image data, a second deviation of the second return light signals from a second expectation, the second return light signals corresponding to a second area of the aperture window, the second area at least partially overlapping with the first area; and
performing at least one of:
determining whether the first deviation exceeds a first threshold, or
determining whether the second deviation exceeds a second threshold.

10. The system of claim 9, wherein the detecting of the at least a partial window blockage of the aperture window further comprises:
in accordance with at least one of:
a determination that the first deviation exceeds the first threshold, or
a determination that the second deviation exceeds the second threshold,
determining one or more locations, one or more types, and an extent of the at least a partial window blockage of the aperture window.

11. The system of claim 9, wherein the detecting of the at least a partial window blockage of the aperture window further comprises: determining whether the at least a partial window blockage persists over no less than one data collection cycle; and
wherein causing the adjustment of a device or an operational condition of the HyDAR system comprises: in accordance with a determination that the at least a partial window blockage persists over no less than one data collection cycle, performing at least one of:
reporting the at least a partial window blockage; or
activating a blockage removal mechanism for removing the at least a partial window blockage.

12. The system of claim 9, wherein the first deviation or the second deviation represents one or more of the following changes associated with the first return light signals or the second return light signals, respectively:
change in a signal intensity or an average signal intensity;
change in a distribution of the signal intensity;
change in a size and/or a shape associated with one or both of the first area and the second area of the aperture window over time;
change in sensitivity to a predetermined wavelength range;
change in a point count of the point cloud data; or
change in a distribution of distances represented by the point cloud data or the image data.

13. The system of claim 8, wherein the detecting of the at least a partial window blockage of the aperture window comprises:
fusing, using one or more machine-learning networks, the point cloud data representing the first return light signals and the image data representing the second return light signals to obtain a fused data; and
detecting a fused blockage detection result based on the fused data.

14. The system of claim 13, wherein the detecting of the at least a partial window blockage of the aperture window comprises: determining, based on the fused blockage detection result, whether the at least partial window blockage persists over on less than one data collection cycle; and
wherein causing the adjustment of a device configuration or an operational condition of the HyDAR system comprises: in accordance with a determination that the at least a partial window blockage persists over no less than one data collection cycle, performing at least one of:
reporting the at least a partial window blockage; or
activating a blockage removal mechanism for removing the at least a partial window blockage.

15. The system of claim 8, wherein the detecting of interference signals caused by the one or more interference light sources comprises:
obtaining a first light profile representing characteristics of the first return light signals;
obtaining a second light profile representing characteristics of the second return light signals;
determine whether at least one of the first light profile or the second light profile matches with an interference light profile associated with the interference signals provided by the one or more interference light sources; and
wherein causing adjustment of a device configuration or an operational condition of the HyDAR system comprises:
in accordance with a determination that at least one of the first light profile or the second light profile matches with the interference light profile, causing adjustment of at least one of a laser power, a noise filter, or the one or more steering mechanism to reduce or prevent a HyDAR system misdetection.

16. The system of claim 15, wherein at least one of the first light profile, the second light profile, or the interference light profile comprises data representing one or more of the following:
a measured direction along which the first return light signals and/or the second return light signals are detected by the HyDAR system;
an absolute intensity detected along the measured direction;
a relative intensity to different spectral ranges detected long the measured direction;
a detectable size or shape of the at least one of the one or more interference light sources; and
a distribution of distances over multiple data collection cycles.

17. The system of claim 15, wherein the one or more interference light sources comprise one or more of the Sun, vehicle headlights/taillight, street illumination, a HyDAR or LiDAR system, and a light redistribution mechanism redirecting light from another interference source.

18. The system of claim 15, wherein causing adjustment of at least one of the laser power, the noise filter, or the one or more steering mechanism to reduce or prevent a HyDAR system misdetection comprises one or more of:
adjusting at least one of the one or more steering mechanisms to tune at least one of a start location or an end location of a field-of-view of the HyDAR system to avoid a location of the one or more interference light sources; and
adjusting at least one of the one or more steering mechanisms to tune a duration of a data collection cycle to avoid a location of the one or more interference light sources or to reduce a likelihood of receiving the interference signals at the HyDAR system.

19. The system of claim 15, wherein causing adjustment of at least one of the laser power, the noise filter, or the one or more steering mechanism to reduce or prevent a HyDAR system misdetection comprises one or more of:
adjusting the laser power to increase a signal intensity ratio of the first return light signals to the interference light signals to no less than a signal-to-noise ratio (SNR) threshold; and
turning off the laser power to avoid directing the laser light signals to a location of the one or more interference light sources.

20. The system of claim 15, wherein causing adjustment of at least one of the laser power, the noise filter, or the one or more steering mechanism to reduce or prevent a HyDAR system misdetection comprises one or more of:
adjusting the controller to enhance the noise filter to remove data representing the at least a part of the interference light signals provided by the one or more interference light sources; and
adjusting the controller to discard or ignore data representing the at least a part of the interference light signals provided by the one or more interference light sources.

21. The system of claim 8, wherein detecting the extrinsic calibration degradation measured by the relation between the HyDAR system and the moveable platform to which the HyDAR system is mounted comprises:
(i) combining the point cloud data representing the first return light signals and image data representing the second return light signals to obtain a combined dataset;
(ii) segmenting a space of interest based on the combined dataset;
(iii) detecting parallel line features in the space of interest based on the combined dataset; and
(iv) identifying an intersection position of the detected parallel line features.

22. The system of claim 21, wherein detecting the extrinsic calibration degradation measured by the relation between the HyDAR system and the moveable platform to which the HyDAR system is mounted further comprises:
repeating at least some of steps (i)-(iv) of claim 21 to obtain multiple intersection positions; and
estimating, based on the multiple intersection positions, if the relation between the HyDAR system and the moveable platform to which the HyDAR system is mounted has shifted from an original configuration.

23. The system of claim 8, wherein detecting the extrinsic calibration degradation measured by the relation between the HyDAR system and the moveable platform to which the HyDAR system is mounted comprises:
identifying one or more sets of features associated with one or more predefined stationary targets, based on the point cloud data representing the first return light signals and the image data representing the second return light signals; and
providing one or more of the following information in accordance with the identified one or more sets of features:
positions of the one or more sets of features in a three-dimensional (3D) space;
positions of the one or more sets of features in elevation and azimuth;
the point cloud data representing the first return light signals at an area associated with the one or more sets of features;
the image data representing the second return light signals at the one or more features;
a gradient associated with the point cloud data representing the first return light signals at the one or more sets of features;
a gradient associated with the image data representing the second return light signals at the one or more sets of features;
a histogram of gradient (HOG) associated with the point cloud data representing the first return light signals at the one or more sets of features; and
a histogram of gradient (HOG) associated with the image data representing second return light signals at the one or more sets of features.

24. The system of claim 8, wherein detecting the extrinsic calibration degradation measured by the relation between the HyDAR system and the moveable platform to which the HyDAR system is mounted comprises:
identifying a first set of features associated with predefined stationary targets based on at least the image data representing second return light signals;
obtaining a second set of features from a sensor external to the HyDAR system, the sensor comprising one or more of a camera, an infrared camera, and a LiDAR or HyDAR system;
establishing correspondence between the first set of features and the second set of features;
calculating an affine transformation between the first and second sets of features; and
estimating, based on the calculated transformation, if the relation between the HyDAR system and the moveable platform to which the HyDAR system is mounted has shifted from an original configuration.

25. The system of claim 8, wherein detecting the intrinsic calibration degradation associated with misaligned internal components of the HyDAR system comprises:
obtaining at least the image data representing the second return light signals at different internal configurations of the HyDAR system;
identifying, based on the image data, a plurality of sets of features from a same set of predefined targets for each internal configuration of the different internal configurations;
correlating each of the plurality of sets of features to a physical setup of the predefined targets to calculate a relative position and orientation of a corresponding internal configuration of the different internal configurations;
validating whether the calculated relative positions and orientations of the different internal configurations fall within an acceptable tolerance from target values.

26. The system of claim 1, wherein the point cloud data representing the first return light signals and the image data representing the second return light signals are time-and-space synchronized by configurations of the one or more steering mechanisms.

27. The system of claim 26, wherein:
at least a part of the image data representing the second return light signals has corresponding point cloud data representing the first return light signals; or
a part of the image data representing the second return light signals have no corresponding point cloud data representing the first return light signals.

28. The system of claim 27, wherein the controller is further configured to perform:
inferring distance information using the part of the image data representing the second return light signals that have no corresponding point cloud data representing the first return light signals, based on the at least a part of the image data representing the second return light signals that has corresponding point cloud data representing the first return light signals.
